(19) United States
(12) Patent Application Publication
(10) Pub. No.: US 2020/0090051 A1
(43) Pub. Date: Mar. 19, 2020

(54) OPTIMIZATION PROBLEM OPERATION METHOD AND APPARATUS

(71) Applicant: FUJITSU LIMITED, Kawasaki-shi (JP)

(72) Inventors: Noriaki Shimada, Kawasaki (JP); Hiroyuki Izui, Kawasaki (JP); Hiroshi Kondou, Yokohama (JP); Tatsuhiro Makino, Taito (JP)

(73) Assignee: FUJITSU LIMITED, Kawasaki-shi (JP)

(21) Appl. No.: 16/563,999

(22) Filed: Sep. 9, 2019

(30) Foreign Application Priority Data
Sep. 19, 2018 (JP) 2018-175415

(51) Int. Cl. G06N 5/00

(52) U.S. Cl. CPC G06N 5/003

(57) ABSTRACT

An optimization problem operation method include accepting a combinatorial optimization problem to an operation unit that is capable of being divided into a plurality of partitions logically and solving the combinatorial optimization problem. The method include deciding a partition mode that prescribes a logical division state of the operation unit and an execution mode that prescribes a range of hardware resources used in an operation in the partition mode according to a scale or a requested precision of the combinatorial optimization problem. The method include causing execution of operations of the combinatorial optimization problem in parallel in the operation unit with the partition mode and the execution mode decided, based on the number of times obtained by dividing the number of times of execution of the combinatorial optimization problem by the number of divisions corresponding to the execution mode.

### CROSS-REFERENCE TO RELATED APPLICATION

This application is based upon and claims the benefit of priority of the prior Japanese Patent Application No. 2018-175415, filed on Sep. 19, 2018, the entire contents of which are incorporated herein by reference.

### FIELD

The embodiment discussed herein is related to optimization problem operation method and apparatus.

### BACKGROUND

As a method for solving a multivariable optimization problem at which the von Neumann computer is not good, an optimization apparatus using the Ising energy function (referred to as Ising machine or Boltzmann machine in some cases) exists. The optimization apparatus replaces a problem of a calculation target by an Ising model that is a model representing the behavior of spins of a magnetic body and carries out calculations.

It is also possible for the optimization apparatus to carry out modeling by using a neural network, for example. In this case, each of plural bits corresponding to plural spins (spin bits) included in the Ising model functions as a neuron that outputs 0 or 1 according to a weight coefficient (referred to also as coupling coefficient) that represents the magnitude of interaction between another bit and the self-bit. The optimization apparatus obtains, as a solution, the combination of the values of the respective bits with which the minimum value of the value (referred to as energy) of the above-described energy function (referred to also as cost function or objective function) is obtained by a stochastic search method such as simulated annealing.

For example, there is a proposal for a semiconductor system that searches for the ground state of an Ising model by using a semiconductor chip on which plural unit elements corresponding to spins are mounted. In the semiconductor system of the proposal, in implementing a semiconductor chip that may deal with a large-scale problem, the semiconductor system is constructed by using plural semiconductor chips on which a certain number of unit elements are mounted.

An example of a related art is disclosed in International Publication Pamphlet No. WO 2017/037903.

### SUMMARY

According to an aspect of the embodiment, a non-transitory computer-readable recording medium has stored therein a program for causing a computer to execute a process including accepting a combinatorial optimization problem to an operation unit that is capable of being divided into a plurality of partitions logically and solves the combinatorial optimization problem; deciding a partition mode that prescribes a logical division state of the operation unit and an execution mode that prescribes a range of hardware resources used in an operation in the partition mode according to a scale or a requested precision of the combinatorial optimization problem; and causing execution of operations of the combinatorial optimization problem in parallel in the operation unit with the partition mode and the execution mode decided, based on the number of times obtained by dividing the number of times of execution of the combinatorial optimization problem by the number of divisions corresponding to the execution mode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating one embodiment example of an optimization problem operation method according to an embodiment;

FIGS. 2A and 2B represent an explanatory diagram illustrating one embodiment example of an operation unit;

FIG. 3 is an explanatory diagram illustrating a system configuration example of an information processing system;

FIG. 4 is a block diagram Illustrating a hardware configuration example of an optimization problem operation apparatus;

FIG. 5 is an explanatory diagram Illustrating one example of a relation of hardware in an information processing system;

FIG. 6 is an explanatory diagram illustrating one example of a combinatorial optimization problem;

FIG. 7 is an explanatory diagram illustrating a search example of binary values that provide a minimum energy;

FIGS. 8A to 8C represent an explanatory diagram illustrating a circuit configuration example of an LFB;

FIG. 9 is an explanatory diagram illustrating a circuit configuration example of a random selector unit;

FIG. 10 is an explanatory diagram illustrating an example of a trade-off relation between scale and precision;

FIG. 11 is an explanatory diagram (first diagram) illustrating an example of storing of weight coefficients;

FIG. 12 is an explanatory diagram (second diagram) illustrating an example of storing of weight coefficients;

FIG. 13 is an explanatory diagram (third diagram) illustrating an example of storing of weight coefficients;

FIG. 14 is an explanatory diagram (fourth diagram) illustrating an example of storing of weight coefficients;

FIG. 15 is a flowchart illustrating one example of an operation processing procedure of an optimization apparatus;

FIG. 16 is an explanatory diagram (fifth diagram) illustrating an example of storing of weight coefficients;

FIG. 17 is an explanatory diagram illustrating one example of stored contents of a mode setting table;

FIG. 18 is a block diagram illustrating a functional configuration example of an optimization problem operation apparatus;

FIG. 19 is an explanatory diagram illustrating a specific example of a partition information table;

FIG. 20A is an explanatory diagram (first diagram) illustrating a parallel execution example of a combinatorial optimization problem according to the number of times of repetition;

FIG. 20B is an explanatory diagram (second diagram) illustrating a parallel execution example of a combinatorial optimization problem according to the number of times of repetition;

FIG. 20C is an explanatory diagram (third diagram) illustrating a parallel execution example of a combinatorial optimization problem according to the number of times of repetition;

FIG. 20D is an explanatory diagram (fourth diagram) illustrating a parallel execution example of a combinatorial optimization problem according to the number of times of repetition;

FIGS. 21A and 21B represent a flowchart (first flowchart) illustrating one example of an optimization problem operation processing procedure of an optimization problem operation apparatus;

FIG. 22 is a flowchart (second flowchart) illustrating the one example of the optimization problem operation processing procedure of the optimization problem operation apparatus;

FIG. 23 is a flowchart illustrating one example of a specific processing procedure of parallel operation processing;

FIG. 24 is an explanatory diagram illustrating an apparatus configuration example of an optimization apparatus;

FIGS. 25A to 25C represent an explanatory diagram Illustrating a circuit configuration example of an LFB; and

FIG. 26 is an explanatory diagram illustrating a circuit configuration example of a scale coupling circuit.

### DESCRIPTION OF EMBODIMENTS

In an optimization apparatus, according to the problem to be solved, the number of spin bits used (equivalent to the scale of the problem) and the number of bits of the weight coefficient (equivalent to the precision of condition representation in the problem) possibly change. For example, in a problem in a certain field, a comparatively large number of spin bits are used and the number of bits of the weight coefficient may be comparatively small in some cases. Meanwhile, in a problem in another field, the number of spin bits may be comparatively small, whereas a comparatively large number of bits of the weight coefficient are used in other cases. However, it is inefficient to manufacture an optimization apparatus having the number of spin bits and the number of bits of the weight coefficient suitable for each problem individually on each problem basis.

An embodiment of optimization problem operation program, method, and apparatus according to the present disclosure will be described in detail below with reference to the drawings.

### Embodiments

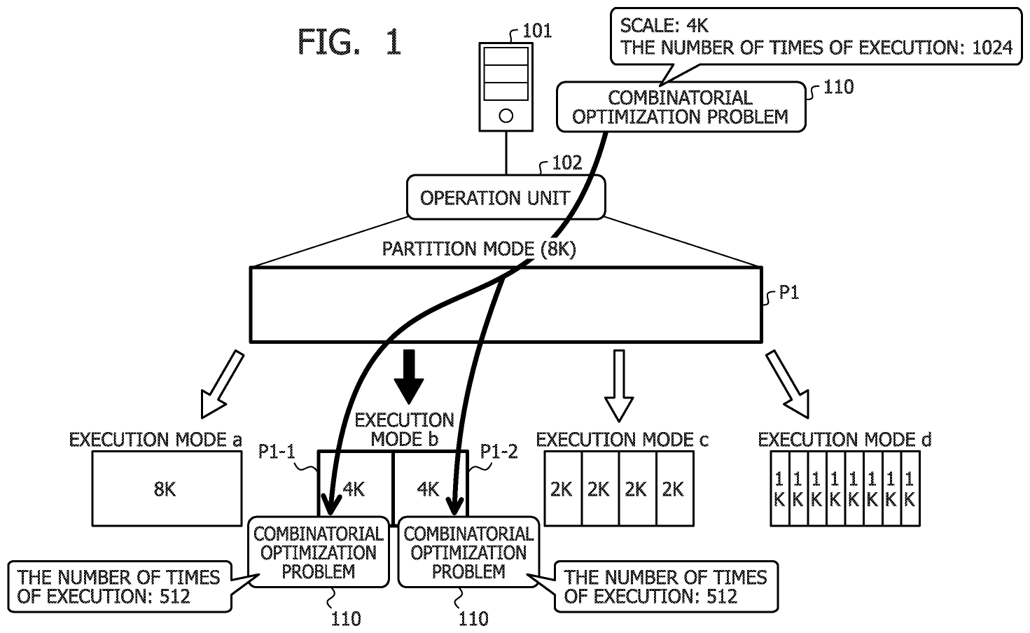

FIG. 1 is an explanatory diagram illustrating one embodiment example of an optimization problem operation method according to the embodiment. In FIG. 1, an optimization problem operation apparatus 101 is a computer that executes an operation of a combinatorial optimization problem by an operation unit 102. The operation unit 102 is a device that solves the combinatorial optimization problem.

The operation unit 102 may be divided into plural partitions logically. Dividing into partitions is delimiting the range of hardware resources used in an operation. In the operation unit 102, different problems may be solved in the respective partitions independently.

For example, when the operation unit 102 is divided into eight partitions, it becomes possible that eight users simultaneously solve different problems. For example, the operation unit 102 may be an apparatus of a separate body that is coupled to the optimization problem operation apparatus 101 and is used or may be an apparatus incorporated in the optimization problem operation apparatus 101.

The optimization problem operation apparatus 101 may change a partition mode that prescribes the logical division state of the operation unit 102 through setting to the operation unit 102. Depending on how the operation unit 102 is divided, the range of hardware resources that may be used in an operation changes and the scale and precision of a combinatorial optimization problem that may be solved in each partition are decided.

However, when the partition mode is dynamically changed, a result in an operation in a partition may be abnormal. Therefore, in the case of changing the partition mode, the optimization problem operation apparatus 101 changes the partition mode after the state in which an operation is not being executed in the respective partitions is obtained, for example.

How the operation unit 102 is divided, i.e., what kind of partition mode is prepared, may be arbitrarily set.

Furthermore, the optimization problem operation apparatus 101 may change an execution mode in each partition mode through setting to the operation unit 102. The execution mode is a mode that prescribes the range of hardware resources used in an operation. For example, in the operation unit 102, the range of hardware resources used in an operation may be specified based on the partition mode and the execution mode.

However, in the operation unit 102, change to an execution mode with higher granularity than the partition mode is not made in each partition in order to suppress the influence on other partitions. The granularity represents the maximum scale or the maximum precision of the problem that may be solved in each mode. For example, change is not made to an execution mode in which the range of hardware resources used in an operation is larger than the maximum hardware resources that may be used in each partition.

Furthermore, when change to an execution mode with lower granularity than the partition mode is made in a certain partition, the range of hardware resources used in an operation is segmented more finely. For example, one partition is further divided into plural partitions.

Here, an optimization apparatus (Ising machine) that solves a combinatorial optimization problem is desired to solve problems different in scale and the requested precision in some cases. However, the optimization apparatus of the related art has only a single mode (range of hardware resources used in an operation is fixed) and is not configured to carry out the optimum operating according to the scale and requested precision of the problem.

Therefore, in the optimization apparatus of the related art, when the scale or precision of the problem to be solved is lower than the maximum scale or precision of the problem that may be solved by hardware, the range in which the hardware makes a search and the size of the memory subjected to Direct Memory Access (DMA) transfer becomes large and the operation time increases. For example, in the case of solving a problem with a scale of “1024 bits (1K)” when the maximum scale of the problem that may be solved by hardware is “8192 bits (8K),” the search range widens and useless DMA transfer is carried out and therefore the operation performance deteriorates.

Furthermore, even if the partition mode and the execution mode are set according to the scale of the problem, the efficiency is not necessarily sufficient when the execution mode partly uses hardware resources of the optimization apparatus. For example, the case of solving a problem with a scale of “1024 bits (1K)” in the partition mode in which the maximum scale of the problem that may be solved is “8192 bits (8K)” is assumed.

In this case, it is conceivable that the execution mode is changed to an execution mode with lower granularity than the partition mode, for example, an execution mode in which the maximum scale of the problem that may be solved is “1024 bits (1K).” However, in the case of solving one problem with the scale of “1024 bits (1K)” by hardware resources that may solve the problem with the scale of “8192 bits (8K),” the hardware resources are partly used and are not efficiently used.

Therefore, in the present embodiment, description will be made regarding an optimization problem operation method in which a combinatorial optimization problem is efficiently solved by executing operations of the combinatorial optimization problem in parallel with the number of parallel operations corresponding to the execution mode by the operation unit 102 set to the partition mode and the execution mode according to the scale or requested precision of the problem. A processing example of the optimization problem operation apparatus 101 will be described below.

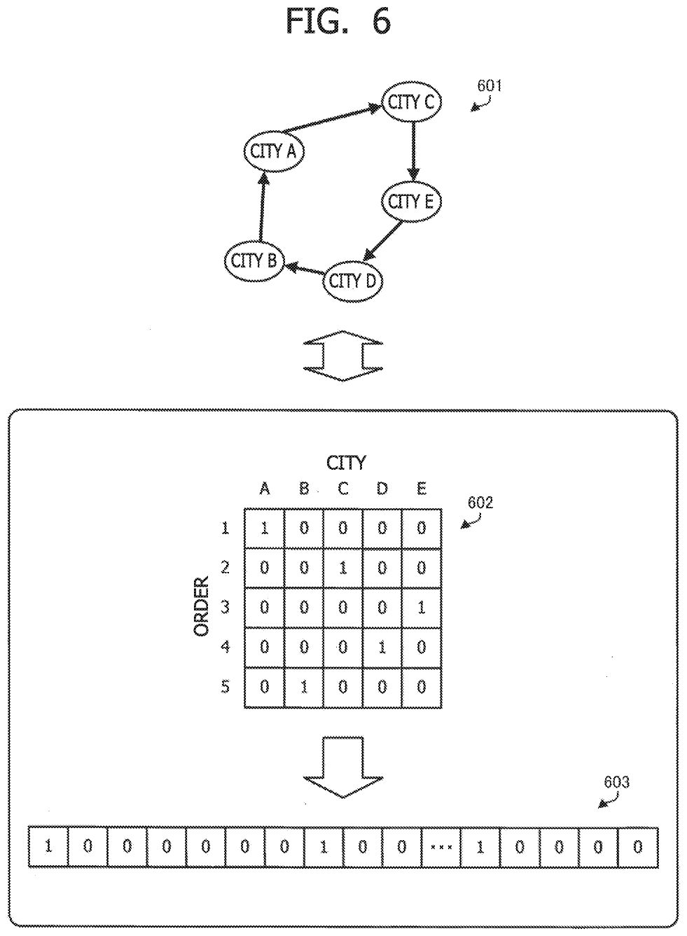

(1) The optimization problem operation apparatus 101 accepts a combinatorial optimization problem to the operation unit 102. Here, the accepted combinatorial optimization problem is a problem of a calculation target to be solved and is a problem specified by a user, for example. One example of the combinatorial optimization problem will be described later by using FIG. 6.

(2) The optimization problem operation apparatus 101 decides the partition mode of the operation unit 102 and the execution mode that prescribes the range of hardware resources used in an operation in this partition mode according to the scale or requested precision of the combinatorial optimization problem.

Here, the scale of the combinatorial optimization problem is represented by the number of spin bits of an Ising model of the combinatorial optimization problem, for example. The Ising model is a model that represents the behavior of spins of a magnetic body. The operation unit 102 replaces the problem of the calculation target by the Ising model and carries out calculation, for example. Furthermore, the requested precision of the combinatorial optimization problem is represented by the number of bits of the weight coefficient that represents the magnitude of interaction between bits, for example.

For example, the optimization problem operation apparatus 101 determines whether or not the scale of the combinatorial optimization problem is smaller than the maximum scale of the problem that may be solved in a first partition mode. Here, the first partition mode is any partition mode in plural partition modes that may be set in the operation unit 102 and is the present partition mode of the operation unit 102, for example.

If the scale of the combinatorial optimization problem is smaller than the maximum scale, the optimization problem operation apparatus 101 decides the partition mode of the operation unit 102 as the first partition mode. For example, if the first partition mode is the present partition mode, change of the partition mode is not carried out.

Furthermore, the optimization problem operation apparatus 101 decides the execution mode of the operation unit 102 as a first execution mode that prescribes the range of hardware resources corresponding to the scale of the combinatorial optimization problem in the execution modes that prescribe the range of hardware resources used in an operation in the first partition mode.

Here, the range of hardware resources corresponding to the scale of the combinatorial optimization problem is the range of the minimum hardware resources that may solve a problem with this scale, for example. For example, supposing that the scale of the combinatorial optimization problem is “2048 bits (2K),” the range of the minimum hardware resources that may solve a problem with this scale is the range of hardware resources that may solve a problem with a scale of 2048 bits (2K) or smaller.

On the other hand, if the scale of the combinatorial optimization problem is larger than the maximum scale, it is difficult to solve the combinatorial optimization problem in the first partition mode in the unchanged state. For this reason, the optimization problem operation apparatus 101 may decide the partition mode of the operation unit 102 as a second partition mode in which hardware resources corresponding to the scale of the combinatorial optimization problem may be used. For example, the optimization problem operation apparatus 101 decides the partition mode of the operation unit 102 as the second partition mode that may solve a problem with a scale equal to or larger than the scale of the combinatorial optimization problem.

However, in the case of changing the partition mode, the optimization problem operation apparatus 101 changes the partition mode in the state in which an operation is not being executed in the respective partitions in order to keep a result in an operation in a partition from becoming abnormal.

This makes it possible to execute the operation of the combinatorial optimization problem with the setting according to the scale of the combinatorial optimization problem. If the scale of the combinatorial optimization problem is larger than the maximum scale, the optimization problem operation apparatus 101 may divide the combinatorial optimization problem and solve the divided problems by using an existing decomposition solution method.

Furthermore, for example, the optimization problem operation apparatus 101 may determine whether or not the requested precision of the combinatorial optimization problem is in the range of the maximum precision of the problem that may be solved in the first partition mode. If the requested precision of the combinatorial optimization problem is in the range of the maximum precision, the optimization problem operation apparatus 101 decides the partition mode of the operation unit 102 as the first partition mode. Moreover, the optimization problem operation apparatus 101 decides the execution mode of the operation unit 102 as the first execution mode that prescribes the range of hardware resources corresponding to the requested precision of the combinatorial optimization problem.

Here, the range of hardware resources corresponding to the requested precision of the combinatorial optimization problem is the range of the minimum hardware resources that may solve a problem with this requested precision, for example. For example, supposing that the requested precision of the combinatorial optimization problem is “32 bits,” the range of the minimum hardware resources that may solve a problem with this requested precision is the range of hardware resources that may solve a problem with a precision of 32 bits or lower.

This makes it possible to execute the operation of the combinatorial optimization problem with the setting according to the requested precision of the combinatorial optimization problem.

In the example of FIG. 1, suppose that a problem of a calculation target is a “combinatorial optimization problem 110” and the scale of the combinatorial optimization problem 110 is “4096 bits (4K).” Furthermore, suppose that the number “1024” of times of execution of the combinatorial optimization problem 110 is specified. Moreover, suppose that the first partition mode is “partition mode (8K)” that is the present partition mode of the operation unit 102.

The partition mode (8K) is a partition mode that prescribes the state in which the operation unit 102 is set as one partition (in the example of FIG. 1, partition P1) logically. The maximum scale of the problem that may be solved in the partition mode (8K) is “8192 bits (8K).” For example, the maximum scale of the problem that may be solved in the partition P1 is “8192 bits (8K).”

Furthermore, suppose that, in the partition mode (8K), execution modes that may be set in the partition P1 are execution modes a, b, c, and d. The execution mode a is an execution mode that may solve a problem with a scale of “8192 bits (8K)” or smaller. The execution mode b is an execution mode that may solve a problem with a scale of “4096 bits (4K)” or smaller. The execution mode c is an execution mode that may solve a problem with a scale of “2048 bits (2K)” or smaller. The execution mode d is an execution mode that may solve a problem with a scale of “1024 bits (1K)” or smaller.

Here, description will be made by taking as an example the case in which the partition mode and the execution mode of the operation unit 102 are decided according to the scale of the combinatorial optimization problem 110.

In this case, the optimization problem operation apparatus 101 determines whether or not the scale of the combinatorial optimization problem 110 is smaller than the maximum scale of the problem that may be solved in the partition mode (8K). Here, the scale “4096 bits (4K)” of the combinatorial optimization problem 110 is smaller than the maximum scale “8192 bits (8K).”

Thus, the optimization problem operation apparatus 101 determines that the scale of the combinatorial optimization problem 110 is smaller than the maximum scale. The optimization problem operation apparatus 101 decides the partition mode of the operation unit 102 as the partition mode (8K). For example, the optimization problem operation apparatus 101 does not change the partition mode.

Furthermore, the optimization problem operation apparatus 101 decides the execution mode of the operation unit 102 as the first execution mode that prescribes the range of hardware resources corresponding to the scale of the combinatorial optimization problem 110 in the execution modes a, b, c, and d in the partition mode (8K). Here, the scale of the combinatorial optimization problem 110 is “4096 bits (4K).”

In this case, for example, the optimization problem operation apparatus 101 decides the execution mode of the operation unit 102 as the execution mode b that prescribes the range of the minimum hardware resources that may solve a problem with a scale of “4096 bits (4K).” In the execution mode b, compared with the execution mode a, the hardware resources used are less although the maximum scale of the problem that may be solved in each partition is smaller.

For example, when the execution mode of the operation unit 102 is changed from the execution mode a to the execution mode b in the partition mode (8K), the partition P1 is divided into a partition P1-1 and a partition P1-2. The maximum scale of the problem that may be solved by the respective partitions P1-1 and P1-2 is “4096 bits (4K).”

(3) With the decided partition mode and execution mode, the optimization problem operation apparatus 101 causes operations of the optimization problem to be executed in parallel in the operation unit 102 based on the number of times obtained by dividing the number of times of execution of the combinatorial optimization problem by the number of divisions corresponding to this execution mode.

Here, the number of times of execution of the combinatorial optimization problem is the number of times the operation of the combinatorial optimization problem is executed. The number of times of execution of the combinatorial optimization problem may be the number of times a problem of the same contents is repeatedly solved, for example. Furthermore, the number of times of execution of the combinatorial optimization problem may be the number of times problems of different contents are solved with the same scale and requested precision, for example. For example, the number “1024” of times of execution of the combinatorial optimization problem 110 represents the number of times a problem of the same contents is repeatedly solved.

The number of divisions corresponding to the execution mode is the number of operations that may be executed in parallel. For example, in the partition P1 in the partition mode (8K), the number of divisions corresponding to the execution mode a is “1.” Furthermore, the number of divisions corresponding to the execution mode b is “2.” The number of divisions corresponding to the execution mode c is “4.” The number of divisions corresponding to the execution mode d is “8.”

In the example of FIG. 1, the partition mode and the execution mode of the operation unit 102 are the partition mode (8K) and the execution mode b. Here, in the partition mode (8K), the number of divisions corresponding to the execution mode b is “2.” The number of times obtained by dividing the number “1024” of times of execution of the combinatorial optimization problem 110 by the number “2” of divisions corresponding to the execution mode b is “512.”

In this case, the optimization problem operation apparatus 101 assigns the combinatorial optimization problem 110 corresponding to 512 times to each of the respective partitions P1-1 and P1-2 of the operation unit 102. The optimization problem operation apparatus 101 causes operations of the combinatorial optimization problem 110 corresponding to 512 times to be executed in parallel in the respective partitions P1-1 and P1-2 with the partition mode (8K) and the execution mode b.

As above, according to the optimization problem operation apparatus 101, operations of the combinatorial optimization problem regarding which number of times of execution is specified may be executed in parallel with the partition mode and the execution mode according to the scale or requested precision of the problem. This may effectively use hardware resources of the operation unit 102 and enhance the operation efficiency, so that increase in the speed of operation processing of plural problems (repetition of the same problem and different problems are both available) may be intended.

In the example of FIG. 1, by the operation unit 102 set to the partition mode (8K) and the execution mode b according to the scale of the problem, operations of the combinatorial optimization problem 110 may be executed in parallel with the number “2” of parallel operations corresponding to this execution mode b. This may enhance the operation efficiency doubly compared with the case in which operations of the combinatorial optimization problem 110 corresponding to 1024 times are caused to be executed in one partition P1.

One Embodiment Example of Operation Unit 102

Next, one embodiment example of the operation unit 102 illustrated in FIG. 1 will be described.

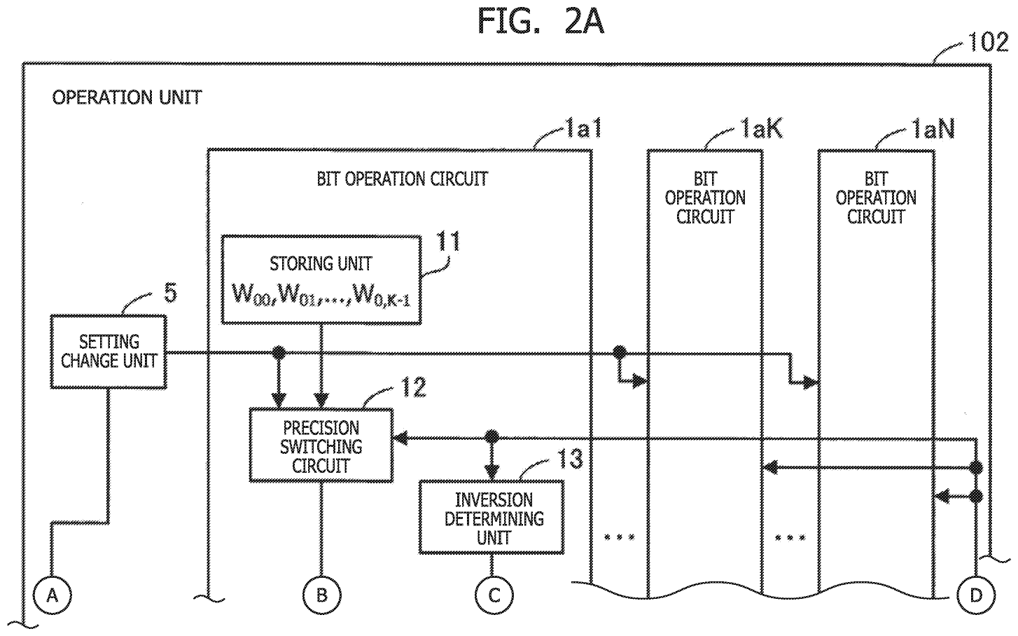

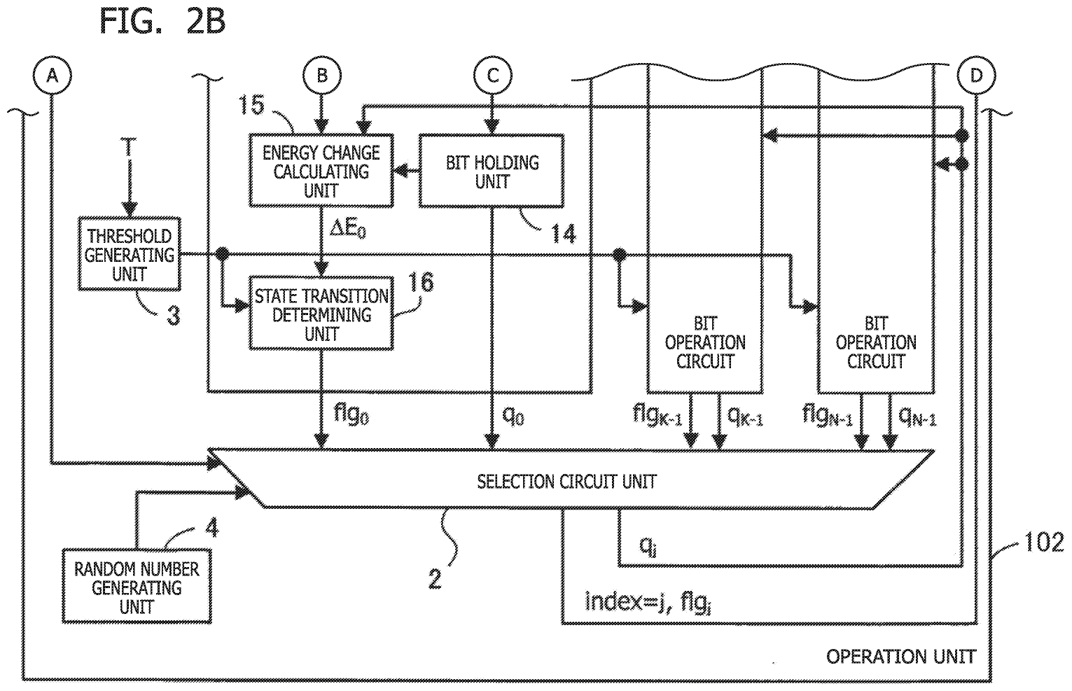

FIGS. 2A and 2B represent an explanatory diagram illustrating the one embodiment example of the operation unit 102. In FIGS. 2A and 2B, the operation unit 102 searches for the values of the respective bits when an energy function becomes the minimum value (ground state) in the combinations (states) of the respective values of plural bits corresponding to plural spins (spin bits) included in an Ising model obtained by converting a problem of a calculation target (combinatorial optimization problem).

An energy function E(x) of the Ising type is defined by the following expression (1), for example.

$$E ( x ) = - {\sum }_{〈 i , j 〉}^{ } {W}_{ij} {x}_{i} {x}_{j} - {\sum }_{i}^{ } {b}_{i} {x}_{i} \qquad ( 1 )$$

The first term on the right side is what integrates the products among the values (0 or 1) of two bits and the coupling coefficient regarding all combinations of two bits that may be selected from all bits included in the Ising model without omission and overlapping. The number of all bits included in the Ising model is defined as K (K is an integer equal to or larger than 2). Furthermore, each of i and j is defined as an integer that is at least 0 and at most K−1. xᵢ is a variable that represents the value of the i-th bit (referred to also as state variable). xⱼ is a variable that represents the value of the j-th bit. W; is the weight coefficient that represents the magnitude of interaction between the i-th and j-th bits. Wᵢᵢ=0 holds. Moreover, Wᵢⱼ=Wⱼᵢ in many cases holds (for example, coefficient matrix based on the weight coefficients is a symmetric matrix in many cases).

The second term on the right side is what obtains the total sum of the products between a bias coefficient and the value of the bit regarding each of all bits. bᵢ represents the bias coefficient of the i-th bit.

Furthermore, when the value of the variable xᵢ changes to become 1−xᵢ, the amount of increase in the variable xᵢ is represented as Δxᵢ=(1−xᵢ)−xᵢ=1-2xᵢ. Therefore, energy change ΔEᵢ in association with spin inversion (change in the value) is represented by the following expression (2).

$$\begin{matrix}{Δ {E}_{i} = E ( x ) \vert}_{{x}_{i} -> 1 - {x}_{i}} - E ( x ) \\ = - Δ {x}_{i} ( {\sum }_{j}^{ } {W}_{ij} {x}_{j} + {b}_{i} ) \\ = - Δ {x}_{i} {h}_{i} \\ = \{ \begin{matrix}- {h}_{i} & ( for {x}_{i} = 0 -> 1 ) \\ + {h}_{i} & ( for {x}_{i} = 1 -> 0 )\end{matrix}\end{matrix} \qquad ( 2 )$$

hᵢ is referred to as a local field and is represented by the following expression (3).

$${h}_{i} = {\sum }_{j}^{ } {W}_{ij} {x}_{j} + {b}_{i} \qquad ( 3 )$$

What is obtained by multiplying the local field hᵢ by a sign (+1 or −1) according to Δxᵢ is the energy change ΔEᵢ. An amount Δhᵢ of change in the local field hᵢ is represented by the following expression (4).

$$Δ {h}_{i} = \{ \begin{matrix}+ {W}_{ij} & ( for {x}_{j} = 0 -> 1 ) \\ - {W}_{ij} & ( for {x}_{j} = 1 -> 0 )\end{matrix} \qquad ( 4 )$$

Processing of updating the local field hᵢ when the certain variable xⱼ changes is executed in parallel.

The operation unit 102 is a semiconductor integrated circuit of one chip and is implemented by using a field programmable gate array (FPGA) or the like, for example. The operation unit 102 includes bit operation circuits 1a1, . . . , 1aK, . . . , and 1aN (plural bit operation circuits), a selection circuit unit 2, a threshold generating unit 3, a random number generating unit 4, and a setting change unit 5. Here, N is the total number of bit operation circuits included in the operation unit 102. N is an integer equal to or larger than K. Identification information (index=0, . . . , K−1, . . . , and N−1) is associated with each of the bit operation circuits 1a1, . . . , 1aK, . . . , and 1aN.

The bit operation circuits 1a1, . . . , 1aK, . . . , and 1aN are unit elements that provide one bit included in a bit string that represents the state of an Ising model. This bit string may be referred to as spin bit string, state vector, or the like. Each of the bit operation circuits 1a1, . . . , 1aK, . . . , and 1aN stores the weight coefficients between the self-bit and the other bits and determines whether or not inversion of the self-bit in response to inversion of another bit is possible based on the weight coefficient to output a signal indicating whether or not inversion of the self-bit is possible to the selection circuit unit 2.

The selection circuit unit 2 selects the bit to be inverted (inversion bit) in the spin bit string. For example, the selection circuit unit 2 accepts a signal indicating whether or not inversion is possible, output from each of the bit operation circuits 1a1, . . . , and 1aK used for the search for the ground state of the Ising model in the bit operation circuits 1a1, . . . , 1aK, . . . , and 1aN. The selection circuit unit 2 preferentially selects one bit corresponding to the bit operation circuit that has output a signal indicating that inversion is possible in the bit operation circuits 1a1, . . . , and 1aK and employs it as the inversion bit. For example, the selection circuit unit 2 selects this inversion bit based on random number bits output by the random number generating unit 4. The selection circuit unit 2 outputs a signal that represents the selected inversion bit to the bit operation circuits 1a1, . . . , and 1aK. The signal that represents the inversion bit includes a signal that represents identification information of the inversion bit (Index=j), a flag indicating whether or not inversion is possible (flgⱼ; =1), and a present value qⱼ of the inversion bit (value before inversion of this time). However, none of the bits are inverted in some cases. If none of the bits are inverted, the selection circuit unit 2 outputs flgⱼ=0.

The threshold generating unit 3 generates a threshold used when whether inversion of the bit is possible is determined for each of the bit operation circuits 1a1, . . . , 1aK, . . . , and 1aN. The threshold generating unit 3 outputs a signal that represents this threshold to each of the bit operation circuits 1a1, . . . , 1aK, . . . , and 1aN. As described later, the threshold generating unit 3 uses a parameter (temperature parameter T) that represents the temperature and a random number for the generation of the threshold. The threshold generating unit 3 includes a random number generator that generates this random number. It is preferable for the threshold generating unit 3 to include the random number generator individually for each of the bit operation circuits 1a1, . . . , 1aK, . . . , and 1aN and carry out generation and supply of the threshold individually. However, the random number generator of the threshold generating unit 3 may be shared by a given number of bit operation circuits.

The random number generating unit 4 generates the random number bits and outputs them to the selection circuit unit 2. The random number bits generated by the random number generating unit 4 are used for selection of the inversion bit by the selection circuit unit 2.

The setting change unit 5 changes a first number of bits (the number of spin bits) of the bit string (spin bit string) that represents the state of the Ising model of the calculation target in the bit operation circuits 1a1, . . . , 1aK, . . . , and 1aN. Furthermore, the setting change unit 5 changes a second number of bits of the weight coefficient for each of the bit operation circuits of the first number of bits.

Here, the first number of bits (the number of spin bits) is equivalent to the scale of the problem (combinatorial optimization problem). The second number of bits (the number of bits of the weight coefficient) is equivalent to the precision of the problem. The optimization problem operation apparatus 101 implements an operation with the partition mode and the execution mode decided according to the scale or requested precision of the combinatorial optimization problem by controlling the setting to the setting change unit 5 regarding the first and second numbers of bits.

Next, the circuit configuration of the bit operation circuit will be described. Although the bit operation circuit 1a1 (index=0) will be mainly described, the other bit operation circuits may also be implemented by the same circuit configuration (for example, index=X−1 is set regarding the X-th (X is an integer of at least 1 and at most N) bit operation circuit).

The bit operation circuit 1a1 includes a storing unit 11, a precision switching circuit 12, an inversion determining unit 13, a bit holding unit 14, an energy change calculating unit 15, and a state transition determining unit 16.

The storing unit 11 is a register, static random access memory (SRAM), or the like, for example. The storing unit 11 stores the weight coefficients between the self-bit (here, bit of index=0) and the other bits. Here, for the number K of spin bits (first number of bits), the total number of weight coefficients is K². In the storing unit 11, K weight coefficients W₀₀, W₀₁, . . . , and W_{0,K-1} are stored for the bit of index=0. Here, the weight coefficient is represented by the second number L of bits. Therefore, in the storing unit 11, K×L bits are used in order to store the weight coefficients. The storing unit 11 may be disposed outside the bit operation circuit 1a1 and inside the operation unit 102 (this similarly applies to the storing units 11 of the other bit operation circuits).

When any bit of the spin bit string is inverted, the precision switching circuit 12 reads out the weight coefficient for the inverted bit from the storing unit 11 of its own (of the bit operation circuit 1a1) and outputs the read-out weight coefficient to the energy change calculating unit 15. For example, the precision switching circuit 12 accepts the identification information of the inversion bit from the selection circuit unit 2 and reads out the weight coefficient corresponding to the set of the inversion bit and the self-bit from the storing unit 11 to output it to the energy change calculating unit 15.

At this time, the precision switching circuit 12 reads out the weight coefficient represented by the second number of bits set by the setting change unit 5. The precision switching circuit 12 changes the second number of bits of the coefficient read out from the storing unit 11 according to the setting of the second number of bits by the setting change unit 5.

For example, the precision switching circuit 12 includes a selector that reads out a bit string of a given number of bits from the storing unit 11. If the given number of bits of the bit string read out by the selector is larger than the second number of bits, the precision switching circuit 12 reads out a unit bit string including the weight coefficient corresponding to the inversion bit by this selector and extracts the weight coefficient represented by the second number of bits from the read-out unit bit string. Alternatively, if the given number of bits of the bit string read out by the selector is smaller than the second number of bits, the precision switching circuit 12 may extract the weight coefficient represented by the second number of bits from the storing unit 11 by coupling plural bit strings read out by this selector.

The inversion determining unit 13 accepts the signal that represents index=j and flgⱼ output by the selection circuit unit 2 and determines whether or not the self-bit has been selected as the inversion bit based on this signal. If the self-bit has been selected as the inversion bit (for example, if index=j represents the self-bit and flgⱼ indicates that inversion is possible), the inversion determining unit 13 inverts the bit stored in the bit holding unit 14. For example, if the bit held by the bit holding unit 14 is 0, this bit is changed to 1. Furthermore, if the bit held by the bit holding unit 14 is 1, this bit is changed to 0.

The bit holding unit 14 is a register that holds one bit. The bit holding unit 14 outputs the held bit to the energy change calculating unit 15 and the selection circuit unit 2.

The energy change calculating unit 15 calculates the energy change value ΔE₀ of the Ising model using the weight coefficient read out from the storing unit 11 and outputs it to the state transition determining unit 16. For example, the energy change calculating unit 15 accepts the value of the inversion bit (value before inversion of this time) from the selection circuit unit 2 and calculates Δh₀ based on the above-described expression (4) depending on whether the inversion bit is inverted from 1 to 0 or from 0 to 1. The energy change calculating unit 15 updates h₀ by adding Δh₀ to the previous h₀. The energy change calculating unit 15 includes a register that holds h₀ and holds h₀ after the update by this register.

Moreover, the energy change calculating unit 15 accepts the present self-bit from the bit holding unit 14 and calculates, based on the above-described expression (2), the energy change value ΔE₀ of the Ising model when the self-bit is inverted from 0 to 1 if the self-bit is 0 or when the self-bit is inverted from 1 to 0 if the self-bit is 1. The energy change calculating unit 15 outputs the calculated energy change value ΔE₀ to the state transition determining unit 16.

The state transition determining unit 16 outputs the signal flg₀ indicating whether or not inversion of the self-bit is possible to the selection circuit unit 2 according to the calculation of the energy change by the energy change calculating unit 15. For example, the state transition determining unit 16 is a comparator that accepts the energy change value ΔE₀ calculated by the energy change calculating unit 15 and determines whether or not inversion of the self-bit is possible according to comparison with the threshold generated by the threshold generating unit 3. Here, the determination by the state transition determining unit 16 will be described.

In the simulated annealing, it is known that the state reaches the optimal solution (ground state) in the limit as time (the number of times of iteration) goes to infinity when acceptable probability p(ΔE, T) of state transition that causes certain energy change ΔE is settled as represented by the following expression (5).

$$p ( Δ E , T ) = f ( - \frac{Δ E}{T} ) \qquad ( 5 )$$

In the above-described expression (5), T is the above-described temperature parameter T. Here, as the function f, the following expression (6) (Metropolis method) or the following expression (7) (Gibbs method) is used.

$$\begin{matrix}{f}_{metro} ( x ) = min ( 1 , {e}^{z} ) & ( 6 ) \\ {f}_{Gibbs} ( x ) = \frac{1}{1 + {e}^{- z}} & ( 7 )\end{matrix}$$

The temperature parameter T is represented by the following expression (8), for example. For example, the temperature parameter T is given as a function that logarithmically decreases with respect to the number t of times of iteration. For example, a constant c is decided according to the problem.

$$T = \frac{{T}_{0} log ( c )}{log ( t + c )} \qquad ( 8 )$$

Here, T₀ is an initial temperature value and it is desirable to set it sufficiently high according to the problem.

When the acceptable probability p(ΔE, T) represented by the above-described expression (5) is used, if a steady state is reached after sufficient iteration of state transition at a certain temperature, this state is generated in accordance with a Boltzmann distribution. For example, the occupation probability of each state obeys a Boltzmann distribution with respect to a thermal equilibrium state in thermodynamics. Thus, by gradually decreasing the temperature in such a manner that a state that obeys a Boltzmann distribution is generated at a certain temperature and thereafter a state that obeys a Boltzmann distribution is generated at a temperature lower than this temperature, the state that obeys the Boltzmann distribution at each temperature may be traced. Furthermore, when the temperature is set to 0, the state of the lowest energy (ground state) is implemented at high probability by the Boltzmann distribution at the temperature 0. This behavior is very similar to state change when a material is annealed and therefore this method is referred to as simulated annealing. At this time, stochastic occurrence of state transition by which the energy rises is equivalent to thermal excitation in physics.

For example, a circuit that outputs a flag (flg=1) indicating that state transition causing the energy change ΔE is permitted at the acceptable probability p(ΔE, T) may be implemented by a comparator that outputs a value according to comparison between f(−ΔE/T) and a uniform random number u that takes a value in an interval [0, 1).

However, the same function may be implemented also when the following modification is made. When the same monotonically increasing function is made to act on two numbers, the magnitude relation between the numbers does not change. Therefore, even when the same monotonically increasing function is made to act on two inputs of a comparator, the output of the comparator does not change. For example, an inverse function f⁻¹(−ΔE/T) of f(−ΔE/T) may be used as the monotonically increasing function made to act on f(−ΔE/T) and f⁻¹(u) obtained by replacing −ΔE/T in f⁻¹(−ΔE/T) by u may be used as the monotonically increasing function made to act on the uniform random number u. In this case, it suffices that the circuit having a similar function to the above-described comparator is a circuit that outputs 1 when −ΔE/T is larger than f⁻¹(u). Moreover, because the temperature parameter T is positive, it suffices for the state transition determining unit 16 to be a circuit that outputs flg₀=1 when −ΔE is larger than T·f⁻¹(u) (alternatively when ΔE is smaller than −(T·f⁻¹(u))).

The threshold generating unit 3 generates the uniform random number u and outputs the value of the above-described f⁻¹(u) by using a conversion table to convert the uniform random number u to the value of f⁻¹(u). When the Metropolis method is applied, f⁻¹(u) is given by the following expression (9). Furthermore, when the Gibbs method is applied, f⁻¹(u) is given by the following expression (10).

$$\begin{matrix}{f}_{metro}^{- 1} ( u ) = log ( u ) & ( 9 ) \\ {f}_{Gibbs}^{- 1} ( u ) = log ( \frac{u}{1 - u} ) & ( 10 )\end{matrix}$$

The conversion table is stored in a memory (diagrammatic representation is omitted) such as a random access memory (RAM) or flash memory coupled to the threshold generating unit 3, for example. The threshold generating unit 3 outputs a product (T·f⁻¹(u)) between the temperature parameter T and f⁻¹(u) as the threshold. Here, T·f⁻¹(u) is equivalent to thermal excitation energy.

When flgⱼ is input from the selection circuit unit 2 to the state transition determining unit 16 and this flgⱼ indicates that state transition is not permitted (for example, when state transition does not occur), the comparison with the threshold may be carried out after an offset value is added to −ΔE₀ by the state transition determining unit 16. Furthermore, if non-occurrence of state transition continues, the state transition determining unit 16 may increase the offset value to be added. On the other hand, the state transition determining unit 16 sets the offset value to 0 when flg₃ indicates that state transition is permitted (for example, when state transition occurs). Permission of state transition is facilitated due to the addition of the offset value to −ΔE₀ and the increase in the offset value and, if the present state is trapped at a local solution, the escape from the local solution is promoted.

In this manner, the temperature parameter T is set gradually smaller and, for example, a spin bit string when the value of the temperature parameter T has been decreased a given number of times (or when the temperature parameter T has reached the minimum value) is held by the bit operation circuits 1a1, . . . , and 1aK. The operation unit 102 outputs the spin bit string when the value of the temperature parameter T has been decreased the given number of times (or when the temperature parameter T has reached the minimum value) as a solution. The operation unit 102 may include a control unit (diagrammatic representation is omitted) that carries out setting of the temperature parameter T and the weight coefficients for the storing unit 11 of each of the bit operation circuits 1a1, . . . , and 1aK and reads out and outputs the spin bit string held in the bit operation circuits 1a1, . . . , and 1aK.

In the operation unit 102, the number of spin bits of the Ising model (first number of bits) and the number of bits of the weight coefficient between bits (second number of bits) may be changed by the setting change unit 5. Here, the number of spin bits is equivalent to the scale of the circuit that implements the Ising model (scale of the problem). When the scale is larger, the operation unit 102 may be applied to a combinatorial optimization problem having a larger number of combination candidates. Furthermore, the number of bits of the weight coefficient is equivalent to the precision of representation of the mutual relation between bits (precision of condition representation in the problem). When the precision is higher, the conditions with respect to the energy change ΔE at the time of spin inversion may be set in more detail. In a certain problem, the number of spin bits is large and the number of bits that represents the weight coefficient is small in some cases. Alternatively, in another problem, the number of spin bits is small and the number of bits that represents the weight coefficient is large in some cases. It is inefficient to individually manufacture the optimization apparatus suitable for each problem according to the problem.

Therefore, in the operation unit 102, the scale and the precision may be made variable by enabling setting of the number of spin bits that represent the state of the Ising model and the number of bits of the weight coefficient by the setting change unit 5. For example, the partition mode may be changed. As a result, scale and precision that match the problem may be implemented in one operation unit 102.

For example, each of the bit operation circuits 1a1, . . . , 1aK, . . . , and 1aN includes the precision switching circuit 12 and switches the bit length of the weight coefficient read out from the storing unit 11 of its own according to a setting of the setting change unit 5 by the precision switching circuit 12. Furthermore, the selection circuit unit 2 inputs a signal that represents the inversion bit to the bit operation circuits in a number (for example, K) equivalent to the number of spin bits set by the setting change unit 5 and selects the inversion bit from bits corresponding to the bit operation circuits in this number (K). This may implement the Ising model with scale and precision according to the problem by one operation unit 102 without individually manufacturing the optimization apparatus having scale and precision according to the problem.

Here, as described above, the storing unit 11 included in each of the bit operation circuits 1a1, . . . , and 1aN is implemented by a storing device with comparatively low capacity, such as an SRAM. For this reason, it is also conceivable that, when the number of spin bits increases, the capacity of the storing unit 11 becomes insufficient depending on the number of bits of the weight coefficient. On the other hand, according to the operation unit 102, it also becomes possible to set the scale and the precision in such a manner that the limit to the capacity of the storing unit 11 is not exceeded by the setting change unit 5. For example, it is conceivable that the setting change unit 5 carries out the setting to decrease the number of bits of the weight coefficient as the number of spin bits increases. Furthermore, it is also conceivable that the setting change unit 5 carries out the setting to decrease the number of spin bits as the number of bits of the weight coefficient increases.

Furthermore, in the above-described example, K bit operation circuits in N bit operation circuits are used for an Ising model. In the case ofN−K≥K, the operation unit 102 may implement the same Ising model as the above-described Ising model by K bit operation circuits in the remaining N−K bit operation circuits and enhance the degree of parallelism of the same problem processing by both Ising models to increase the speed of calculation.

Moreover, the operation unit 102 may implement another Ising model corresponding to another problem by using part of the remaining N−K bit operation circuits and execute an operation of the other problem in parallel to the problem represented by the above-described Ising model.

Alternatively, the operation unit 102 may cause the remaining N−K bit operation circuits not to be used. In this case, the selection circuit unit 2 forcibly sets all of the flags fig output by the remaining N−K bit operation circuits to 0 to keep the bits corresponding to the remaining N−K bit operation circuits from being selected as an inversion candidate.

System Configuration Example of Information Processing System 300

Next, a system configuration example of an information processing system 300 including the optimization problem operation apparatus 101 illustrated in FIG. 1 will be described.

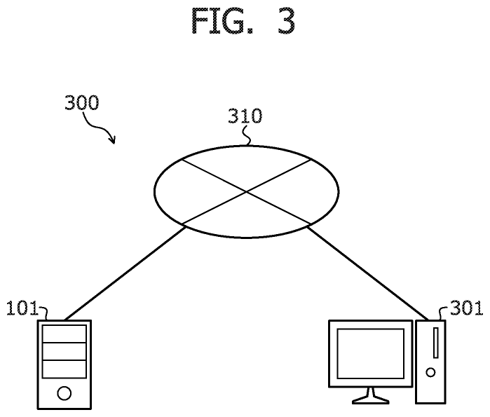

FIG. 3 is an explanatory diagram illustrating the system configuration example of the information processing system 300. In FIG. 3, the information processing system 300 includes the optimization problem operation apparatus 101 and a client apparatus 301. In the information processing system 300, the optimization problem operation apparatus 101 and the client apparatus 301 are coupled through a wired or wireless network 310. The network 310 is a local area network (LAN), wide area network (WAN), the Internet, or the like, for example.

The optimization problem operation apparatus 101 provides a function of replacing a combinatorial optimization problem by an Ising model and solving the combinatorial optimization problem through a search for the ground state of the Ising model. The optimization problem operation apparatus 101 is an on-premise server or a server in cloud computing, for example.

The client apparatus 301 is a computer used by a user. The client apparatus 301 is used for input of a problem to be solved by the user to the optimization problem operation apparatus 101, for example. The client apparatus 301 is a personal computer (PC), tablet PC, or the like, for example.

Hardware Configuration Example of Optimization Problem Operation Apparatus 101

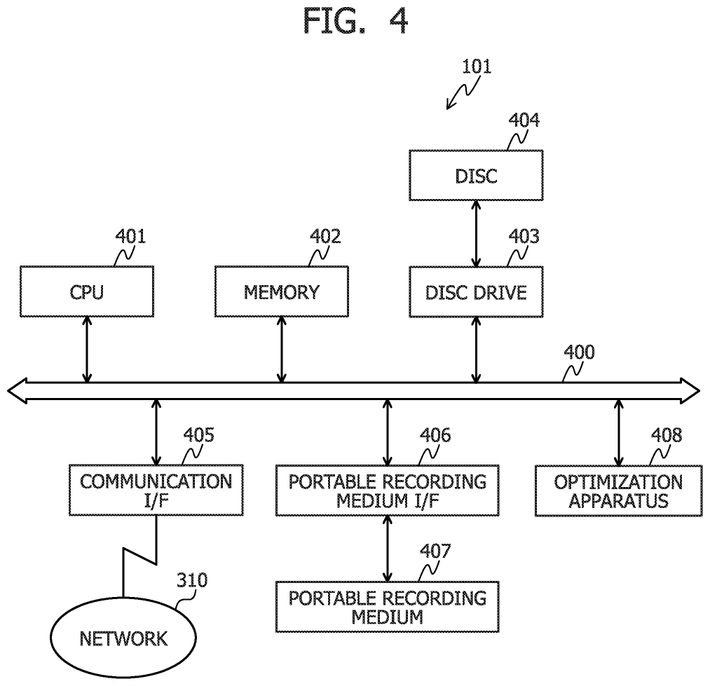

FIG. 4 is a block diagram illustrating a hardware configuration example of the optimization problem operation apparatus 101. In FIG. 4, the optimization problem operation apparatus 101 includes a central processing unit (CPU) 401, a memory 402, a disc drive 403, a disc 404, a communication interface (I/F) 405, a portable recording medium I/F 406, a portable recording medium 407, and an optimization apparatus 408. Furthermore, the respective constitutional units are each coupled by a bus 400. The bus 400 is a Peripheral Component Interconnect Express (PCIe) bus, for example.

Here, the CPU 401 is responsible for control of the whole of the optimization problem operation apparatus 101. The CPU 401 may include plural cores. The CPU 401 may be a multi-CPU. The memory 402 includes read only memory (ROM), RAM, flash ROM, and so forth, for example. For example, the flash ROM stores a program of an operating system (OS), and the ROM stores application programs, and the RAM is used as a work area of the CPU 401. The program stored in the memory 402 is loaded into the CPU 401 and thereby causes the CPU 401 to execute processing subjected to coding.

The disc drive 403 controls read/write of data from/to the disc 404 in accordance with control by the CPU 401. The disc 404 stores data written by control by the disc drive 403. As the disc 404, magnetic disc, optical disc, and so forth are cited, for example.

The communication I/F 405 is coupled to the network 310 through a communication line and is coupled to an external computer (for example, the client apparatus 301 illustrated in FIG. 3) through the network 310. Furthermore, the communication I/F 405 is responsible for an interface between the network 310 and the inside of the apparatus and controls input and output of data from the external computer. As the communication I/F 405, a modem, LAN adapter, or the like may be employed, for example.

The portable recording medium I/F 406 controls read/write of data from/to the portable recording medium 407 in accordance with control by the CPU 401. The portable recording medium 407 stores data written by control by the portable recording medium I/F 406. As the portable recording medium 407, Compact Disc (CD)-ROM, Digital Versatile Disc (DVD), Universal Serial Bus (USB) memory, and so forth are cited, for example.

The optimization apparatus 408 searches for the ground state of an Ising model in accordance with control by the CPU 401. The optimization apparatus 408 is one example of the operation unit 102 illustrated in FIG. 1.

The optimization problem operation apparatus 101 may include a solid state drive (SSD), an input apparatus, a display, and so forth, for example, besides the above-described constituent units. Furthermore, the optimization problem operation apparatus 101 does not need to include the disc drive 403, the disc 404, the portable recording medium I/F 406, and the portable recording medium 407, for example, in the above-described constitutional units. Moreover, the client apparatus 301 illustrated in FIG. 3 includes a CPU, a memory, a communication I/F, an input apparatus, a display, and so forth, for example.

Relation of Hardware in Information Processing System 300

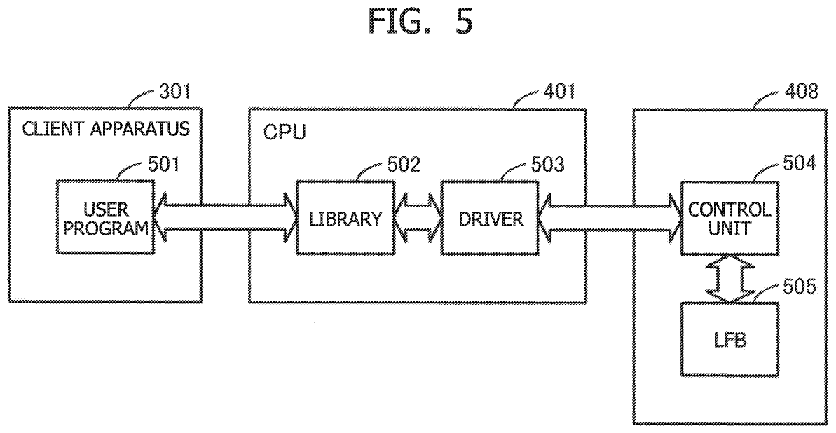

FIG. 5 is an explanatory diagram illustrating one example of the relation of hardware in the information processing system 300. In FIG. 5, the client apparatus 301 executes a user program 501. The user program 501 carries out input of various kinds of data (for example, contents of a problem to be solved and operating conditions such as the use schedule of the optimization apparatus 408) to the optimization problem operation apparatus 101, display of an operation result by the optimization apparatus 408, and so forth.

The CPU 401 is a processor (operation unit) that executes a library 502 and a driver 503. A program of the library 502 and a program of the driver 503 are stored in the memory 402 (see FIG. 4), for example.

The library 502 accepts various kinds of data input by the user program 501 and converts a problem to be solved by a user to a problem of searching for the lowest energy state of an Ising model. The library 502 provides information relating to the problem after the conversion (for example, the number of spin bits, the number of bits that represent the weight coefficient, the values of the weight coefficients, the initial value of the temperature parameter, and so forth) to the driver 503. Furthermore, the library 502 acquires the search result of the solution by the optimization apparatus 408 from the driver 503 and converts this search result to result information that is easy for the user to understand (for example, information on a result display screen) to provide the result information to the user program 501.

The driver 503 supplies the information provided from the library 502 to the optimization apparatus 408. Furthermore, the driver 503 acquires the search result of the solution based on the Ising model from the optimization apparatus 408 and provides it to the library 502.

The optimization apparatus 408 includes a control unit 504 and a local field block (LFB) 505 as hardware.

The control unit 504 includes a RAM that stores operating conditions of the LFB 505 accepted from the driver 503 and controls an operation by the LFB 505 based on these operating conditions. Furthermore, the control unit 504 carries out setting of initial values to various registers included in the LFB 505, storing of the weight coefficients in SRAMs, reading of a spin bit string (search result) after operation end, and so forth. The control unit 504 is implemented by an FPGA or the like, for example.

The LFB 505 includes plural local field elements (LFE). The LFEs are unit elements corresponding to spin bits. One LFE corresponds to one spin bit. As described later, the optimization apparatus 408 includes plural LFBs, for example.

One Example of Combinatorial Optimization Problem

Next, one example of a combinatorial optimization problem will be described.

FIG. 6 is an explanatory diagram Illustrating one example of a combinatorial optimization problem. As one example of a combinatorial optimization problem, a traveling salesman problem will be considered. Here, suppose that a path along which five cities, city A, city B, city C, city D, and city E, are visited at the minimum cost (distance, fee, and so forth) is obtained. A graph 601 represents one path in which the cities are regarded as nodes and movement between cities is regarded as an edge. This path is represented by a matrix 602 in which rows are associated with the order of visit and columns are associated with the cities, for example. The matrix 602 indicates that the city regarding in which a bit “1” is set is visited in increasing order of row.

Moreover, the matrix 602 may be converted to binary values 603 equivalent to a spin bit string. In the example of the matrix 602, the binary values 603 are 5×5=25 bits. The number of bits of the binary values 603 (spin bit string) increases as the number of cities as the traveling target increases. For example, when the scale of the combinatorial optimization problem becomes larger, a larger number of spin bits are desired and the number of bits (scale) of the spin bit string becomes larger.

Next, a search example of binary values that provide the minimum energy will be described.

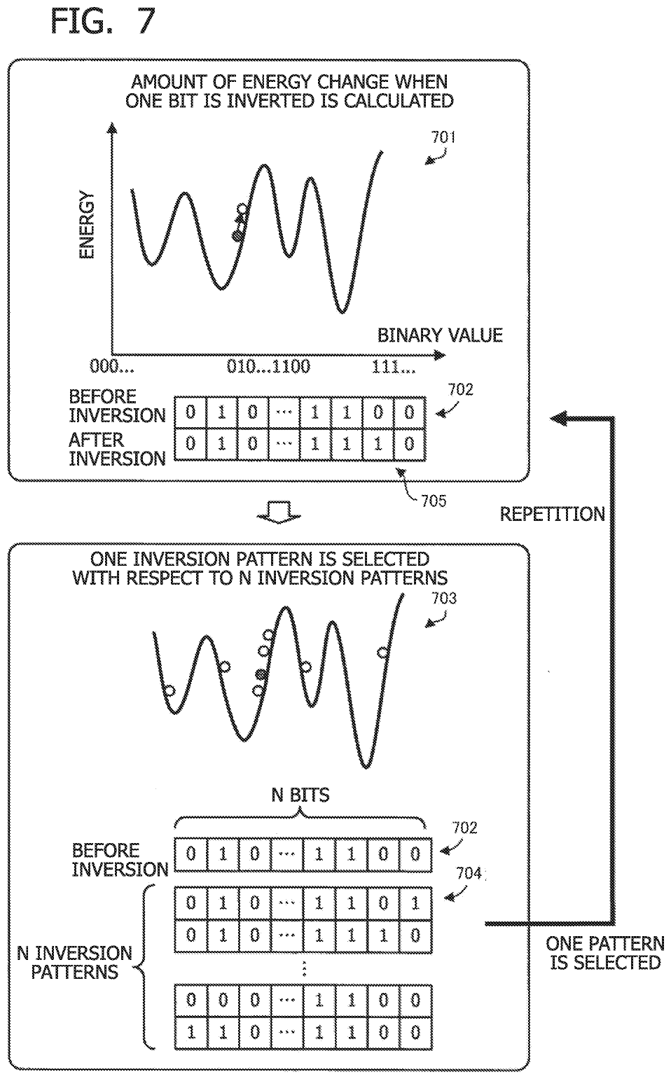

FIG. 7 is an explanatory diagram illustrating the search example of binary values that provide the minimum energy. In FIG. 7, first, energy before one bit in binary values 702 is inverted (before spin inversion) is defined as Eᵢₙᵢₜ.

The optimization apparatus 408 calculates the amount ΔE of energy change when arbitrary one bit of the binary values 702 is inverted. A graph 701 exemplifies energy change in response to one bit inversion according to an energy function, with the abscissa axis indicating the binary value and the ordinate axis indicating the energy. The optimization apparatus 408 obtains ΔE by the above-described expression (2), for example.

The optimization apparatus 408 applies the above-described calculation to all bits of the binary value 702 and calculates the amount ΔE of energy change with respect to inversion of each bit. For example, when the number of bits of the binary values 702 is N, N inversion patterns 704 are obtained. The graph 701 exemplifies how the energy changes according to each inversion pattern.

The optimization apparatus 408 randomly selects one inversion pattern 704 from the inversion patterns 704 that satisfy an Inversion condition (given determination condition between threshold and ΔE) based on ΔE of each inversion pattern. The optimization apparatus 408 adds or subtracts ΔE corresponding to the selected inversion pattern to or from Eᵢₙᵢₜ before spin inversion to calculate an energy value E after spin inversion. The optimization apparatus 408 sets the obtained energy value E as Eᵢₙᵢₜ and repeatedly carries out the above-described procedure by using binary values 705 after spin inversion.

Here, as described above, one element of W used in the above-described expressions (2) and (3) is the weight coefficient of spin inversion that represents the magnitude of interaction between bits. The number of bits that represent the weight coefficient is referred to as the precision. When the precision is higher, the conditions with respect to the amount ΔE of energy change at the time of spin inversion may be set in more detail. For example, the total size of W is “precision×the number of spin bits×the number of spin bits” with respect to all couplings of two bits included in the spin bit string. As one example, when the number of spin bits is 8 k (=8192), the total size of W is “precision×8 k×8 k.”

Circuit Configuration Example of LFB 505

Next, a circuit configuration example of the LFB 505 that is exemplified in FIG. 5 and makes a search will be described. The optimization apparatus 408 includes eight LFBs 505, for example.

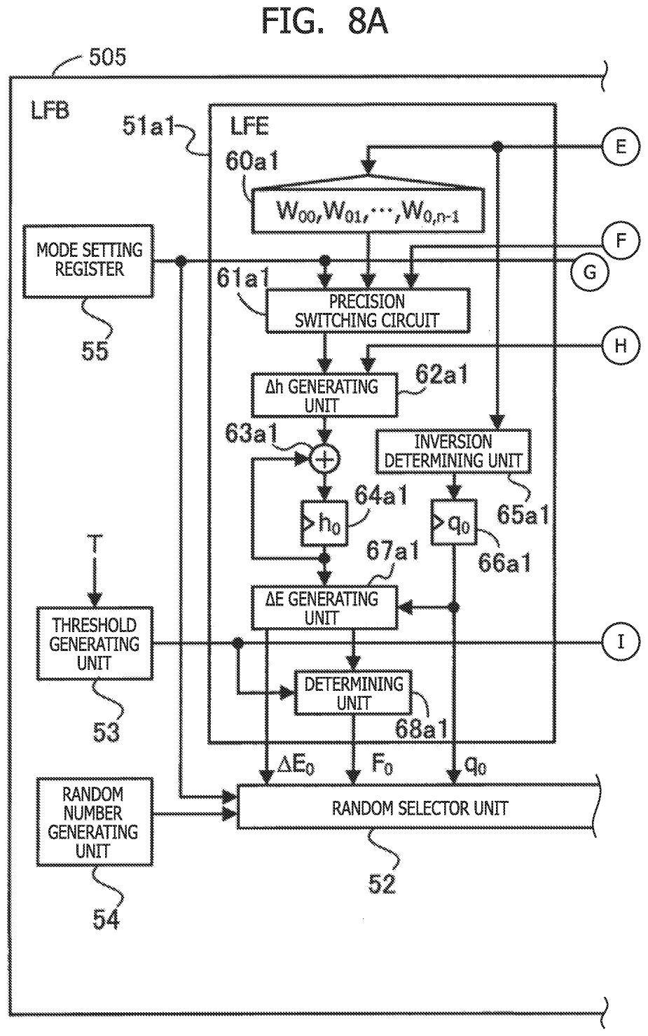

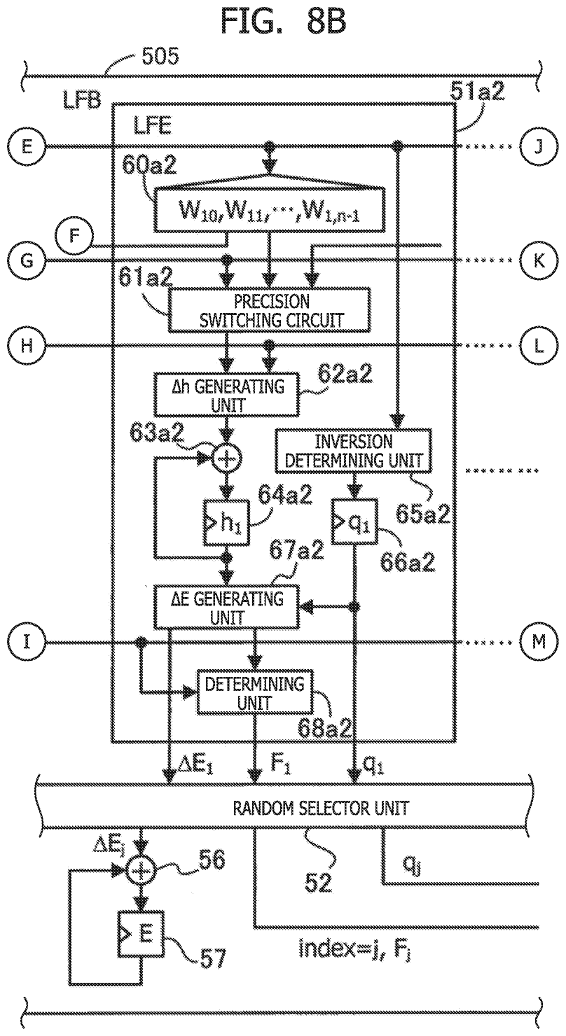

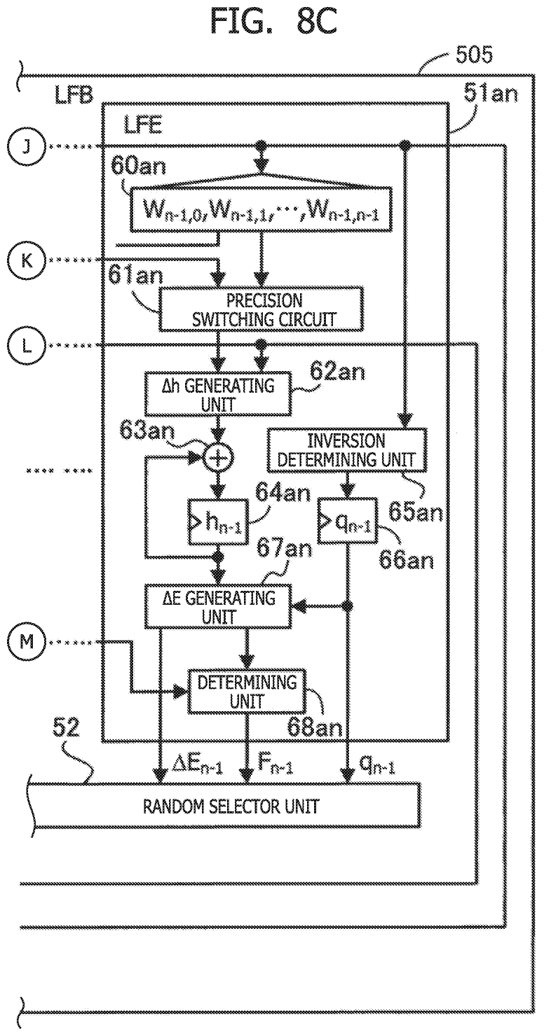

FIGS. 8A to 8C represent an explanatory diagram illustrating a circuit configuration example of an LFB. In FIGS. 8A to 8C, the LFB 505 includes LFEs 51a1, 51a2, . . . , and 51an, a random selector unit 52, a threshold generating unit 53, a random number generating unit 54, a mode setting register 55, an adder 56, and an E storing register 57.

Each of the LFEs 51a1, 51a2, . . . , and 51an is used as one bit of spin bits. n is an integer equal to or larger than 2 and represents the number of LFEs included in the LFB 505. Identification information (index) of the LFE is associated with each of the LFEs 51a1, 51a2, . . . , and 51an. index=0, 1, . . . , and n−1 are set for the LFEs 51a1, 51a2, . . . , and 51an, respectively. The LFEs 51a1, 51a2, . . . , and 51an are one example of the bit operation circuits 1a1, . . . , and 1aN illustrated in FIGS. 2A and 2B.

In the following, the circuit configuration of the LFE 51a1 will be described. The LFEs 51a2, . . . , and 51an are also implemented by the circuit configuration similar to the LFE 51a1. As for explanation of the circuit configuration of the LFEs 51a2, . . . , and 51an, a part of “a1” at the tail end of the numeral of each element in the following description may be replaced by each of “a2,” . . . , and “an” (for example, numeral “60a1” may be replaced by “60an”) and the original description may be read as description for the corresponding configuration. Furthermore, the subscript of each of values such as h, q, ΔE, and W may also be replaced by the subscript corresponding to each of “a2,” . . . , and “an” and the original description may be read as description for the corresponding configuration.

The LFE 51a1 includes an SRAM 60a1, a precision switching circuit 61a1, a Δh generating unit 62a1, an adder 63a1, an h storing register 64a1, an inversion determining unit 65a1, a bit storing register 66a1, a ΔE generating unit 67a1, and a determining unit 68a1.

The SRAM 60a1 stores weight coefficients W. The SRAM 60a1 corresponds to the storing unit 11 illustrated in FIG. 2A. In the SRAM 60a1, only the weight coefficients W used in the LFE 51a1 in the weight coefficients W of all spin bits are stored. Thus, supposing that the number of spin bits is K (K is an integer of at least 2 and at most n), the size of all weight coefficients stored in the SRAM 60a1 is “precision×K” bits. In FIGS. 8A to 8C, the case of the number K of spin bits=n is exemplified as one example. In this case, weight coefficients W₀₀, W₀₁, . . . , and W_{0,n-1} are stored in the SRAM 60a1.

The precision switching circuit 61a1 acquires an index that is identification information of the inversion bit and a flag F indicating that inversion is possible from the random selector unit 52 and extracts the weight coefficient corresponding to the inversion bit from the SRAM 60a1. The precision switching circuit 61a1 outputs the extracted weight coefficient to the Δh generating unit 62a1. For example, the precision switching circuit 61a1 may acquire, from the SRAM 60a1, index and the flag F stored in the SRAM 60a1 by the random selector unit 52. Alternatively, the precision switching circuit 61a1 may include a signal line to receive supply of index and the flag F from the random selector unit 52 (diagrammatic representation is omitted).

Here, the precision switching circuit 61a1 accepts setting of the number of bits of the weight coefficient (precision) set in the mode setting register 55 and switches the number of bits of the weight coefficient read out from the SRAM 60a1 according to this setting.

For example, the precision switching circuit 61a1 includes a selector that reads out a bit string of a given unit number of bits (unit bit string) from the SRAM 60a1. The precision switching circuit 61a1 reads out the unit bit string with a number r of bits including the weight coefficient corresponding to the inversion bit by this selector. For example, if the unit number r of bits of the unit bit string read out by this selector is larger than a number z of bits of the weight coefficient, the precision switching circuit 61a1 reads out the weight coefficient by shifting the bit part that represents the weight coefficient corresponding to the inversion bit toward the least significant bit (LSB) side and substituting 0 into the other bit part for the read-out bit string. Alternatively, the case in which the unit number r of bits is smaller than the number z of bits set by the mode setting register 55 is also conceivable. In this case, the precision switching circuit 61a1 may extract the weight coefficient with the set number z of bits by coupling plural unit bit strings read out by this selector.

The precision switching circuit 61a1 is coupled also to the SRAM 60a2 included in the LFE 51a2. As described later, it is also possible for the precision switching circuit 61a1 to read out the weight coefficient from the SRAM 60a2.

The Δh generating unit 62a1 accepts the present bit value of the inversion bit (bit value before inversion of this time) from the random selector unit 52 and calculates an amount Δh₀ of change in a local field h₀ by the above-described expression (4) by using the weight coefficient acquired from the precision switching circuit 61a1. The Δh generating unit 62a1 outputs Δh₀ to the adder 63a1.

The adder 63a1 adds Δh₀ to the local field h₀ stored in the h storing register 64a1 and outputs the resulting value to the h storing register 64a1. The h storing register 64a1 takes in the value (local field h₀) output by the adder 63a1 in synchronization with a dock signal that is not Illustrated. The h storing register 64a1 is a flip-flop, for example. The initial value of the local field h₀ stored in the h storing register 64a1 is a bias coefficient b₀. This initial value is set by the control unit 504.

The inversion determining unit 65a1 accepts index=j of the inversion bit and the flag Fⱼ indicating whether or not inversion is possible from the random selector unit 52 and determines whether or not the self-bit has been selected as the inversion bit. If the self-bit has been selected as the inversion bit, the inversion determining unit 65a1 inverts the spin bit stored in the bit storing register 66a1.

The bit storing register 66a1 holds the spin bit corresponding to the LFE 51a1. The bit storing register 66a1 is a flip-flop, for example. The spin bit stored in the bit storing register 66a1 is inverted by the inversion determining unit 65a1. The bit storing register 66a1 outputs the spin bit to the ΔE generating unit 67a1 and the random selector unit 52.

The ΔE generating unit 67a1 calculates an amount ΔE₀ of energy change of the Ising model according to inversion of the self-bit by the above-described expression (2) based on the local field h₀ of the h storing register 64a1 and the spin bit of the bit storing register 66a1. The ΔE generating unit 67a1 outputs the amount ΔE₀ of energy change to the determining unit 68a1 and the random selector unit 52.

The determining unit 68a1 outputs, to the random selector unit 52, a flag F₀ indicating whether or not to permit inversion of the self-bit (indicating whether or not inversion of the self-bit is possible) through comparison between the amount ΔE₀ of energy change output by the ΔE generating unit 67a1 and a threshold generated by the threshold generating unit 53. For example, the determining unit 68a1 outputs F₀=1 (inversion is possible) when ΔE₀ is smaller than the threshold −(T·f⁻¹(u)), and outputs F₀=0 (inversion is not possible) when ΔE₀ is equal to or larger than the threshold −(T·f⁻¹(u)). Here, f⁻¹(u) is a function given as either the above-described expression (9) or (10) according to the applied law. Furthermore, u is a uniform random number in an interval [0, 1].

The random selector unit 52 accepts the amount of energy change, the flag indicating whether or not inversion of the spin bit is possible, and the spin bit from each of the LFEs 51a1, 51a2, . . . , and 51an and selects the bit to be inverted (inversion bit) in the spin bits regarding which inversion is possible.

The random selector unit 52 supplies the present bit value (bit qⱼ) of the selected inversion bit to the Δh generating units 62a1, 62a2, . . . , and 62an included in the LFEs 51a1, 51a2, . . . , and 51an. The random selector unit 52 is one example of the selection circuit unit 2 illustrated in FIG. 2B.

The random selector unit 52 outputs index=j of the inversion bit and the flag Fⱼ indicating whether or not inversion is possible to the SRAMs 60a1, 60a2, . . . , and 60an included in the LFEs 51a1, 51a2, . . . , and 51an. The random selector unit 52 may output index=j of the inversion bit and the flag Fⱼ indicating whether or not inversion is possible to the precision switching circuits 61a1, 61a2, . . . , and 61an included in the LFEs 51a1, 51a2, . . . , and 51an as described above.

Furthermore, the random selector unit 52 supplies index=j of the inversion bit and the flag Fⱼ indicating whether or not inversion is possible to the inversion determining units 65a1, 65a2, . . . , and 65an included in the LFEs 51a1, 51a2, . . . , and 51an. Moreover, the random selector unit 52 supplies ΔE corresponding to the selected inversion bit to the adder 56.

Here, the random selector unit 52 accepts setting of the number of spin bits in a certain Ising model (for example, the number of LFEs used) from the mode setting register 55. For example, the random selector unit 52 uses the LFEs in a number equivalent to the set number of spin bits from the LFE with the smallest index sequentially to allow a search for a solution to be made. For example, when using K LFEs in the n LFEs, the random selector unit 52 selects the inversion bit from a spin bit string corresponding to the LFEs of the LFEs 51a1, . . . , and LFE 51aK. At this time, it is conceivable that the random selector unit 52 forcibly sets, to 0, the flag F output from each of n−K LFEs 51a(K+1), . . . , and 51an, which are not used, for example.

The threshold generating unit 53 generates the threshold used for the comparison with the amount ΔE of energy change and supplies it to the determining units 68a1, 68a2, . . . , and 68an included in the LFEs 51a1, 51a2, . . . , and 51an. As described above, the threshold generating unit 53 generates the threshold by using the temperature parameter T, the uniform random number u in the interval [0, 1], and f⁻¹(u) represented by the above-described expression (9) or the above-described expression (10). For example, the threshold generating unit 53 includes a random number generator for each LFE individually and generates the threshold by using the random number u of each LFE. However, the random number generator may be shared by several LFEs. The initial value of the temperature parameter T, the decrease cycle and decrease amount of the temperature parameter T in the simulated annealing, and so forth are controlled by the control unit 504.

The random number generating unit 54 generates random number bits used for the selection of the inversion bit in the random selector unit 52 and supplies them to the random selector unit 52.

The mode setting register 55 supplies a signal that represents the number of bits of the weight coefficient (for example, precision of the problem) to the precision switching circuits 61a1, 61a2, . . . , and 61an included in the LFEs 51a1, 51a2, . . . , and 51an. Furthermore, the mode setting register 55 supplies a signal that represents the number of spin bits (for example, scale of the problem) to the random selector unit 52. Setting of the number of spin bits and the number of bits of the weight coefficient for the mode setting register 55 is carried out by the control unit 504. The mode setting register 55 is one example of the setting change unit 5 illustrated in FIG. 2A.

The adder 56 adds the amount ΔEⱼ of energy change output by the random selector unit 52 to the energy value E stored in the E storing register 57 and outputs the resulting value to the E storing register 57.

The E storing register 57 takes in the energy value E output by the adder 56 in synchronization with a clock signal that is not illustrated. The E storing register 57 is a flip-flop, for example. The initial value of the energy value E is calculated by the control unit 504 by using the above-described expression (1) and is set in the E storing register 57.

For example, when K LFEs are used for a search for a solution, the control unit 504 obtains a spin bit string by reading out the respective spin bits of the bit storing registers 66a1, . . . , and 66aK.

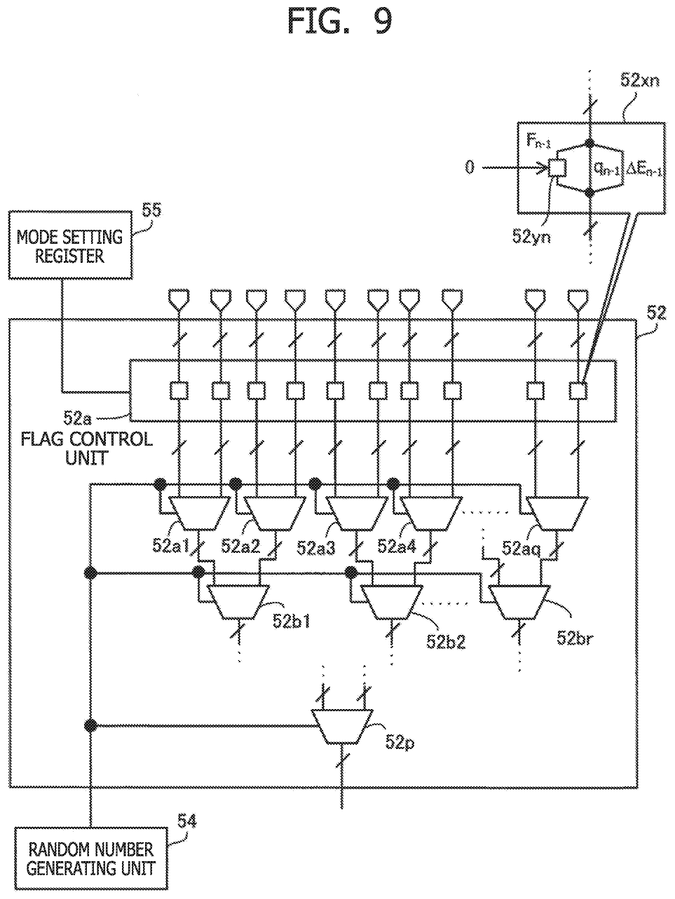

FIG. 9 is an explanatory diagram illustrating a circuit configuration example of a random selector unit. In FIG. 9, the random selector unit 52 includes a flag control unit 52a and plural selection circuits coupled in a tree manner across plural stages.

The flag control unit 52a controls the value of a flag input to each of selection circuits 52a1, 52a2, 52a3, 52a4, . . . , and 52aq at the first stage according to the setting of the number of spin bits in the mode setting register 55. In FIG. 9, a partial circuit 52xn that controls the value of the flag to one input of the selection circuit 52aq (corresponding to the output of the LFE 51an) is exemplified. A flag setting unit 52yn of the partial circuit 52xn is a switch that forcibly sets, to 0, the flag Fₙ₋₁ output from the LFE 51an that is not used.

To each of the selection circuits 52a1, 52a2, 52a3, 52a4, . . . , and 52aq at the first stage, respective two sets of variables qᵢ, Fᵢ, and ΔEᵢ output by each of the LFEs 51a1, 51a2, . . . , and 51an are input. For example, a set of variables q₀, F₀, and ΔE₀ output by the LFE 51a1 and a set of variables q₁, F₁, and ΔE₁ output by the LFE 51a2 are input to the selection circuit 52a1. Furthermore, a set of variables q₂, F₅, and ΔE₂ and a set of variables q₃, F₃, and ΔE₃ are input to the selection circuit 52a2, and a set of variables q₄, F₄, and ΔE₄ and a set of variables q₅, F₅, and ΔE₅ are input to the selection circuit 52a3. Moreover, a set of variables q₆, F₆, and ΔE₆ and a set of variables q₇, F₇, and ΔE₇ are input to the selection circuit 52a4, and a set of variables qₙ₋₂, Fₙ₋₂, and ΔEₙ₋₂ and a set of variables qₙ₋₁, Fₙ₋₁, and ΔEₙ₋₁ are input to the selection circuit 52aq.

Each of the selection circuits 52a1, . . . , and 52aq selects one set of the variables qᵢ, Fᵢ, and ΔEᵢ based on the input two sets of the variables qᵢ, Fᵢ, and ΔEᵢ and a one-bit random number output by the random number generating unit 54. At this time, each of the selection circuits 52a1, . . . , and 52aq preferentially selects the set in which Fᵢ is 1, and selects either one set based on the one-bit random number if Fᵢ is 1 in both sets (this similarly applies to the other selection circuits). Here, the random number generating unit 54 generates the one-bit random number for each selection circuit individually and supplies it to each selection circuit. Furthermore, each of the selection circuits 52a1, . . . , and 52aq generates an identification value of one bit indicating which set of the variables qᵢ, Fᵢ, and ΔE₁ has been selected and outputs a signal (referred to as state signal) including the selected variables qᵢ, Fᵢ, and ΔEᵢ and the identification value. The number of selection circuits 52a1 to 52aq at the first stage is ½ of the number of LFEs 51a1, . . . , and 51an, i.e. n/2.

To each of the selection circuits 52b1, 52b2, “.”, and 52br at the second stage, respective two signals of the state signals output by the selection circuits 52a, . . . , and 52aq are input. For example, the state signals output by the selection circuits 52a1 and 52a2 are input to the selection circuit 52b1 and the state signals output by the selection circuits 52a3 and 52a4 are input to the selection circuit 52b2.

Each of the selection circuits 52b1, . . . , and 52br selects either one of the two state signals based on the two state signals and a one-bit random number output by the random number generating unit 54. Furthermore, each of the selection circuits 52b1, . . . , and 52br updates the identification value included in the selected state signal by adding one bit in such a manner that which state signal has been selected is indicated, and outputs the selected state signal.

Similar processing is executed also in the selection circuits at the third stage and the subsequent stages. The bit width of the identification value increases by one bit in the selection circuits of each stage and the state signal that is the output of the random selector unit 52 is output from a selection circuit 52p at the last stage. The identification value included in the state signal output by the random selector unit 52 is index that is represented by a binary number and represents the inversion bit.

However, the random selector unit 52 may accept, from each LFE, index corresponding to this LFE in addition to the flag F and output index corresponding to the inversion bit by selecting index by each selection circuit similarly to the variables qᵢ, Fᵢ, and ΔEᵢ. In this case, each LFE includes a register for storing index and outputs index from this register to the random selector unit 52.

As above, the random selector unit 52 forcibly sets signals indicating whether or not inversion is possible, output by the LFEs 51a(K+1), . . . , and 51an other than the LFEs 51a1, . . . , and 51aK in the set number K of spin bits in the LFEs 51a1, . . . , and 51an, to signals indicating that inversion is not possible. The random selector unit 52 selects the inversion bit based on the signals that are output by the LFEs 51a1, . . . , and 51aK and indicate whether or not inversion is possible and the signals that are set for the LFEs 51a(K+1), . . . , and 51an and indicate that inversion is not possible. The random selector unit 52 outputs the signal that represents the inversion bit also to the LFEs 51a(K+1), . . . , and 51an in addition to the LFEs 51a1, . . . , and 51aK.

In this manner, the flags F of the LFEs that are not used are forcibly set to 0 by control by the flag control unit 52a. Therefore, the bits corresponding to the LFEs that are not used for the spin bit string may be excluded from the inversion candidates.

Next, examples of storing of the weight coefficients in the SRAMs 60a1, 60a2, . . . , and 60an of the LFEs 51a1, 51a2, . . . , and 51an will be described. First, the trade-off relation between the scale and the precision with respect to the SRAM capacity will be described.

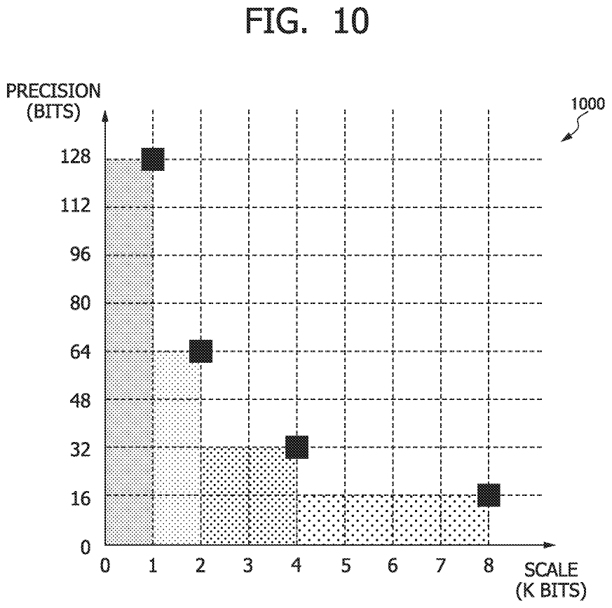

FIG. 10 is an explanatory diagram illustrating an example of the trade-off relation between the scale and the precision. In FIG. 10, a graph 1000 represents the trade-off relation between the scale and the precision when the upper limit of the capacity for storing the weight coefficients is 128K (kilo) bits in the SRAM of each LFE. Here, 1K=1024 is defined. The abscissa axis of the graph 100 indicates the scale (K bits) and the ordinate axis indicates the precision (bits). Suppose that n=8192 as one example.

In this case, for a scale of 1K bits, the precision is at most 128 bits. Furthermore, for a scale of 2K bits, the precision is at most 64 bits. For a scale of 4K bits, the precision is at most 32 bits. For a scale of 8K bits, the precision is at most 16 bits.

Therefore, suppose that the following four modes are allowed to be used in the optimization apparatus 408, for example. Each mode corresponds to the partition mode. A first mode is a mode with scale 1K bits/precision 128 bits. A second mode is a mode with scale 2K bits/precision 64 bits. A third mode is a mode with scale 4K bits/precision 32 bits. A fourth mode is a mode with scale 8K bits/precision 16 bits.

Next, examples of storing of the weight coefficients according to each of these four kinds of modes will be described. The weight coefficients are stored in each of the SRAMs 60a1, 60a2, . . . , and 60an by the control unit 504. Suppose that the unit number of bits read out from the SRAMs 60a1, 60a2, . . . , and 60an by the respective selectors of the precision switching circuits 61a1, 61a2, . . . , and 61an is 128 bits as one example.

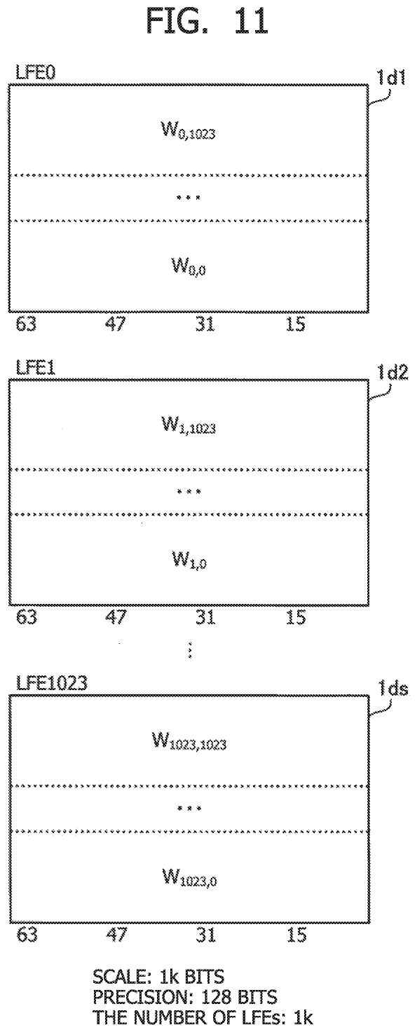

FIG. 11 is an explanatory diagram (first diagram) illustrating an example of storing of weight coefficients. In the case of using the first mode (scale 1K bits/precision 128 bits), the weight coefficients W are represented by the following expression (11).

$$W = ( \begin{matrix}{W}_{0 , 0} & … & {W}_{0 , 1023} \\ ⋮ & ⋱ & ⋮ \\ {W}_{1023 , 0} & … & {W}_{1023 , 1023}\end{matrix} ) \qquad ( 11 )$$

Pieces of data id1, 1d2, . . . , and ids represent an example of storing of the weight coefficients in the SRAMs 60a1, 60a2, . . . , and 60as when the first mode (scale 1K bits/precision 128 bits) is used. Here, s=1024 holds. The pieces of data 1d1, 1d2, . . . , and 1ds are stored in the SRAMs 60a1, 60a2, . . . , and 60as, respectively. In this mode, 1 k (=1024) LFEs are used. In FIG. 11, the LFEs 51a1, . . . , and 51as are represented by using the respective identification numbers like LFE0, . . . , and LFE1023 in some cases (this similarly applies also to the subsequent diagrams).

The data 1d1 represents W_{0,0} to W_{0,1023} stored in the SRAM 60a1 of the LFE 51a1 (LFE0). The data 1d2 represents W_{1,0} to W_{1,1023} stored in the SRAM 60a2 of the LFE 51a2 (LFE1). The data ids represents W_{1023,0} to W_{1023,1023} stored in the SRAM 60as of the LFE 51as (LFE1023). The number of bits of one weight coefficient Wᵢⱼ is 128 bits.

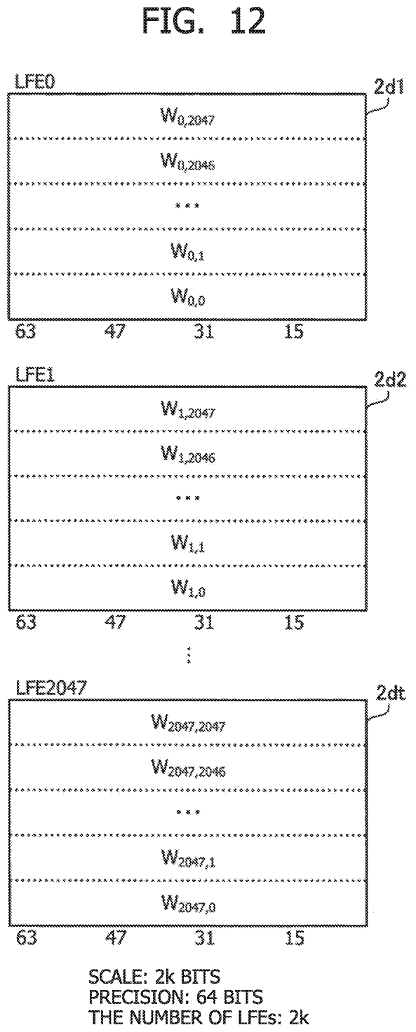

FIG. 12 is an explanatory diagram (second diagram) illustrating an example of storing of weight coefficients. In the case of using the second mode (scale 2K bits/precision 64 bits), the weight coefficients W are represented by the following expression (12).

$$W = ( \begin{matrix}{W}_{0 , 0} & … & {W}_{0 , 2047} \\ ⋮ & ⋱ & ⋮ \\ {W}_{2047 , 0} & … & {W}_{2047 , 2047}\end{matrix} ) \qquad ( 12 )$$

Pieces of data 2d1, 2d2, . . . , and 2dt represent an example of storing of the weight coefficients in the SRAMs 60a1, 60a2, . . . , and 60at when the second mode (scale 2K bits/precision 64 bits) is used. Here, t=2048 holds. The pieces of data 2d1, 2d2, . . . , and 2dt are stored in the SRAMs 60a1, 60a2, . . . , and 60at, respectively. In this mode, 2 k (=2048) LFEs are used.

The data 2d1 represents W_{0,0} to W_{0,2047} stored in the SRAM 60a1 of the LFE 51a1 (LFE0). The data 2d2 represents W_{1,0} to W_{1,2047} stored in the SRAM 60a2 of the LFE 51a2 (LFE1). The data 2dt represents W_{2047,0} to W_{2047,2047} stored in the SRAM 60at of the LFE Slat (LFE2047). The number of bits of one weight coefficient Wᵢⱼ is 64 bits.

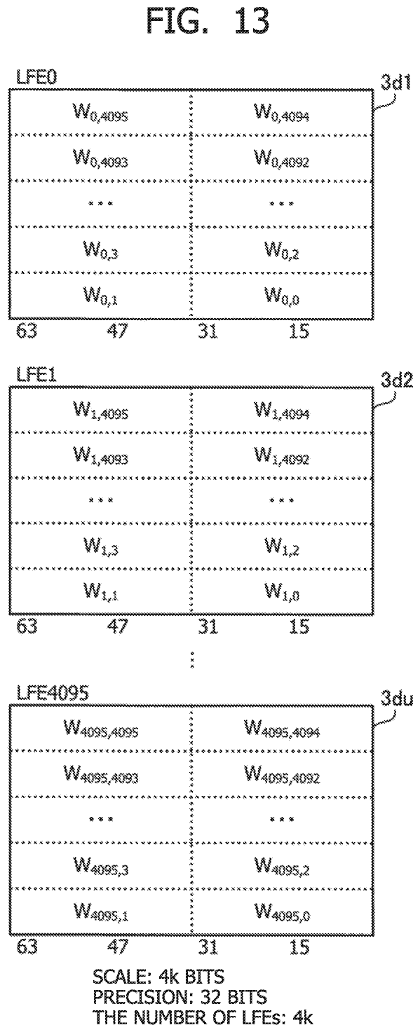

FIG. 13 is an explanatory diagram (third diagram) illustrating an example of storing of weight coefficients. In the case of using the third mode (scale 4K bits/precision 32 bits), the weight coefficients W are represented by the following expression (13).

$$W = ( \begin{matrix}{W}_{0 , 0} & … & {W}_{0 , 4095} \\ ⋮ & ⋱ & ⋮ \\ {W}_{4095 , 0} & … & {W}_{4095 , 4095}\end{matrix} ) \qquad ( 13 )$$

Pieces of data 3d1, 3d2, . . . , and 3du represent an example of storing of the weight coefficients in the SRAMs 60a1, 60a2, . . . , and 60au when the third mode (scale 4K bits/precision 32 bits) is used. Here, u=4096 holds. The pieces of data 3d1, 3d2, . . . , and 3du are stored in the SRAMs 60a1, 60a2, . . . , and 60au, respectively. In this mode, 4 k (=4096) LFEs are used.

The data 3d1 represents W_{0,0} to W_{0,4095} stored in the SRAM 60a1 of the LFE 51a1 (LFE0). The data 3d2 represents W_{1,0} to W_{4095,0} stored in the SRAM 60a2 of the LFE 51a2 (LFE1). The data 3du represents W_{4095,0} to W_{4095,4095} stored in the SRAM 60au of the LFE 51au (LFE4095). The number of bits of one weight coefficient Wᵢⱼ is 32 bits.

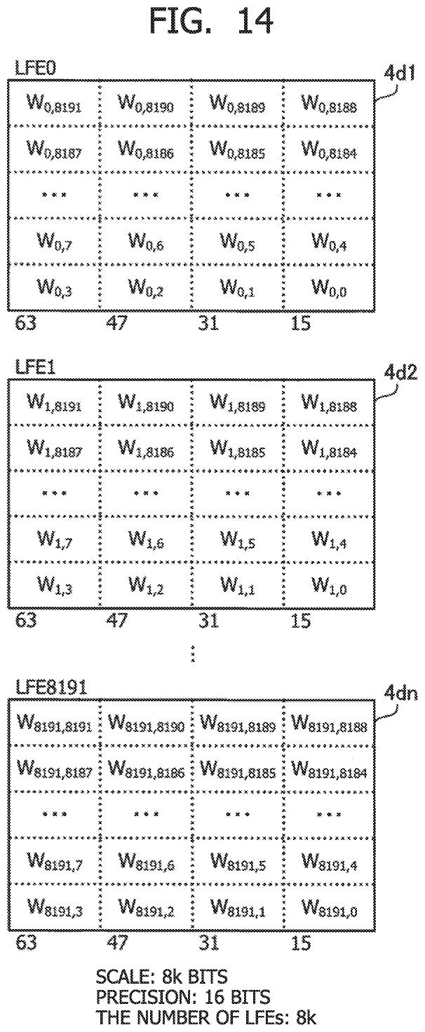

FIG. 14 is an explanatory diagram (fourth diagram) illustrating an example of storing of weight coefficients. In the case of using the fourth mode (scale 8K bits/precision 16 bits), the weight coefficients W are represented by the following expression (14).

$$W = ( \begin{matrix}{W}_{0 , 0} & … & {W}_{0 , 8191} \\ ⋮ & ⋱ & ⋮ \\ {W}_{8191 , 0} & … & {W}_{8191 , 8191}\end{matrix} ) \qquad ( 14 )$$

Pieces of data 4d1, 4d2, . . . , and 4dn represent an example of storing of the weight coefficients in the SRAMs 60a1, 60a2, . . . , and 60an when the fourth mode (scale 8K bits/precision 16 bits) is used. Here, n=8192 holds. The pieces of data 4d1, 4d2, . . . , and 4dn are stored in the SRAMs 60a1, 60a2, . . . , and 60an, respectively. In this mode, 8 k (=8192) LFEs are used.

The data 4d1 represents W_{0,0} to W_{0,8191} stored in the SRAM 60a1 of the LFE 51a1 (LFE0). The data 4d2 represents W_{1,0} to W_{1,8191} stored in the SRAM 60a2 of the LFE 51a2 (LFE1). The data 4dn represents W_{8191,0} to W_{8191,8191} stored in the SRAM 60an of the LFE 51an (LFE8191). The number of bits of one weight coefficient Wᵢⱼ is 16 bits.

Operation Processing Procedure of Optimization Apparatus 408

Next, operation processing procedure of the optimization apparatus 408 will be described. Initial values and operating conditions according to a problem are input to the optimization apparatus 408. The initial values include initial values of the energy value E, the local field hᵢ, the spin bit qᵢ, and the temperature parameter T, the weight coefficients W, and so forth, for example. Furthermore, the operating conditions include a number N1 of times of update of the state with one temperature parameter, a number N2 of times of change in the temperature parameter, the decrease width of the temperature parameter, and so forth. The control unit 504 sets the input initial values and operating conditions in the registers and the SRAMs of the above-described respective LFEs.

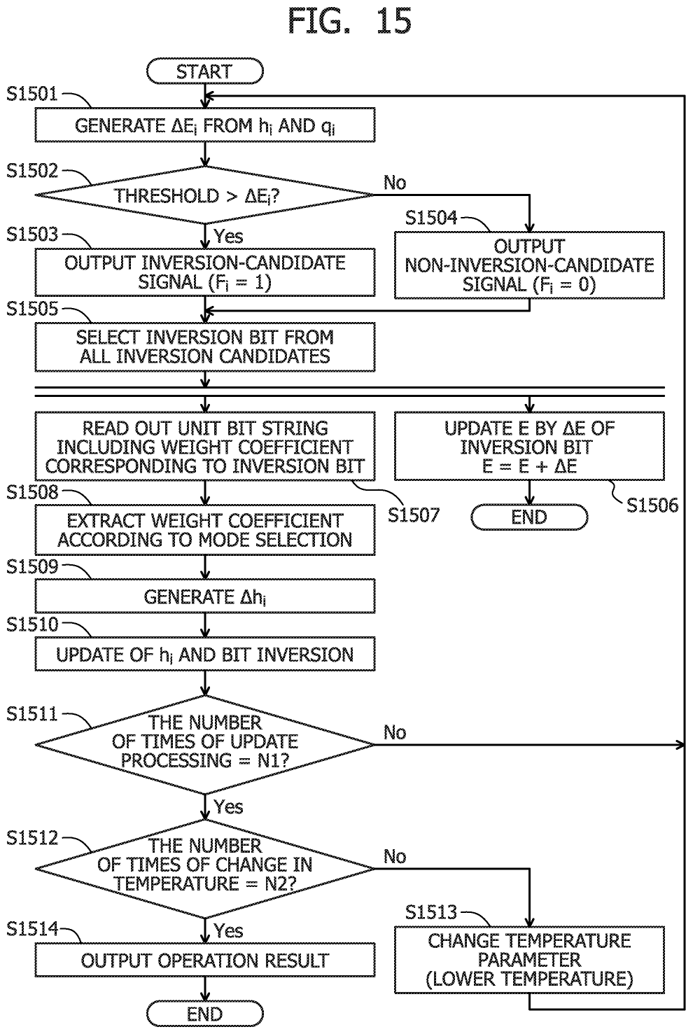

FIG. 15 is a flowchart illustrating one example of the operation processing procedure of the optimization apparatus 408. In explanation of FIG. 15 with reference to FIGS. 5 and 8A-8C, the LFE corresponding to index=i is represented as the LFE 51ax (the first LFE is the LFE 51a1 and the n-th LFE is the LFE 51an). Each unit included in the LFE 51ax is also represented with “x” given to the tail end of the numeral like the SRAM 60ax, for example. Operations by each of the LFEs 51a1, . . . , and LFE 51an are executed in parallel.

In the flowchart of FIG. 15, based on the local field hᵢ stored in the h storing register 64ax and the bit qᵢ, stored in the bit storing register 66ax, the ΔE generating unit 67ax generates the amount ΔE of energy change when this bit qᵢ is inverted (step S1501). The above-described expression (2) is used for the generation of ΔEᵢ.

The determining unit 68ax compares the amount ΔEⱼ of energy change generated by the ΔE generating unit 67ax and the threshold (=−(T·f⁻¹(u)) generated by the threshold generating unit 53 and determines whether or not threshold >ΔEᵢ is satisfied (step S1502). Here, in the case of threshold >ΔEᵢ (step S1502: Yes), the processing proceeds to the step S1503. In the case of threshold ≤ΔEi (step S1502: No), the processing proceeds to the step S1504.

The determining unit 68ax outputs an inversion-candidate signal (Fᵢ=1) to the random selector unit 52 (step S1503). The processing proceeds to the step S1505.

The determining unit 68ax outputs a non-inversion-candidate signal (Fᵢ=0) to the random selector unit 52 (step S1504). The processing proceeds to the step S1505.

In the step S1505, the random selector unit 52 selects one inversion bit from all inversion candidates (bits corresponding to LFEs regarding which Fᵢ=1) output from the LFEs 51a1, . . . , and LFE 51an. The random selector unit 52 outputs index=j, F₁, and q₁ corresponding to the selected inversion bit to the LFE 51a1, . . . , and the LFE 51an. Furthermore, the random selector unit 52 outputs ΔE₁ corresponding to the selected inversion bit to the adder 56. Thereupon, the steps S1506 (energy update processing) and S1507 (state update processing) are started in parallel.

The adder 56 updates the energy value E stored in the E storing register 57 by adding the amount ΔE of energy change corresponding to the inversion bit to the energy value E (step S1506). For example, E=E+ΔE holds. The energy update processing ends.

The precision switching circuit 61ax acquires index=j and the flag Fⱼ corresponding to the inversion bit and reads out the unit bit string including the weight coefficient corresponding to this inversion bit from the SRAM 60ax (step S1507). The unit bit string is the unit of bit string read out at one time from the SRAM 60ax by the selector of the precision switching circuit 61ax. The number of bits of the unit bit string (unit number of bits) is 128 bits in one example (it may be another value). In this case, the unit bit string of 128 bits is read out from the SRAM 60ax in the step S1507.

For example, if 128/a (a=1, 2, 4, 8) bits are selected as the precision, the precision switching circuit 61ax reads out the “Integer(j/a)”-th unit bit string from the unit bit string of the beginning (beginning is defined as 0-th unit bit string) in the SRAM 60ax. Here, Integer(j/a) is a function to extract the integral part from the value of (j/a).

The precision switching circuit 61ax extracts the weight coefficient (weight coefficient corresponding to the inversion bit qⱼ) WO with the number of bits according to mode selection set by the mode setting register 55 from the unit bit string read out in the step S1507 (step S1508). For example, in the case of extracting a bit string of z bits from the unit bit string of 128 bits, the precision switching circuit 61ax extracts the weight coefficient of z bits by shifting the bit range of z bits corresponding to the inversion bit toward the LSB side and setting 0 as the higher-order bits other than these bits as described above.

When the unit bit string read out in the step S1507 is divided into sections with a bit length according to the precision from the beginning, the precision switching circuit 61ax identifies the bit range corresponding to the inversion bit depending on what ordinal number from the beginning (0-th section) the section to which this bit range corresponds has.

According to the examples of FIG. 12 to FIG. 14, in the case of precision of 64 bits, the bit range corresponding to the inversion bit is the 0-th section when j is an even number, and is the first section when j is an odd number. Furthermore, in the case of precision of 32 bits, the bit range corresponding to the inversion bit is the 0-th section when mod(j, 4)=0, and is the first section when mod(j, 4)=1, and is the second section when mod(j, 4)=2, and is the third section when mod(j, 4)=3. Here, mod(u, v) is a function that represents the remainder when u is divided by v. Moreover, also in the case of precision of 16 bits, similarly the “mod(j, 8)”-th section from the beginning of the read-out unit bit string of 128 bits is the bit range corresponding to the inversion bit. In the case of precision of 128 bits, the precision switching circuit 61ax employs the unit bit string of 128 bits read out in the step S1507 as the weight coefficient corresponding to the inversion bit as it is.

In the above-described examples, for precision of 128/a (a=1, 2, 4, 8) bits, the “mod(j, a)”-th section (size of one section is 128/a bits) from the beginning of the unit bit string of 128 bits read out in the step S1507 is the bit range that represents the weight coefficient corresponding to the inversion bit.

The Δh generating unit 62ax generates Δhᵢ based on the inversion direction of the inversion bit and the weight coefficient Wᵢⱼ extracted by the precision switching circuit 61ax (step S1509). The above-described expression (4) is used for the generation of Δhᵢ. Furthermore, the inversion direction of the inversion bit is discriminated based on the inversion bit qᵢ output by the random selector unit 52 (bit before inversion of this time).

In the step S1510, the adder 63ax updates the local field hᵢ stored in the h storing register 64ax by adding Δhᵢ generated by the Δh generating unit 62ax to the local field hᵢ stored in the h storing register 64ax. Furthermore, the inversion determining unit 65ax determines whether or not the self-bit has been selected as the inversion bit based on index=j and the flag Fⱼ output by the random selector unit 52. The inversion determining unit 65ax inverts the spin bit stored in the bit storing register 66ax if the self-bit has been selected as the inversion bit, and keeps the spin bit of the bit storing register 66ax if the self-bit has not been selected as the inversion bit. Here, the case in which the self-bit has been selected as the inversion bit is the case in which index=j=i and Fⱼ=1 are satisfied regarding the signal output by the random selector unit 52.

The control unit 504 determines whether or not the number of times of update processing of each spin bit held in the LFE 51a1, . . . , and the LFE 51an has reached N1 (the number of times of update processing=N1 is satisfied) with the present temperature parameter T (step S1511). If the number of times of update processing has reached N1 (step S1511: Yes), the processing proceeds to the step S1512. If the number of times of update processing has not reached N1 (step S1511: No), the control unit 504 adds 1 to the number of times of update processing and causes the processing to proceed to the step S1501.

The control unit 504 determines whether or not the number of times of change in the temperature parameter T has reached N2 (the number of times of change in the temperature=N2 is satisfied) (step S1512). If the number of times of change in the temperature has reached N2 (step S1512: Yes), the processing proceeds to the step S1514. If the number of times of change in the temperature has not reached N2 (step S1512: No), the control unit 504 adds 1 to the number of times of change in the temperature and causes the processing to proceed to the step S1513.

The control unit 504 changes the temperature parameter T (step S1513). For example, the control unit 504 decreases the value of the temperature parameter T by the decrease width according to the operating condition (equivalent to lowering the temperature). The processing proceeds to the step S1501.

The control unit 504 reads out the spin bit stored in the bit storing register 66ax and outputs it as the operation result (step S1514). For example, the control unit 504 reads out the spin bit stored in each of the bit storing registers 66a1, . . . , and 66aK corresponding to the number K of spin bits set by the mode setting register 55 and outputs the spin bits to the CPU 401. For example, the control unit 504 supplies the read-out spin bit string to the CPU 401. The operation processing ends.

In the step S1505, the random selector unit 52 may exclude the LFEs that are not used from candidates for bit inversion by forcibly setting the value of F output by the LFEs that are not used to 0 according to setting of the mode setting register 55.

According to the optimization apparatus 408, setting of the number of spin bits that represent the state of an Ising model and the number of bits of the weight coefficient is enabled by the mode setting register 55 and scale and precision that match the problem may be implemented in the optimization apparatus 408 of one chip.

For example, the precision switching circuit 61ax switches the bit length of the weight coefficient read out from the SRAM 60ax according to setting of the mode setting register 55. By using the precision switching circuit 61ax, various kinds of precision may be implemented without changing the unit number of bits read out from the SRAM 60ax by the selector of the precision switching circuit 61ax as represented in the step S1508. For example, the precision may be made variable without requiring remaking of the signal line for reading for the unit number of bits from the SRAM 60ax by the selector of the precision switching circuit 61ax.

Furthermore, the random selector unit 52 inputs the signal that represents the inversion bit to the LFEs in a number (for example, K) equivalent to the number of spin bits set by the mode setting register 55 and selects the inversion bit from the bits corresponding to the LFEs in this number (K). The random selector unit 52 inputs the signal that represents the inversion bit also to the n−K LFEs that are not used. However, the random selector unit 52 excludes the LFEs that are not used from the selection candidates of the inversion bit by forcibly setting the flag F output from these n−K LFEs to 0 (inversion is not possible).

This may implement the Ising model with scale and precision according to the problem by one piece of the optimization apparatus 408 without individually manufacturing an optimization apparatus having scale and precision according to the problem.

Next, another example of the mode setting will be described. For example, it is also possible for the optimization apparatus 408 to provide a fifth mode with scale 4 k bits/precision 64 bits in addition to the above-described four kinds of modes by storing the weight coefficients in the SRAMs 60a1, . . . , and 60an in the following manner.

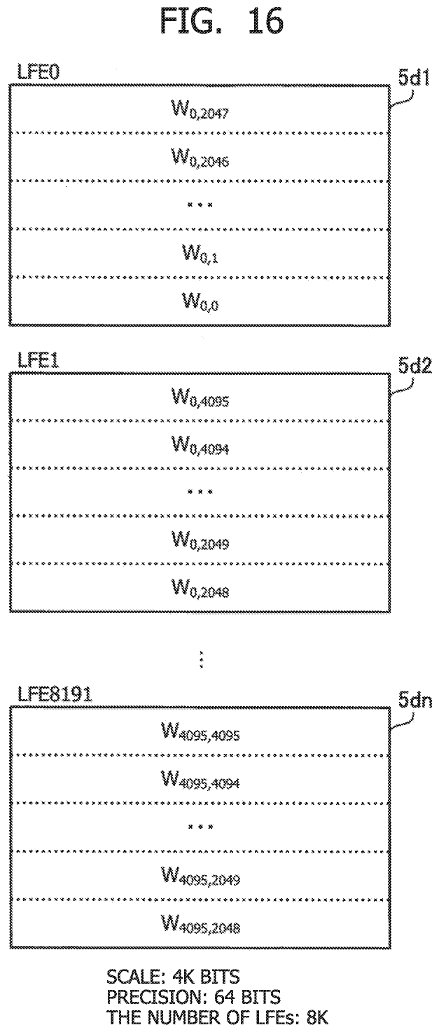

FIG. 16 is an explanatory diagram (fifth diagram) illustrating an example of storing of weight coefficients. Pieces of data 5d1, 5d2, . . . , and 5dn represent an example of storing of the weight coefficients in the SRAMs 60a1, 60a2, . . . , and 60an when the fifth mode (scale 4K bits/precision 64 bits) is used. Here, n=8192 holds. The pieces of data 5d1, 5d2, . . . , and 5dn are stored in the SRAMs 60a1, 60a2, . . . , and 60an, respectively. In this mode, 4K (=4096) LFEs are used as the spin bit string and further 4K (=4096) LFEs are used as the use purpose of only storing of the weight coefficients.

The data 5d1 represents W_{0,0} to W_{0,2047} stored in the SRAM 60a1 of the LFE 51a1 (LFE0). The data 5d2 represents W_{0,2048} to W_{0,4095} stored in the SRAM 60a2 of the LFE 51a2 (LFE1). The data 5dn represents W_{4095,2048} to W_{4095,4095} stored in the SRAM 60an of the LFE 51an (LFE8191). The number of bits of one weight coefficient Wᵢⱼ is 64 bits.

Here, as described above, the precision switching circuit 61a1 of the LFE 51a1 may acquire the weight coefficients also from the SRAM 60a2 of the LFE 51a2. For example, by using the reading path from the SRAM 60a2 of the adjacent LFE 51a2, the precision switching circuit 61a1 may employ a method in which the functions other than the SRAM 60a2 in the LFE 51a2 are stopped and the capacity of the SRAM 60a2 is lent to the LFE 51a1. For example, the odd-number-th LFE (beginning is defined as the first LFE) is allowed to use the SRAM of the even-number-th LFE (alternatively, when the beginning is defined as the 0-th LFE, it may also be said that the even-number-th LFE is allowed to use the SRAM of the odd-number-th LFE).

As above, the precision switching circuits 61a1, . . . , and 61an read out part of the weight coefficients relating to the self-bit and the other bits from the SRAM which a different LFE that is not used as the spin bit includes according to change in the number of bits of the weight coefficient. In this case, for example, by forcibly setting the flag F output from the different LFE that is not used as the spin bit to 0 (inversion is not possible), the random selector unit 52 may exclude the bit corresponding to this different LFE from the selection candidates of the inversion bit.

This may implement the fifth mode with scale 4K bits/precision 64 bits. Similarly, it is also possible to implement higher precision by reducing the scale. As above, according to the optimization apparatus 408, the scale and the precision may be changed more flexibly according to the problem.

Stored Contents of Mode Setting Table 1700

Next, stored contents of a mode setting table 1700 which the optimization problem operation apparatus 101 includes will be described. The mode setting table 1700 is stored in a storing apparatus such as the memory 402 or the disc 404 illustrated in FIG. 4.

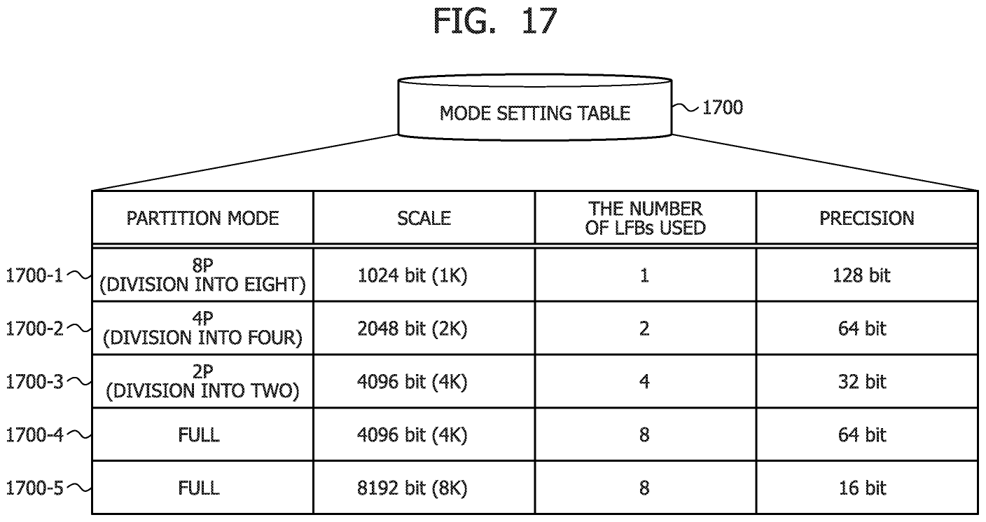

FIG. 17 is an explanatory diagram illustrating one example of the stored contents of the mode setting table 1700. In FIG. 17, the mode setting table 1700 includes fields of partition mode, scale, the number of LFBs used, and precision and stores pieces of mode setting information 1700-1 to 1700-5 as records by setting pieces of information in each field.

Here, the partition mode represents the mode name of the partition mode. A partition mode “8P (division into eight)” is a mode in which the optimization apparatus 408 is divided into eight partitions logically. The partition mode “8P (division into eight)” corresponds to the above-described first mode.

A partition mode “4P (division into four)” is a mode in which the optimization apparatus 408 is divided into four partitions logically. The partition mode “4P (division into four)” corresponds to the above-described second mode. A partition mode “2P (division into two)” is a mode in which the optimization apparatus 408 is divided into two partitions logically. The partition mode “2P (division into two)” corresponds to the above-described third mode.

Partition modes “FULL” are modes in which the optimization apparatus 408 is not divided but used as one partition. Two kinds of partition modes “FULL” are set corresponding to combinations of the scale and the precision. The partition mode “FULL (scale: 8K, precision: 16 bits)” corresponds to the above-described fourth mode. Furthermore, the partition mode “FULL (scale: 4K, precision: 64 bits)” corresponds to the above-described fifth mode.

The scale represents the maximum scale of the problem (combinatorial optimization problem) that may be solved in the partition mode. The number of LFBs used represents the number of LFBs used for each partition in the partition mode. The precision represents the maximum precision of the problem (combinatorial optimization problem) that may be solved in each partition mode.

For example, the mode setting information 1700-1 represents the scale “1024 bits (1K),” the number “1” of LFBs used, and the precision “128 bits” in the partition mode “8P (division into eight).” Although only one kind of partition mode “8P (division into eight)” is set here, the mode setting is not limited thereto. For example, as the partition mode “8P (division into eight),” plural kinds of modes in which the scale and the number of LFBs used are the same and the precision is different may be set. This similarly applies to the other partition modes.

Functional Configuration Example of Optimization Problem Operation Apparatus 101

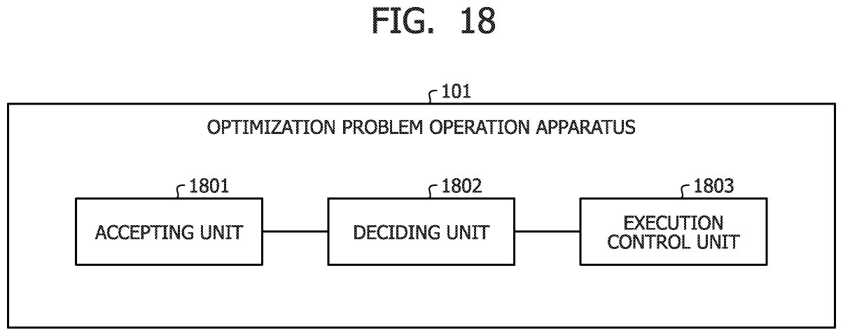

FIG. 18 is a block diagram illustrating a functional configuration example of the optimization problem operation apparatus 101. In FIG. 18, the optimization problem operation apparatus 101 includes an accepting unit 1801, a deciding unit 1802, and an execution control unit 1803. For example, the accepting unit 1801 to the execution control unit 1803 implement functions thereof by causing the CPU 401 to execute a program stored in a storing apparatus such as the memory 402, the disc 404, or the portable recording medium 407 illustrated in FIG. 4 or by the communication I/F 405. The processing result of each functional unit is stored in a storing apparatus such as the memory 402 or the disc 404.

The accepting unit 1801 accepts a combinatorial optimization problem to the optimization apparatus 408. Here, the accepted combinatorial optimization problem is a problem of the calculation target to be solved. For example, the accepting unit 1801 accepts the combinatorial optimization problem by accepting input of information on the combinatorial optimization problem from the client apparatus 301 illustrated in FIG. 3.

In the information on the combinatorial optimization problem, the number of times of repetition according to the problem, initial values, operating conditions, and so forth are included, for example. The number of times of repetition is the number of times the combinatorial optimization problem is repeatedly solved and is specified by a user, for example.

The deciding unit 1802 decides the partition mode and the execution mode of the optimization apparatus 408 according to the scale or requested precision of the combinatorial optimization problem. Here, the partition mode prescribes the logical division state of the optimization apparatus 408. Furthermore, the execution mode prescribes the range of hardware resources used in an operation in the partition mode. The execution mode may be decided in units of partition.

For example, the deciding unit 1802 acquires the scale and the requested precision of the accepted combinatorial optimization problem. Here, the scale of the combinatorial optimization problem is represented by the number of spin bits of an Ising model of the combinatorial optimization problem, for example. The requested precision of the combinatorial optimization problem is represented by the number of bits of the weight coefficient that represents the magnitude of interaction between bits, for example. For example, the deciding unit 1802 acquires, from the library 502 (see FIG. 5), the number of spin bits (scale) and the number of bits that represent the weight coefficient (requested precision) of the problem after conversion obtained by converting the accepted combinatorial optimization problem.

The deciding unit 1802 determines whether or not the scale of the combinatorial optimization problem is smaller than the maximum scale of the problem that may be solved in the first partition mode. The first partition mode is the present partition mode in plural partition modes that may be set in the optimization apparatus 408, for example.

For example, the deciding unit 1802 acquires, from the library 502, the maximum scale (the number of spin bits) and the maximum precision (the number of bits of the weight coefficient) of the problem that may be solved in the present partition mode. The deciding unit 1802 determines whether or not the scale of the combinatorial optimization problem is smaller than the acquired maximum scale.

For example, if the acquired maximum scale is “4096 bits (4K)” and the maximum precision is “32 bits,” the present partition mode is the partition mode “2P (division into two)” (see FIG. 17). In this case, the deciding unit 1802 determines whether or not the scale of the combinatorial optimization problem is smaller than the acquired maximum scale “4096 bits (4K).”

The library 502 may acquire information on the present partition mode by calling a function prepared in advance. For example, the library 502 may acquire the maximum scale of the problem that may be solved in the present partition mode by calling a getMaxNumBit( ) function. Furthermore, the library 502 may acquire the maximum precision of the problem that may be solved in the present partition mode by calling a getWeightRange( ) function.

If the scale of the combinatorial optimization problem is smaller than the maximum scale, the deciding unit 1802 decides the partition mode of the optimization apparatus 408 to be the first partition mode. Furthermore, the deciding unit 1802 decides the execution mode of the optimization apparatus 408 to be the first execution mode that prescribes the range of hardware resources corresponding to the scale of the combinatorial optimization problem.

Here, the first execution mode is an execution mode that prescribes the range of hardware resources satisfying conditions of the following (i) and (ii), for example, in the execution modes that prescribe the range of hardware resources used in an operation in the first partition mode.

(i) The maximum scale of the problem that may be solved is smaller than the maximum scale of the problem that may be solved in the first partition mode.

(ii) A problem with a scale equal to or larger than the scale of the combinatorial optimization problem may be solved.

For example, first the deciding unit 1802 refers to the mode setting table 1700 illustrated in FIG. 17 and identifies the partition mode corresponding to the combination of the acquired maximum scale and maximum precision. This may identify the first partition mode that is the present partition mode of the optimization apparatus 408.

The deciding unit 1802 refers to the mode setting table 1700 and identifies the execution mode that prescribes the range of hardware resources satisfying the conditions of the above-described (i) and (Ii) in the execution modes that prescribe the range of hardware resources used in an operation in the first partition mode.

For example, supposing that the partition mode is “FULL (scale: 8K, precision: 16 bits),” the execution modes that may be set in the optimization apparatus 408 is execution mode “FULL,” execution mode “2P,” execution mode “4P,” and execution mode “8P.”

The execution mode “FULL” is the execution mode that prescribes the range of hardware resources that may solve a problem with a scale “8192 bits (8K)” at most. The execution mode “2P” is the execution mode that prescribes the range of hardware resources that may solve a problem with a scale “4096 bits (4K)” at most. The execution mode “4P” is the execution mode that prescribes the range of hardware resources that may solve a problem with a scale “2048 bits (2K)” at most. The execution mode “8P” is the execution mode that prescribes the range of hardware resources that may solve a problem with a scale “1024 bits (1K)” at most.

In the initial setting, the execution mode in the partition mode “FULL (scale: 8K, precision: 16 bits)” is the execution mode “FULL.” In the following, the execution mode initially set in each partition mode will be represented as “initial mode” in some cases.

Furthermore, supposing that the partition mode is “FULL (scale: 4K, precision: 64 bits),” the execution modes that may be set in the optimization apparatus 408 is execution mode “2P,” execution mode “4P,” and execution mode “8P.” The initial mode of the partition mode “FULL (scale: 4K, precision: 64 bits)” is the execution mode “2P.”

Moreover, supposing that the partition mode is “2P (division into two),” the execution modes that may be set in the optimization apparatus 408 is execution mode “2P,” execution mode “4P,” and execution mode “8P.” The initial mode of the partition mode “2P (division into two)” is the execution mode “2P.”

In addition, supposing that the partition mode is “4P (division into four),” the execution modes that may be set in the optimization apparatus 408 is execution mode “4P” and execution mode “8P.” The initial mode of the partition mode “4P (division into four)” is the execution mode “4P.”

Furthermore, supposing that the partition mode is “8P (division into eight),” the execution modes that may be set in the optimization apparatus 408 is only execution mode “8P.”

As one example, supposing that the first partition mode is “FULL (scale: 8K, precision: 16 bits),” the maximum scale of the problem that may be solved is “8192 bits (8K).” Furthermore, supposing that the scale of the combinatorial optimization problem is “2048 bits (2K),” the execution modes that satisfy the above-described (ii) are the execution mode “FULL,” the execution mode “2P,” and the execution mode “4P.”

Therefore, the execution modes that prescribe the range of hardware resources satisfying the above-described (i) and (ii) are the execution mode “2P” and the execution mode “4P.” In this case, the deciding unit 1802 decides the execution mode “4P,” in which the scale of the problem that may be solved is the smallest, in the execution mode “2P” and the execution mode “4P,” as the first execution mode, for example.

Furthermore, if the scale of the combinatorial optimization problem is the same as the maximum scale of the problem that may be solved in the first partition mode, the deciding unit 1802 decides the partition mode of the optimization apparatus 408 to be the first partition mode. Furthermore, the deciding unit 1802 decides the execution mode of the optimization apparatus 408 to be the initial mode of the first partition mode. The initial mode is the execution mode that prescribes the range of hardware resources corresponding to the maximum scale of the problem that may be solved in each partition mode.

With the decided partition mode and execution mode, the execution control unit 1803 causes operations of the combinatorial optimization problem to be executed in parallel in the optimization apparatus 408 based on the number of times obtained by dividing the number of times of execution of the combinatorial optimization problem by the number of divisions corresponding to this execution mode. Here, the number of times of execution of the combinatorial optimization problem is the above-described number of times of repetition of the combinatorial optimization problem, for example.

Furthermore, the number of divisions corresponding to the execution mode is the number of operations that may be executed in parallel in the decided execution mode in each partition in the decided partition mode, for example.

For example, suppose that the partition mode is “FULL (scale: 8K, precision: 16 bits)” and the execution mode is “8P.” In this case, the number of operations that may be executed in parallel in the execution mode “8P” is “8” in the partition (one partition) in the partition mode “FULL (scale: 8K, precision: 16 bits).” For example, the number of divisions corresponding to the execution mode “8P” in the partition mode “FULL (scale: 8K, precision: 16 bits)” is “8.”

Furthermore, for example, suppose that the partition mode is “2P (division into two)” and the execution mode is “8P.” In this case, the number of operations that may be executed in parallel in the execution mode “8P” is “4” in each partition (two partitions) in the partition mode “2P (division into two).” For example, the number of divisions corresponding to the execution mode “8P” in the partition mode “2P (division into two)” is “4.”

Furthermore, the number of times obtained by dividing the number of times of execution of the combinatorial optimization problem by the number of divisions corresponding to the execution mode is each number of times of execution when operations of the combinatorial optimization problem are executed in parallel in each partition in the optimization apparatus 408. For example, suppose that the number of times of execution of the combinatorial optimization problem is “1024” and the number of divisions corresponding to the execution mode is “8.” In this case, the number of times obtained by dividing the number of times of execution of the combinatorial optimization problem by the number of divisions corresponding to the execution mode is “128.”

As one example, suppose that the decided partition mode and execution mode are the partition mode “FULL (scale: 8K, precision: 16 bits)” and the execution mode “8P.” Furthermore, suppose that the number of times obtained by dividing the number of times of execution of the combinatorial optimization problem by the number of divisions corresponding to the execution mode is “128.”

In this case, the execution control unit 1803 refers to the mode setting table 1700 and identifies the scale and precision corresponding to the execution mode “8P,” for example. The scale and precision corresponding to the execution mode “8P” are equivalent to the scale and precision corresponding to the partition mode “8P (division into eight).” Thus, the scale and precision corresponding to the execution mode “8P” are scale “1024 bits (1K)” and precision “128 bits.”

The execution control unit 1803 inputs the identified scale (the number of spin bits) and precision (the number of bits of the weight coefficient) to the optimization apparatus 408. In the optimization apparatus 408, the control unit 504 accepts the scale (the number of spin bits) and the precision (the number of bits of the weight coefficient) from the execution control unit 1803 and inputs them to the mode setting register 55 of the LFB 505.

The precision (the number of bits of the weight coefficient) input to the mode setting register 55 is input to the precision switching circuit of each LFE. For example, the precision switching circuit 61a1 accepts the input precision (the number of bits of the weight coefficient) and switches the number of bits of the weight coefficient read out from the SRAM 60a1 according to this precision (the number of bits of the weight coefficient).

Furthermore, the scale (the number of spin bits) input to the mode setting register 55 is input to the random selector unit 52. For example, the random selector unit 52 uses the LFEs in a number equivalent to the input scale (the number of spin bits) from the LFE with the smallest index sequentially to allow a search for a solution to be made.

Due to this, the partition mode “FULL (scale: 8K, precision: 16 bits)” and the execution mode “8P” are set in the optimization apparatus 408. In this case, in the optimization apparatus 408, eight partitions in the execution mode “8P” in the partition mode “FULL (scale: 8K, precision: 16 bits)” are formed.

Which hardware resource (for example, LFB) is used to implement each partition may be determined by the execution control unit 1803 or may be determined by the control unit 504 of the optimization apparatus 408.

The execution control unit 1803 causes operations of the combinatorial optimization problem of each number “128” of times to be executed in parallel in the optimization apparatus 408. For example, the execution control unit 1803 causes processing of repeating the operation of the combinatorial optimization problem 128 times to be executed in parallel in each of the eight partitions in the optimization apparatus 408.

The execution control unit 1803 may set seed values different from each other for the operations of the combinatorial optimization problem executed in parallel and start the execution. For example, the execution control unit 1803 inputs the different seed values to the respective partitions and causes the processing of repeating the operation of the combinatorial optimization problem 128 times to be executed in parallel.

Here, the seed value is a random number given first in the simulated annealing. Different solutions may be obtained by changing the seed value. The seed value is used for generation of the random number bits output by the random number generating unit 4 (or random number generating unit 54), for example.

For example, the execution control unit 1803 inputs initial values and operating conditions according to the problem to the optimization apparatus 408. In the optimization apparatus 408, the control unit 504 sets the input initial values and operating conditions in the register and the SRAM of each LFE. If the LFE that is not used exists, the control unit 504 sets, e.g., 0 as all of W in the SRAM of this LFE.

The execution control unit 1803 inputs the identified scale (the number of spin bits) and the precision (the number of bits of the weight coefficient) to the optimization apparatus 408. As a result, the scale (the number of spin bits) and the precision (the number of bits of the weight coefficient) are input from the control unit 504 to the mode setting register 55 and the partition mode and the execution mode are set in the optimization apparatus 408.

Furthermore, the execution control unit 1803 inputs, to the optimization apparatus 408, the number of times of each partition the operations of the combinatorial optimization problem are executed in parallel and the seed values. The number of times of each partition is the number of times the operation of the combinatorial optimization problem is repeatedly executed in each partition and is equivalent to the number of times the procedure from the start (START) to the end (END) in FIG. 15 is repeated, for example.

The execution control unit 1803 inputs an operation start flag (for example, operation start flag=1) to the optimization apparatus 408. When accepting the input of the operation start flag, the control unit 504 causes the operations of the combinatorial optimization problem corresponding to the input number of times to be executed in parallel by the respective partitions.

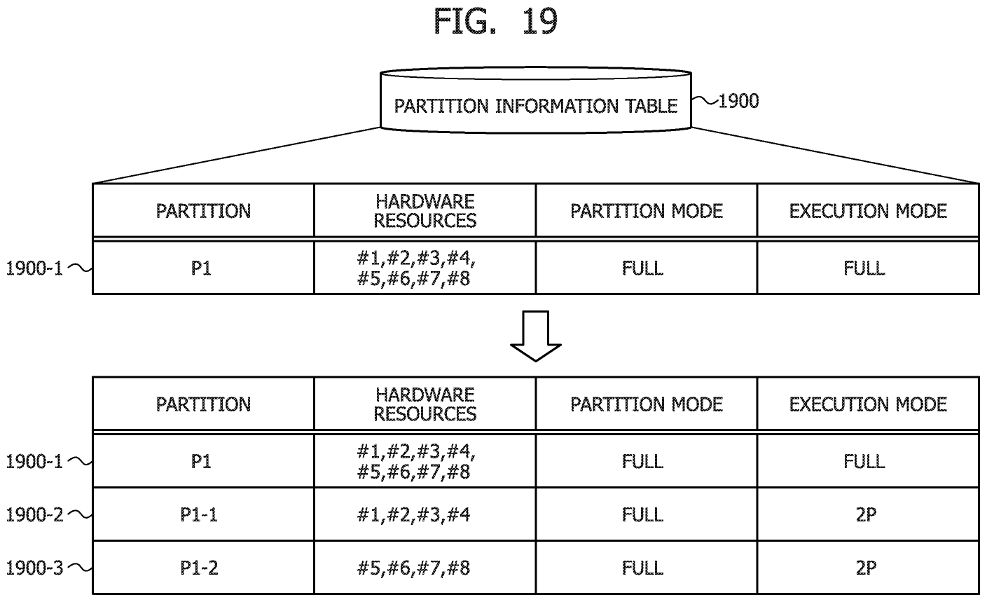

The execution control unit 1803 manages information on each partition in the optimization apparatus 408 by using a partition information table 1900 like one Illustrated in FIG. 19, for example. The partition information table 1900 is stored in a storing apparatus such as the memory 402, the disc 404, or the like illustrated in FIG. 4.

FIG. 19 is an explanatory diagram illustrating a specific example of the partition information table 1900. In FIG. 19, the partition information table 1900 includes fields of partition, hardware resources, partition mode, and execution mode and partition information (for example, partition information 1900-1) is stored as a record through setting of information in each field.

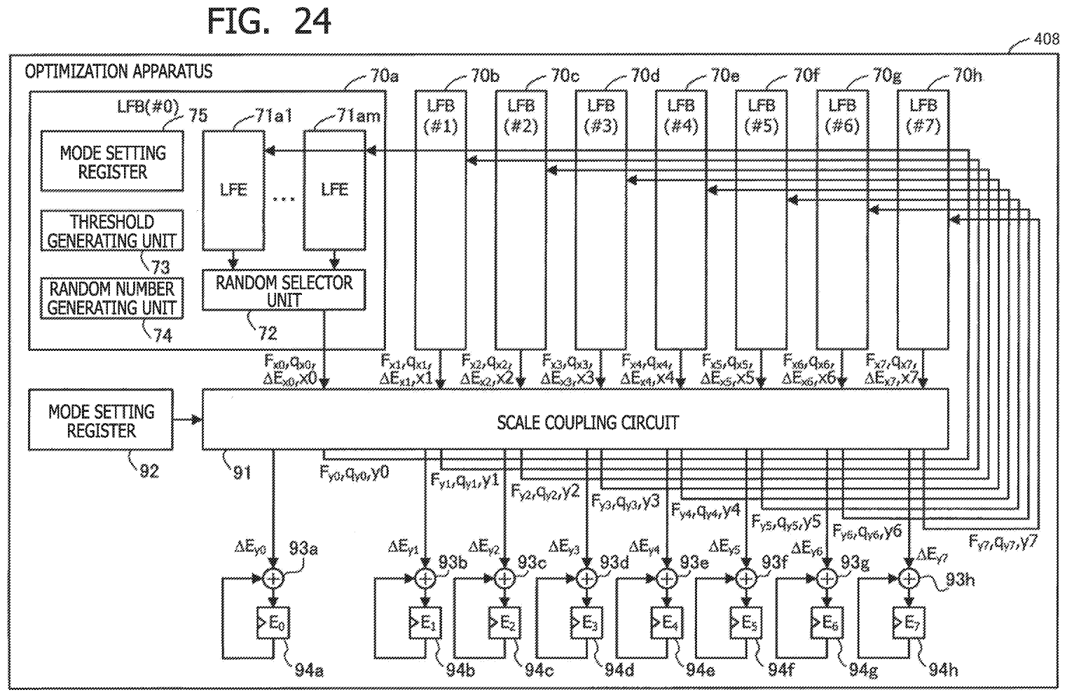

Here, the partition is an identifier to identify the partition. The hardware resources are identifiers to identify hardware resources corresponding to the partition. Here, #1 to #8 are identifiers to identify LFBs which the optimization apparatus 408 includes. The LFBs are the LFB 505 illustrated in FIGS. 8A to 8C, LFBs 70a to 70h illustrated in FIG. 24 to be described later, or the like, for example. The partition mode represents the present partition mode. The execution mode represents the execution mode in the partition mode.

For example, the partition information 1900-1 represents the hardware resources “#1 to #8” corresponding to a partition P1, the partition mode “FULL,” and the execution mode “FULL.” The partition mode “FULL” corresponds to the partition mode “FULL (scale: 8K, precision: 16 bits),” for example.

Here, suppose that the partition information 1900-1 represents the partition mode and the execution mode in the initial state of the optimization apparatus 408. Here, the case in which the execution mode is changed from the execution mode “FULL” to the execution mode “2P” in the partition mode “FULL (scale: 8K, precision: 16 bits)” is assumed.

In this case, in the partition information table 1900, pieces of partition information 1900-2 and 1900-3 are stored as new records, for example. For example, the partition information 1900-2 represents the hardware resources “#1 to #4” corresponding to a partition P1-1 obtained by dividing the partition P1, the partition mode “FULL,” and the execution mode “2P.”

When a certain partition (for example, partition P1) is divided into plural partitions through changing the execution mode, the partitions after the division are managed by branch numbers of the partition before the division (for example, P1-1 and P1-2). This makes it easier to identify the correspondence relation between the partitions before and after the division.

For example, by referring to the partition Information table 1900, the execution control unit 1803 may specify the partition (hardware resources) in the optimization apparatus 408 and input the above-described number of times of each partition and seed values to the optimization apparatus 408.

Referring back to FIG. 18, furthermore, if the number of times of execution of the combinatorial optimization problem is equal to or larger than a threshold, the execution control unit 1803 may cause operations of the combinatorial optimization problem to be executed in parallel in the optimization apparatus 408. For example, if the number of times of execution of the combinatorial optimization problem is smaller than the threshold, the execution control unit 1803 may cause an operation of the combinatorial optimization problem corresponding to the number of times of execution to be executed in any one of partitions in the decided partition mode and execution mode. The threshold may be arbitrarily set and a value such as 100 is set, for example.

Due to this, when the number of times of execution of the combinatorial optimization problem is small, an operation may be caused to be executed in a single partition without using plural partitions, and the remaining partitions may be made unused.

Furthermore, when the operation of the combinatorial optimization problem in the optimization apparatus 408 with the decided first partition mode and first execution mode has been completed, the execution control unit 1803 may change the execution mode of the optimization apparatus 408 to the initial mode in the first partition mode.

The initial mode is the execution mode that prescribes the range of hardware resources corresponding to the maximum scale of the problem that may be solved in the first partition mode. For example, after the operation in each partition in the first execution mode has been completed, the execution control unit 1803 changes the execution mode of the optimization apparatus 408 to the initial mode in the first partition mode.

For example, the execution control unit 1803 refers to the mode setting table 1700 and identifies the scale and precision corresponding to the initial mode of the first partition mode. The execution control unit 1803 inputs the identified scale (the number of spin bits) and precision (the number of bits of the weight coefficient) to the optimization apparatus 408.

Due to this, at the time when the operation of the combinatorial optimization problem has been completed, the execution mode of the optimization apparatus 408 may be returned to the initial mode in the first partition mode and the state may be returned to the original state in which a problem with a larger scale than the problem that may be solved in the first execution mode may be solved.

When the execution mode is changed to the initial mode, the partition information table 1900 illustrated in FIG. 19 is updated, for example. For example, when the execution mode is changed from the execution mode “2P” to the initial mode in the partition mode “FULL (scale: 8K, precision: 16 bits),” the pieces of partition information 1900-2 and 1900-3 are deleted.

If the scale of the combinatorial optimization problem is larger than the maximum scale of the problem that may be solved in the first partition mode, it is difficult to solve the combinatorial optimization problem in this state. In this case, the deciding unit 1802 decides the partition mode of the optimization apparatus 408 as the second partition mode that may solve a problem with a scale equal to or larger than the scale of the combinatorial optimization problem. The deciding unit 1802 may decide the execution mode of the optimization apparatus 408 to be the initial mode of the second partition mode.

However, when the partition mode is dynamically changed, possibly a result in an operation in each partition becomes abnormal. Therefore, in the case of changing the partition mode, the optimization problem operation apparatus 101 changes the partition mode after making the state in which an operation is not being executed in the respective partitions, for example.

For example, in the case of changing the partition mode, the execution control unit 1803 stops a calculation node (so-called container) in charge of each partition. The execution control unit 1803 temporarily unloads the driver 503 and reloads the driver 503. At this time, the execution control unit 1803 inputs the scale and precision corresponding to the second partition mode to the optimization apparatus 408. As a result, the second partition mode is set in the optimization apparatus 408. The execution control unit 1803 reactivates the calculation nodes (containers). This may change the partition mode.

When the partition mode is changed, the partition information table 1900 illustrated in FIG. 19 is updated, for example. For example, when the partition mode is changed, the partition Information table 1900 is initialized and partition information corresponding to the partition mode after the change is stored as a new record.

Furthermore, if the scale of the combinatorial optimization problem is larger than the maximum scale of the problem that may be solved in the first partition mode, the optimization problem operation apparatus 101 may divide the combinatorial optimization problem and solve the divided problems by an existing decomposition solution method. For example, the deciding unit 1802 may divide the combinatorial optimization problem and treat the problems after the division as problems of calculation targets.

Due to this, in the case in which the scale of the combinatorial optimization problem is larger than the maximum scale of the problem that may be solved in the first partition mode, the combinatorial optimization problem may be solved without changing the partition mode. The solution of the combinatorial optimization problem is what is obtained by integrating the solutions of the problems after the division.

Furthermore, if the requested precision of the combinatorial optimization problem is outside the range of the maximum precision of the problem that may be solved in the first partition mode (present partition mode), it is difficult to solve the combinatorial optimization problem in this state. In this case, for example, the execution control unit 1803 may solve a problem resulting from scaling (N times) into the range of the maximum precision of the problem that may be solved in the present partition mode and thereafter return what is obtained by recalculation (1/N times) to establish congruence with the original problem as the energy.

For example, in the case of the partition mode “FULL (scale: 8K, precision: 16 bits),” the maximum precision is “16 bits.” Therefore, when “3276700” is specified as the coefficient of the quadratic term of the problem, it is difficult to solve the problem in this state. In this case, for example, the execution control unit 1803 carries out scaling-down to 1/100 and solves the problem as the problem in which the coefficient of the quadratic term is 32767. Thereafter, the execution control unit 1803 returns what is obtained by recalculation (100 times) to establish congruence with the original problem as the energy.

Due to this, the combinatorial optimization problem may be solved even when the requested precision of the combinatorial optimization problem is outside the range of the maximum precision of the problem that may be solved in the first partition mode.

In the above-described explanation, description is made by taking as an example the case in which the partition mode and the execution mode are decided according to the scale of the combinatorial optimization problem. However, the configuration is not limited thereto.

The deciding unit 1802 may decide the partition mode and the execution mode of the optimization apparatus 408 according to the requested precision of the accepted combinatorial optimization problem. For example, the deciding unit 1802 determines whether or not the requested precision of the combinatorial optimization problem is in the range of the maximum precision of the problem that may be solved in the first partition mode.

Here, if the requested precision of the combinatorial optimization problem is in the range of the maximum precision of the problem that may be solved in the first partition mode, the deciding unit 1802 decides the partition mode of the optimization apparatus 408 to be the first partition mode. Furthermore, the deciding unit 1802 decides the execution mode of the optimization apparatus 408 to be a second execution mode that prescribes the range of hardware resources corresponding to the requested precision of the combinatorial optimization problem.

Here, the second execution mode is an execution mode that prescribes the range of hardware resources satisfying a condition of the following (iii) in the execution modes that prescribe the range of hardware resources used in an operation in the first partition mode.

(iii) The requested precision of the combinatorial optimization problem is in the range of the maximum precision.

Due to this, in the case in which plural execution modes in which the scale is the same and the precision is different exist (for example, scale is “1K” and precision is “64 bits, 32 bits, 16 bits”) in the first partition mode, or the like, calculation may be carried out with setting according to the requested precision of the combinatorial optimization problem.

Furthermore, the deciding unit 1802 may decide the partition mode and the execution mode of the optimization apparatus 408 according to the scale and requested precision of the accepted combinatorial optimization problem. For example, the deciding unit 1802 may decide the partition mode of the optimization apparatus 408 to be the partition mode that satisfies the conditions of the above-described (ii) and (iii). In this case, the deciding unit 1802 decides the execution mode of the optimization apparatus 408 to be the initial mode in the decided partition mode.

For example, suppose that the scale of the combinatorial optimization problem is “4096 bits (4K)” and the requested precision of the combinatorial optimization problem is “64 bits.” In this case, in the example of the partition mode represented in FIG. 17, the partition mode “2P (scale: 4K, precision: 32 bits)” and the partition mode “FULL (scale: 4K, precision: 64 bits)” are conceivable when only the scale of the combinatorial optimization problem is considered.

However, the partition mode “2P (scale: 4K, precision: 32 bits)” does not satisfy the requested precision of the combinatorial optimization problem. Thus, the deciding unit 1802 decides the partition mode of the optimization apparatus 408 to be the partition mode “FULL (scale: 4K, precision: 64 bits).” The deciding unit 1802 decides the execution mode of the optimization apparatus 408 to be the initial mode “FULL” in the partition mode “FULL (scale: 4K, precision: 64 bits).” This may carry out calculation with setting according to the scale and requested precision of the combinatorial optimization problem.

Parallel Execution Example of Combinatorial Optimization Problem

Next, parallel execution examples of a combinatorial optimization problem according to the number of times of repetition will be described. The number of times of repetition is equivalent to the number of times of execution of the combinatorial optimization problem.

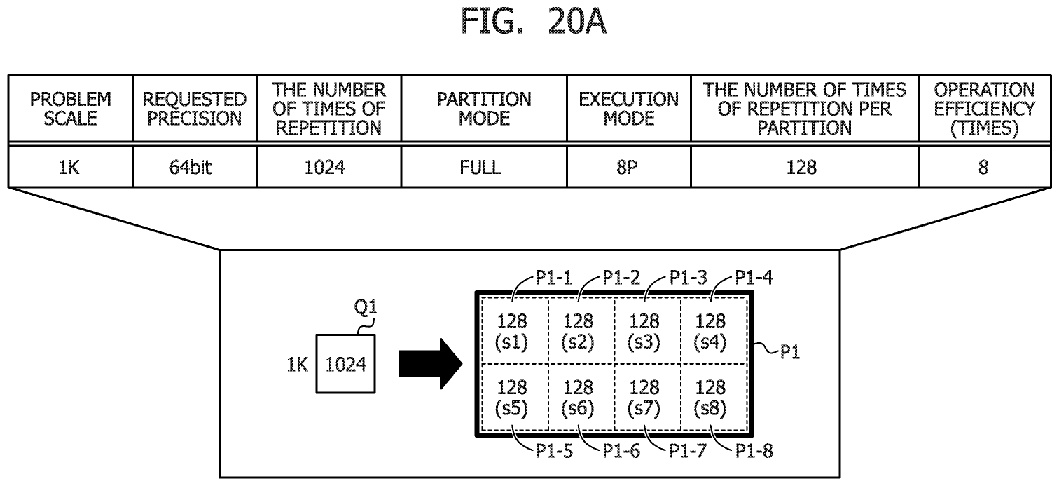

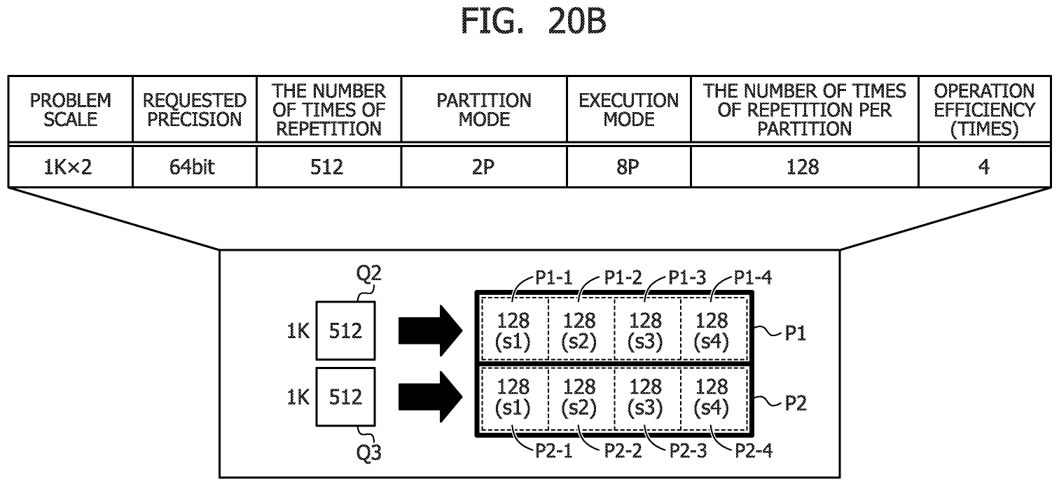

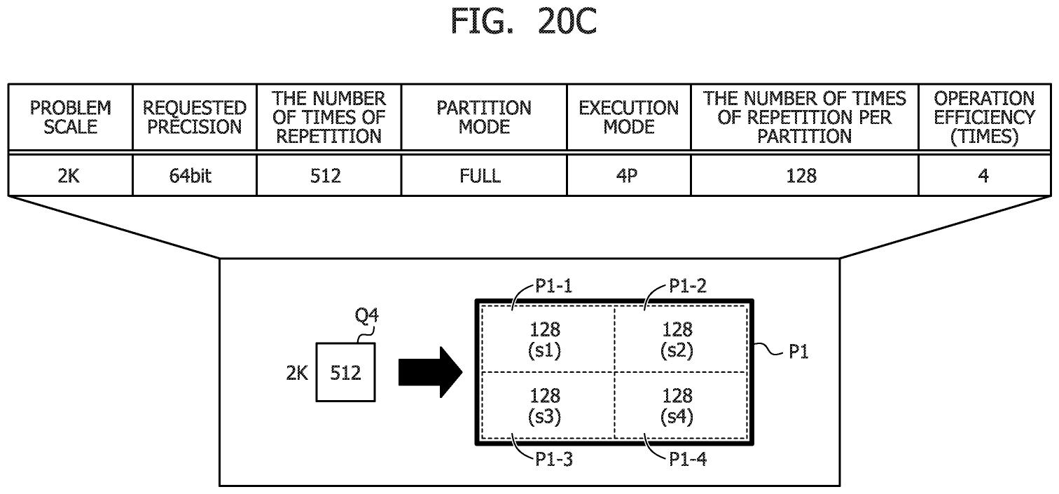

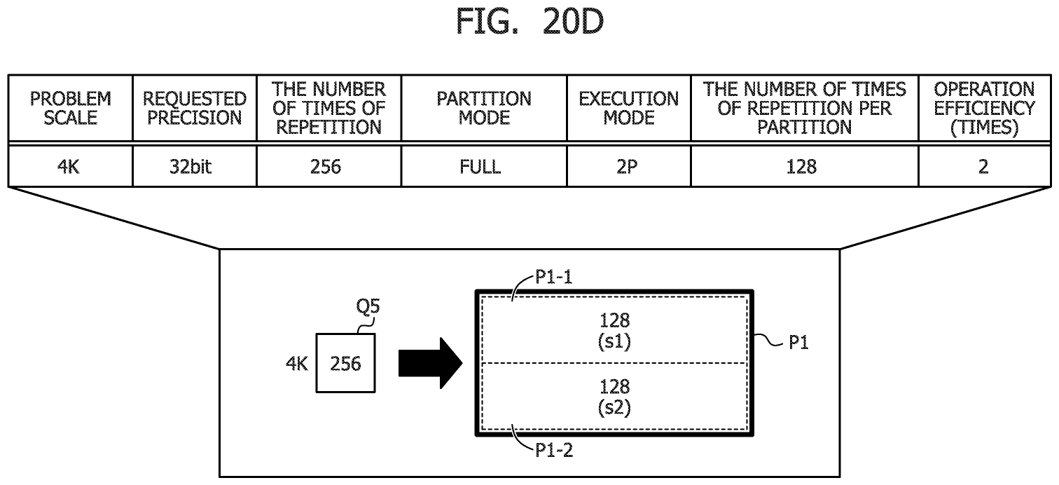

FIG. 20A is an explanatory diagram (first diagram) illustrating a parallel execution example of a combinatorial optimization problem according to the number of times of repetition. Suppose that, in the example of FIG. 20A, a problem (combinatorial optimization problem) of a calculation target is “problem Q1” and the scale of the problem Q1 is “1024 bits (1K)” and the requested precision is “64 bits” and the number of times of repetition is “1024.”

Furthermore, suppose that, in the partition mode “FULL (scale: 8K, precision: 16 bits),” the execution mode of the partition P1 is changed from the execution mode “FULL” to the execution mode “8P” according to the scale of the problem Q1. In this case, the partition P1 in the partition mode “FULL (scale: 8K, precision: 16 bits)” is divided and partitions P1-1 to P1-8 in the execution mode “8P” are formed.

Here, the number of divisions corresponding to the execution mode “8P” in the partition P1 is “8.” In this case, the execution control unit 1803 calculates the number “128” of times obtained by dividing the number “1024” of times of execution of the problem Q1 by the number “8” of divisions. The execution control unit 1803 assigns the calculated number “128” of times to the respective partitions P1-1 to P1-8 by the control unit 504 of the optimization apparatus 408.

Furthermore, the execution control unit 1803 gives different seed values s1 to s8 to the respective partitions P1-1 to P1-8 by the control unit 504 of the optimization apparatus 408. The execution control unit 1803 causes operations of the problem Q1 corresponding to 128 times to be executed in parallel in the respective partitions P1-1 to P1-8 by the control unit 504 of the optimization apparatus 408.

This may enhance the operation efficiency by a factor of eight times compared with the case in which an operation of the problem Q1 corresponding to 1024 times is caused to be executed in one partition.

Although description is made by taking as an example the case in which the number of times of execution of the combinatorial optimization problem is divisible by the number of divisions corresponding to the execution mode, the number of times of execution is not divisible in some cases. For example, when the number of times of execution of the problem Q1 is “1020” and the number of divisions corresponding to the execution mode is “8,” the number of times of execution is not divisible. In this case, for example, the execution control unit 1803 assigns a quotient “127” obtained by dividing the number “1020” of times of execution of the problem Q1 by the number “8” of divisions to the respective partitions P1-1 to P1-8. Moreover, the execution control unit 1803 may additionally assign a remainder “4” obtained by dividing the number “1020” of times of execution of the problem Q1 by the number “8” of divisions to any partition (for example, partition P1-1).

FIG. 20B is an explanatory diagram (second diagram) illustrating a parallel execution example of a combinatorial optimization problem according to the number of times of repetition. Suppose that, in the example of FIG. 20B, problems of calculation targets are “problems Q2 and Q3” and the scale of the respective problems Q2 and Q3 is “1024 bits (1K)” and the requested precision is “64 bits” and the number of times of repetition is “512.”

Furthermore, suppose that, in the partition mode “2P (division into two),” the execution mode of the respective partitions P1 and P2 is changed from the execution mode “2P” to the execution mode “8P” according to the scale of the respective problems Q2 and Q3. In this case, each of the partitions P1 and P2 in the partition mode “2P (division into two)” is divided and partitions P1-1 to P1-4 and partitions P2-1 to P2-4 in the execution mode “8P” are formed.

Here, the number of divisions corresponding to the execution mode “8P” in the respective partitions P1 and P2 is “4.” In this case, regarding the respective problems Q2 and Q3, the execution control unit 1803 calculates the number “128” of times obtained by dividing the number “512” of times of execution of the respective problems Q2 and Q3 by the number “4” of divisions. Regarding the problem Q2, the execution control unit 1803 assigns the calculated number “128” of times to the respective partitions P1-1 to P1-4 by the control unit 504 of the optimization apparatus 408. Furthermore, regarding the problem Q3, the execution control unit 1803 assigns the calculated number “128” of times to the respective partitions P2-1 to P2-4 by the control unit 504 of the optimization apparatus 408.

Moreover, regarding the problem Q2, the execution control unit 1803 gives different seed values s1 to s4 to the respective partitions P1-1 to P1-4 by the control unit 504 of the optimization apparatus 408. In addition, regarding the problem Q3, the execution control unit 1803 gives different seed values s1 to s4 to the respective partitions P2-1 to P2-4 by the control unit 504 of the optimization apparatus 408.

Regarding the problem Q2, the execution control unit 1803 causes operations of the combinatorial optimization problem corresponding to 128 times to be executed in parallel in the respective partitions P1-1 to P1-4 by the control unit 504 of the optimization apparatus 408. Furthermore, regarding the problem Q3, the execution control unit 1803 causes operations of the combinatorial optimization problem corresponding to 128 times to be executed in parallel in the respective partitions P2-1 to P2-4 by the control unit 504 of the optimization apparatus 408.

This may enhance the operation efficiency by a factor of four times compared with the case in which an operation of each of the respective problems Q2 and Q3 corresponding to 512 times is caused to be executed in one partition.

FIG. 20C is an explanatory diagram (third diagram) illustrating a parallel execution example of a combinatorial optimization problem according to the number of times of repetition. Suppose that, in the example of FIG. 20C, a problem of a calculation target is “problem Q4” and the scale of the problem Q4 is “2048 bits (2K)” and the requested precision is “64 bits” and the number of times of repetition is “512.”

Furthermore, suppose that, in the partition mode “FULL (scale: 8K, precision: 16 bits),” the execution mode of the partition P1 is changed from the execution mode “FULL” to the execution mode “4P” according to the scale of the problem Q4. In this case, the partition P1 in the partition mode “FULL (scale: 8K, precision: 16 bits)” is divided and partitions P1-1 to P1-4 in the execution mode “4P” are formed.

Here, the number of divisions corresponding to the execution mode “4P” in the partition P1 is “4.” In this case, the execution control unit 1803 calculates the number “128” of times obtained by dividing the number “512” of times of execution of the problem Q4 by the number “4” of divisions. The execution control unit 1803 assigns the calculated number “128” of times to the respective partitions P1-1 to P1-4 by the control unit 504 of the optimization apparatus 408.

Furthermore, the execution control unit 1803 gives different seed values s1 to s4 to the respective partitions P1-1 to P1-4 by the control unit 504 of the optimization apparatus 408. The execution control unit 1803 causes operations of the problem Q4 corresponding to 128 times to be executed in parallel in the respective partitions P1-1 to P1-4 by the control unit 504 of the optimization apparatus 408.

This may enhance the operation efficiency by a factor of four times compared with the case in which an operation of the problem Q4 corresponding to 512 times is caused to be executed in one partition.

FIG. 20D is an explanatory diagram (fourth diagram) illustrating a parallel execution example of a combinatorial optimization problem according to the number of times of repetition. Suppose that, in the example of FIG. 20D, a problem of a calculation target is “problem Q5” and the scale of the problem Q5 is “4096 bits (4K)” and the requested precision is “32 bits” and the number of times of repetition is “256.”

Furthermore, suppose that, in the partition mode “FULL (scale: 8K, precision: 16 bits),” the execution mode of the partition P1 is changed from the execution mode “FULL” to the execution mode “2P” according to the scale of the problem Q5. In this case, the partition P1 in the partition mode “FULL (scale: 8K, precision: 16 bits)” is divided and partitions P1-1 to P1-2 in the execution mode “2P” are formed.

Here, the number of divisions corresponding to the execution mode “2P” in the partition P1 is “2.” In this case, the execution control unit 1803 calculates the number “128” of times obtained by dividing the number “256” of times of execution of the problem Q5 by the number “2” of divisions. The execution control unit 1803 assigns the calculated number “128” of times to the respective partitions P1-1 and P1-2 by the control unit 504 of the optimization apparatus 408.

Furthermore, the execution control unit 1803 gives different seed values s1 and s2 to the respective partitions P1-1 and P1-2 by the control unit 504 of the optimization apparatus 408. The execution control unit 1803 causes operations of the problem Q5 corresponding to 128 times to be executed in parallel in the respective partitions P1-1 and P1-2 by the control unit 504 of the optimization apparatus 408.

This may enhance the operation efficiency by a factor of two times compared with the case in which an operation of the problem Q5 corresponding to 256 times is caused to be executed in one partition.

Optimization Problem Operation Processing Procedure of Optimization Problem Operation Apparatus 101

Next, the optimization problem operation processing procedure of the optimization problem operation apparatus 101 will be described with reference to FIGS. 4 and 17.

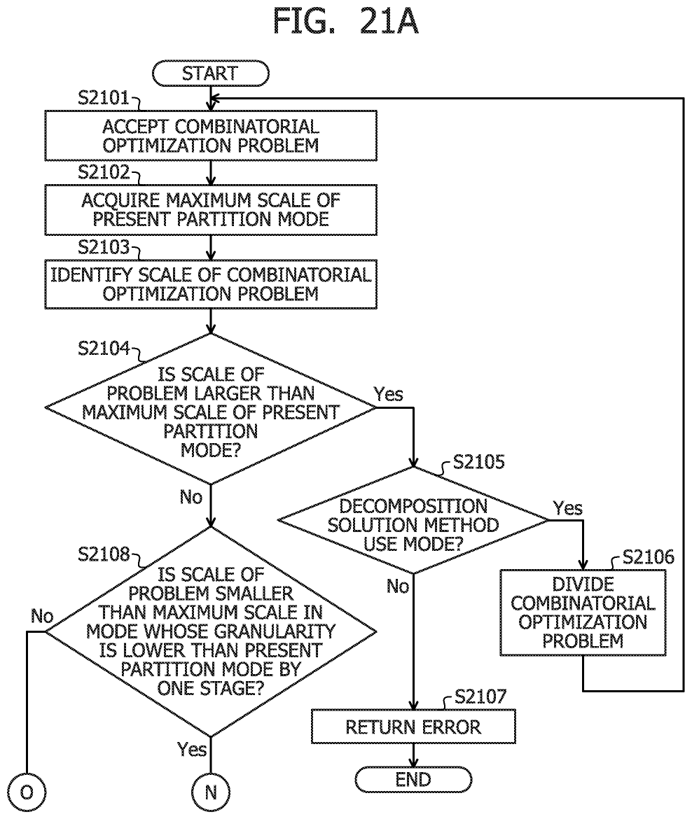

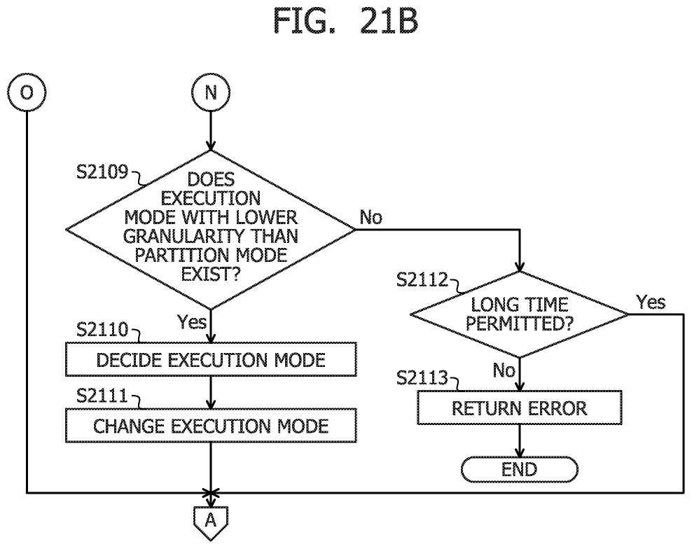

FIGS. 21A and 218 and FIG. 22 are flowcharts illustrating one example of the optimization problem operation processing procedure of the optimization problem operation apparatus 101. In the flowchart of FIGS. 21A and 218, first the optimization problem operation apparatus 101 accepts information on a combinatorial optimization problem of a calculation target (step S2101). The number of times of repetition of the combinatorial optimization problem is included in the information on the combinatorial optimization problem.

The optimization problem operation apparatus 101 acquires the maximum scale (the number of spin bits) of the problem that may be solved in the present partition mode of the optimization apparatus 408 (step S2102). The optimization problem operation apparatus 101 identifies the scale of the accepted combinatorial optimization problem (step S2103).

The optimization problem operation apparatus 101 determines whether or not the identified scale of the combinatorial optimization problem is larger than the acquired maximum scale (step S2104). Here, if the scale of the combinatorial optimization problem is larger than the maximum scale (step S2104: Yes), the optimization problem operation apparatus 101 determines whether or not a decomposition solution method use mode has been set (step S2105).

The decomposition solution method use mode is a mode in which a problem is divided to be solved by a decomposition solution method. The decomposition solution method use mode may be arbitrarily set in advance. For example, when the present partition mode is “FULL,” the decomposition solution method is used if the scale of the problem is larger than “8192 bits (8K).”

Here, if the decomposition solution method use mode has been set (step S2105: Yes), the optimization problem operation apparatus 101 divides the accepted combinatorial optimization problem by a decomposition solver or the like (step S2106) and returns to the step S2101. As a result, in the step S2101, the problem after the division is accepted as the combinatorial optimization problem of the calculation target.

On the other hand, if the decomposition solution method use mode has not been set (step S2105: No), the optimization problem operation apparatus 101 returns an error to the user (step S2107) and ends the series of processing based on the present flowchart.

Furthermore, if the scale of the combinatorial optimization problem is not larger than the maximum scale in the step S2104 (step S2104: No), the optimization problem operation apparatus 101 determines whether or not the identified scale of the combinatorial optimization problem is smaller than the maximum scale in the mode whose granularity is lower than the present partition mode by one stage (step S2108).

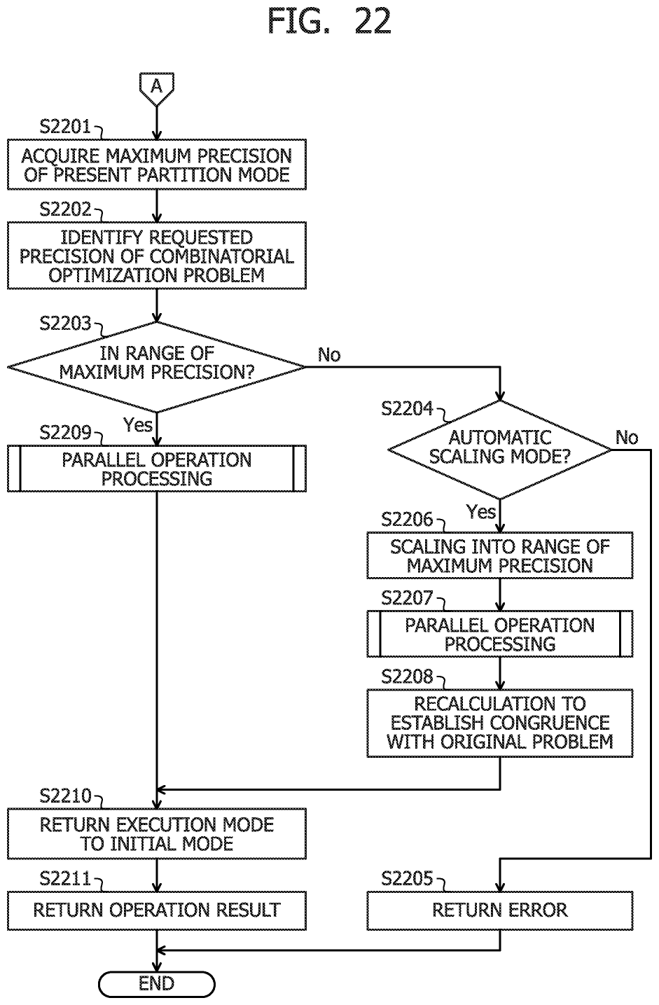

Here, if the scale of the combinatorial optimization problem is the same as the maximum scale in the present partition mode or is larger than the maximum scale in the mode whose granularity is lower than the present partition mode by one stage (step S2108: No), the optimization problem operation apparatus 101 makes a transition to a step S2201 represented in FIG. 22. On the other hand, if the scale of the combinatorial optimization problem is smaller than the maximum scale in the mode whose granularity is lower than the present partition mode by one stage (step S2108: Yes), the optimization problem operation apparatus 101 determines whether or not an execution mode with lower granularity than the present partition mode exists (step S2109).

For example, if the present partition mode is “FULL,” in the step S2108, the optimization problem operation apparatus 101 determines whether the scale of the combinatorial optimization problem is smaller than “4K,” which is the maximum scale of the 2P mode whose granularity is lower than the FULL mode by one stage. For example, if the scale of the problem is “5K,” “6K,” or “7K,” the optimization problem operation apparatus 101 does not change the execution mode, with the FULL mode kept. On the other hand, if the scale of the problem is equal to or smaller than “4K,” the optimization problem operation apparatus 101 changes the execution mode.

Here, if the execution mode with lower granularity exists (step S2109: Yes), the optimization problem operation apparatus 101 decides the execution mode of the optimization apparatus 408 according to the scale of the combinatorial optimization problem (step S2110). However, the partition mode of the optimization apparatus 408 is kept at the present partition mode. For example, the optimization problem operation apparatus 101 decides the partition mode of the optimization apparatus 408 as the present partition mode.

The optimization problem operation apparatus 101 changes the execution mode in the present partition mode to the decided execution mode (step S2111) and makes a transition to the step S2201 represented in FIG. 22. For example, the optimization problem operation apparatus 101 refers to the mode setting table 1700 and identifies the scale and precision corresponding to the decided execution mode in the present partition mode. The optimization problem operation apparatus 101 inputs the identified scale and precision to the optimization apparatus 408 to thereby change the execution mode of the present partition mode.

Furthermore, if the execution mode with lower granularity does not exist in the step S2109 (step S2109: No), the optimization problem operation apparatus 101 determines whether or not to permit taking a long time for the operation (step S2112). Whether or not to permit taking a long time for the operation may be arbitrarily set in advance.

Here, if taking a long time for the operation is not permitted (step S2112: No), the optimization problem operation apparatus 101 returns an error to the user (step S2113) and ends the series of processing based on the present flowchart. On the other hand, if taking a long time for the operation is permitted (step S2112: Yes), the optimization problem operation apparatus 101 makes a transition to the step S2201 represented in FIG. 22.

In the flowchart of FIG. 22, first the optimization problem operation apparatus 101 acquires the maximum precision (the number of bits of the weight coefficient) of the problem that may be solved in the present partition mode (step S2201). The optimization problem operation apparatus 101 identifies the requested precision of the accepted combinatorial optimization problem (step S2202).

The optimization problem operation apparatus 101 determines whether or not the identified requested precision of the combinatorial optimization problem is in the range of the acquired maximum precision (step S2203). Here, if the requested precision of the combinatorial optimization problem is outside the range of the maximum precision (step S2203: No), the optimization problem operation apparatus 101 determines whether or not an automatic scaling mode has been set (step S2204).

The automatic scaling mode is a mode in which a problem is solved with scaling into the range of the maximum precision. The automatic scaling mode may be arbitrarily set in advance.

Here, if the automatic scaling mode has not been set (step S2204: No), the optimization problem operation apparatus 101 returns an error to the user (step S2205) and ends the series of processing based on the present flowchart.

On the other hand, if the automatic scaling mode has been set (step S2204: Yes), the optimization problem operation apparatus 101 carries out scaling (N times) of the combinatorial optimization problem into the range of the maximum precision of the problem that may be solved in the present partition mode (step S2206).

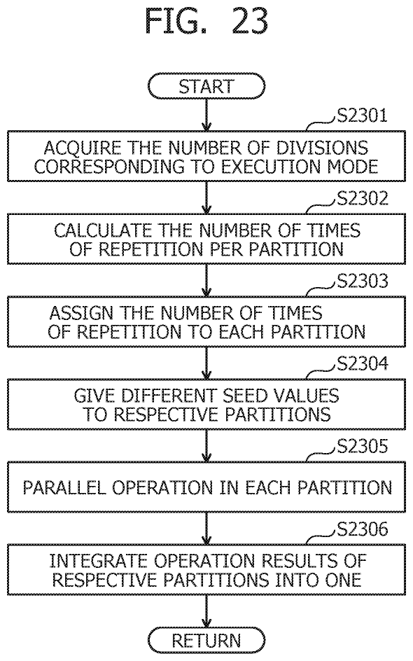

The optimization problem operation apparatus 101 executes parallel operation processing of causing operations of the problem subjected to the scaling by the optimization apparatus 408 to be executed in parallel in the present partition mode and execution mode (step S2207). Specific processing procedure of the parallel operation processing will be described later by using FIG. 23. The optimization problem operation apparatus 101 carries out recalculation (1/N times) of the energy to establish congruence with the original problem (step S2208) and makes a transition to a step S2210.

Furthermore, if the requested precision of the combinatorial optimization problem is in the range of the maximum precision in the step S2203 (step S2203: Yes), the optimization problem operation apparatus 101 executes parallel operation processing of causing operations of the combinatorial optimization problem to be executed in parallel in the optimization apparatus 408 in the present partition mode and execution mode (step S2209). Specific processing procedure of the parallel operation processing will be described later by using FIG. 23.

The optimization problem operation apparatus 101 returns the execution mode changed in the step S2111 to the initial mode (step S2210). However, if the execution mode has not been changed in the step S2111, the optimization problem operation apparatus 101 skips the step S2210.

The optimization problem operation apparatus 101 returns the operation result of the combinatorial optimization problem to the user (step S2211) and ends the series of processing based on the present flowchart. Due to this, the operations may be executed by using proper hardware resources according to the scale of the combinatorial optimization problem and the combinatorial optimization problem may be efficiently solved.

If the precision of the combinatorial optimization problem is outside the range of the maximum precision in the step S2203 (step S2203: No), the optimization problem operation apparatus 101 may change the partition mode of the optimization apparatus 408. For example, the optimization problem operation apparatus 101 changes the partition mode of the optimization apparatus 408 to a partition mode that may solve a problem with precision equal to or higher than the precision of the combinatorial optimization problem.

The specific processing procedure of the parallel operation processing of the steps S2207 and S2209 represented in FIG. 22 will be described with reference to FIGS. 4, 5, and 23.

FIG. 23 is a flowchart illustrating one example of the specific processing procedure of the parallel operation processing. In the flowchart of FIG. 23, first the optimization problem operation apparatus 101 acquires the number of divisions corresponding to the execution mode of the partition in the partition mode (step S2301).

The optimization problem operation apparatus 101 divides the number of times of repetition of the combinatorial optimization problem by the acquired number of divisions to calculate the number of times of repetition per partition in the execution mode (step S2302). The optimization problem operation apparatus 101 assigns the calculated number of times of repetition to each partition in the execution mode by the control unit 504 of the optimization apparatus 408 (step S2303).

The optimization problem operation apparatus 101 gives seed values different from each other to the respective partitions in the execution mode by the control unit 504 of the optimization apparatus 408 (step S2304). The optimization problem operation apparatus 101 causes each partition in the execution mode to execute an operation of the problem corresponding to the number of times of repetition in parallel by the control unit 504 of the optimization apparatus 408 (step S2305).

The optimization problem operation apparatus 101 integrates the operation results of the respective partitions in the execution mode into one result (step S2306) and returns to the step in which the parallel operation processing has been called. The operation result of the combinatorial optimization problem returned to the user in the step S2211 represented in FIG. 22 is the operation result integrated into one result in the step S2306.

This may cause operations of the combinatorial optimization problem to be executed in parallel with the number of parallel operations corresponding to the execution mode.

Apparatus Configuration Example of Optimization Apparatus 408

Next, a more specific apparatus configuration example of the optimization apparatus 408 will be described. The optimization apparatus 408 to be described below is different from the optimization apparatus 408 described by using FIG. 5 to FIG. 16 in part of the circuit configuration.

FIG. 24 is an explanatory diagram illustrating the apparatus configuration example of the optimization apparatus 408. The optimization apparatus 408 includes plural LFBs. The optimization apparatus 408 includes the control unit 504 that controls these plural LFBs (diagrammatic representation is omitted).

Here, as one example, suppose that the number of LFEs that belong to one LFB is m (m is an integer equal to or larger than 2) and the optimization apparatus 408 includes LFBs 70a, 70b, 70c, 70d, 70e, 70f, 70g, and 70h. In this case, the optimization apparatus 408 includes 8 m LFEs in total and may implement the maximum scale of 8 m bits. In the optimization apparatus 408, partitions are implemented by one or more LFBs in the LFBs 70a, 70b, 70c, 70d, 70e, 70f, 70g, and 70h, for example. However, the number of LFBs included in the optimization apparatus 408 is not limited to eight and may be another number.

The plural LFEs included in the LFBs 70a, . . . , and 70h are one example of the bit operation circuits 1a1, . . . , and 1aN illustrated in FIGS. 2A and 2B. It may be said that each of the LFBs 70a, ‘-’, and 70h is one group of LFEs including a given number of (m) LFEs as elements. Furthermore, identification numbers #0 to #7 are allocated to the LFBs 70a, . . . , and 70h, respectively.

The optimization apparatus 408 further includes a scale coupling circuit 91, a mode setting register 92, adders 93a, 93b, 93c, 93d, 93e, 93f, 93g, and 93h, and E storing registers 94a, 94b, 94c, 94d, 94e, 94f, 94g, and 94h.

Here, the LFB 70a includes an LFE 71a1, . . . , and an LFE 71am, a random selector unit 72, a threshold generating unit 73, a random number generating unit 74, and a mode setting register 75. The LFE 71a1, . . . , and the LFE 71am, the random selector unit 72, the threshold generating unit 73, the random number generating unit 74, and the mode setting register 75 are equivalent to the hardware with the same name described with FIGS. 8A to 8C and therefore description thereof is omitted. However, the random selector unit 72 outputs a set of the state signal (flag Fₓ₀, spin bit qₓ₀, and amount ΔEₓ₀ of energy change) with respect to the selected inversion bit to the scale coupling circuit 91. Furthermore, the random selector unit 72 does not need to include the flag control unit 52a (alternatively, may include it). For example, in the random selector unit 72, respective two signals of the state signals from the respective LFEs are input to each selection circuit at the first stage in the random selector unit 72 without through the flag control unit 52a. The LFBs 70b, . . . , and 70h also include the circuit configuration similar to the LFB 70a.

The scale coupling circuit 91 accepts the state signal from each of the LFBs 70a, . . . , and 70h and selects the inversion bit based on the state signals. The scale coupling circuit 91 supplies a signal relating to the inversion bit to each LFE of the LFBs 70a, . . . , and 70h.

For example, the scale coupling circuit 91 outputs flag F_{y0}, bit q_{y0}, and index=y0 that represents the inversion bit to the LFEs 71a1, . . . , and 71am of the LFB 70a. Here, in FIG. 24 and the subsequent diagrams, representation of “index=x0” and so forth output by the random selector unit 72 and the scale coupling circuit 91 will be abbreviated like “x0” in some cases. The scale coupling circuit 91 outputs an amount ΔE_{y0} of energy change to the adder 93a.

Furthermore, the scale coupling circuit 91 supplies flag F_{y1}, bit q_{y1}, and index=y1 that represents the inversion bit to each LFE of the LFB 70b. The scale coupling circuit 91 outputs an amount ΔE_{y1} of energy change to the adder 93b.

The scale coupling circuit 91 outputs flag F_{y2}, bit q_{y2}, and index=y2 that represents the inversion bit to each LFE of the LFB 70c. The scale coupling circuit 91 outputs an amount ΔE_{y2} of energy change to the adder 93c.

The scale coupling circuit 91 outputs flag F_{y3}, bit q_{y3}, and index=y3 that represents the inversion bit to each LFE of the LFB 70d. The scale coupling circuit 91 outputs an amount ΔE_{y3} of energy change to the adder 93d.

The scale coupling circuit 91 outputs flag F_{y4}, bit q_{y4}, and index=y4 that represents the inversion bit to each LFE of the LFB 70e. The scale coupling circuit 91 outputs an amount ΔE_{y4} of energy change to the adder 93e.

The scale coupling circuit 91 outputs flag F_{y5}, bit q_{y5}, and index=y5 that represents the inversion bit to each LFE of the LFB 70f. The scale coupling circuit 91 outputs an amount ΔE_{y5} of energy change to the adder 93f.

The scale coupling circuit 91 outputs flag F_{y5}, bit q_{y6}, and index=y6 that represents the inversion bit to each LFE of the LFB 70g. The scale coupling circuit 91 outputs an amount ΔE_{y6} of energy change to the adder 93g.

The scale coupling circuit 91 outputs flag F_{y7}, bit q_{y7}, and index=y7 that represents the inversion bit to each LFE of the LFB 70h. The scale coupling circuit 91 outputs an amount ΔE_{y7} of energy change to the adder 93h.

The random selector unit (including the random selector unit 72) which each of the LFBs 70a, . . . , and 70h includes and the scale coupling circuit 91 are one example of the selection circuit unit 2 illustrated in FIG. 2B.

The mode setting register 92 carries out setting of operating modes (partition mode and execution mode) for the scale coupling circuit 91. For example, the mode setting register 92 carries out the setting of the operating modes (partition mode and execution mode) for the scale coupling circuit 91 according to scale (the number of spin bits) and precision (the number of bits of the weight coefficient) input from the execution control unit 1803 of the optimization problem operation apparatus 101. The mode setting register 92 sets, in the scale coupling circuit 91, the same operating modes as the operating modes set in the LFEs 71a1, . . . , and 71am and the random selector unit 72 by the mode setting register 75. Details of the mode setting by the mode setting registers 75 and 92 will be described later. The mode setting register (including mode setting register 75) which each of the LFBs 70a, . . . , and 70h includes and the mode setting register 92 are one example of the setting change unit 5 illustrated in FIG. 2A.

The adder 93a adds ΔE_{y0} to an energy value E₀ stored in the E storing register 94a to update this energy value E₀. The E storing register 94a takes in the energy value E₀ calculated by the adder 93a in synchronization with a dock signal (diagrammatic representation is omitted) (this similarly applies to the other E storing registers), for example.

The adder 93b adds ΔE_{y1} to an energy value E₁ stored in the E storing register 94b to update this energy value E₁. The E storing register 94b takes in the energy value E₁ calculated by the adder 93b.

The adder 93c adds ΔE_{y2} to an energy value E₂ stored in the E storing register 94c to update this energy value E₂. The E storing register 94c takes in the energy value E₂ calculated by the adder 93c.

The adder 93d adds ΔE_{y3} to an energy value E₃ stored in the E storing register 94d to update this energy value E₃. The E storing register 94d takes in the energy value E₃ calculated by the adder 93d.

The adder 93e adds ΔE_{y4} to an energy value E₄ stored in the E storing register 94e to update this energy value E₄. The E storing register 94e takes in the energy value E₄ calculated by the adder 93e.

The adder 93f adds ΔE_{y}s to an energy value E₅ stored in the E storing register 94f to update this energy value E₅. The E storing register 94f takes in the energy value E₅ calculated by the adder 93f.

The adder 93g adds ΔE_{y6} to an energy value E₆ stored in the E storing register 94g to update this energy value E₆. The E storing register 94g takes in the energy value E₅ calculated by the adder 93g.

The adder 93h adds ΔE_{y7} to an energy value E₇ stored in the E storing register 94h to update this energy value E₇. The E storing register 94h takes in the energy value E₇ calculated by the adder 93h.

Each of the E storing registers 94a, . . . , and 94h is a flip-flop, for example.

Next, a circuit configuration example of the LFB 70a will be described. The LFBs 70b, . . . , and 70h also include the circuit configuration similar to the LFB 70a.

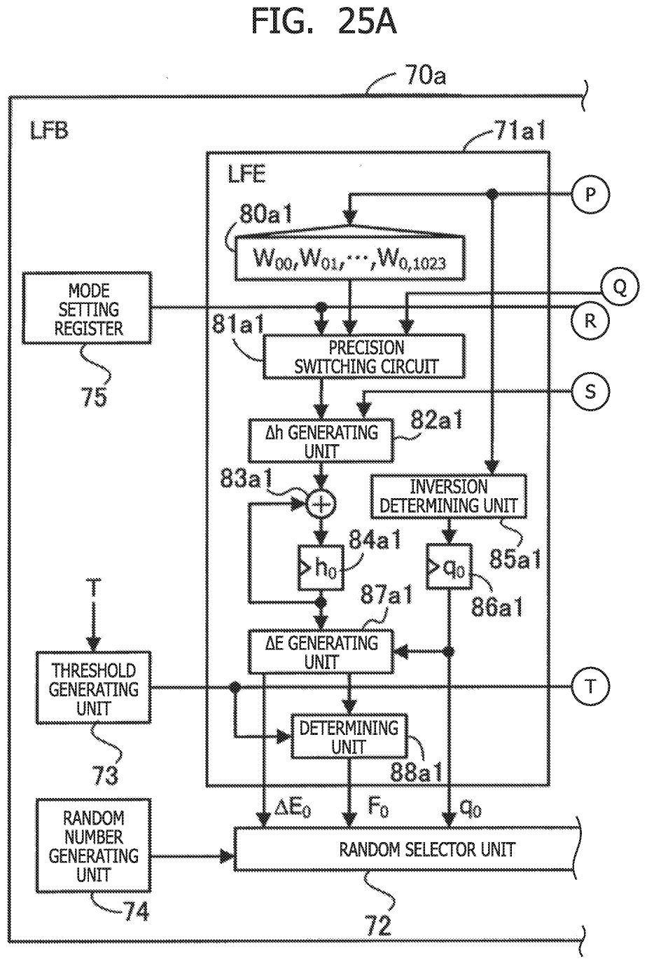

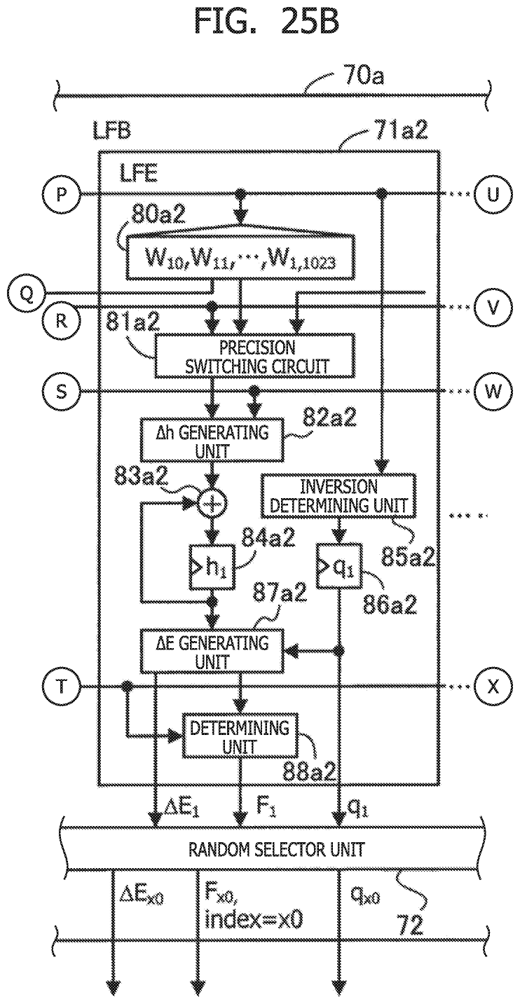

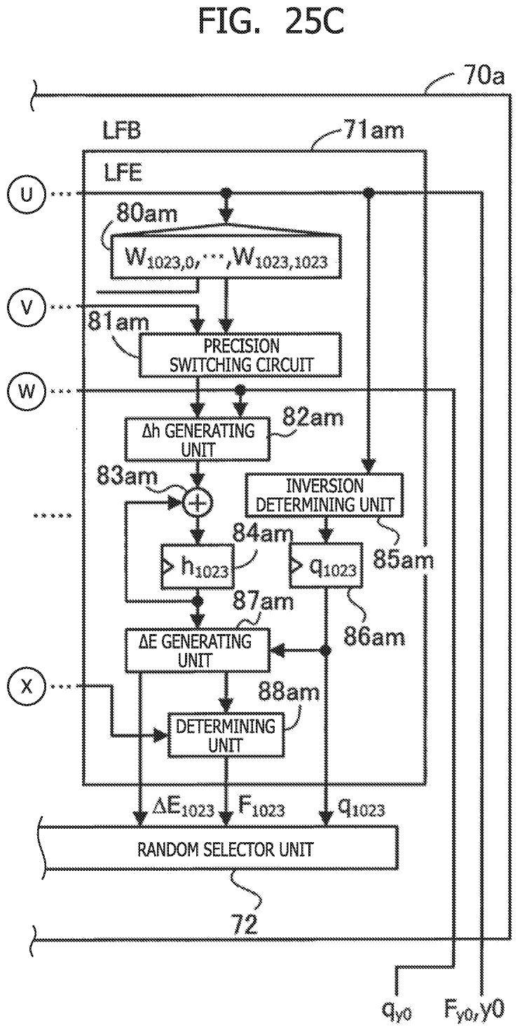

FIGS. 25A to 25C represent an explanatory diagram Illustrating a circuit configuration example of the LFB. Each of the LFEs 71a1, 71a2, . . . , and 71am is used as one bit of spin bits. m is an integer equal to or larger than 2 and represents the number of LFEs included in the LFB 70a. In the example of FIGS. 25A to 25C, m=1024 is assumed as one example. However, m may be another value.

Identification information (index) is associated with each of the LFEs 71a1, 71a2, . . . , and 71am. index=0, 1, . . . , and 1023 are set for the LFEs 71a1, 71a2, . . . , and 71am, respectively.

In the following, the circuit configuration of the LFE 71a1 will be described. The LFEs 71a2, . . . , and 71am are also implemented by the circuit configuration similar to the LFE 71a1. As for explanation of the circuit configuration of the LFEs 71a2, . . . , and 71am, a part of “a1” at the tail end of the numeral of each element in the following description may be replaced by each of “a2,” . . . , and “am” (for example, numeral “80a1” may be replaced by “80am”) and the original description may be read as description for the corresponding configuration.

The LFE 71a1 includes an SRAM 80a1, a precision switching circuit 81a1, a Δh generating unit 82a1, an adder 83a1, an h storing register 84a1, an inversion determining unit 85a1, a bit storing register 86a1, a ΔE generating unit 87a1, and a determining unit 88a1.

Here, the SRAM 80a1, the precision switching circuit 81a1, the Δh generating unit 82a1, the adder 83a1, the h storing register 84a1, the inversion determining unit 85a1, the bit storing register 86a1, the ΔE generating unit 87a1, and the determining unit 88a1 each have the functions similar to the hardware with the same name described with FIGS. 8A to 8C. However, index=y0 and the flag F_{y0} indicating whether or not inversion is possible, output by the scale coupling circuit 91, are supplied to the SRAM 80a1 (or precision switching circuit 81a) and the inversion determining unit 85a. Furthermore, the inversion bit q_{y0} output by the scale coupling circuit 91 is supplied to the Δh generating unit 82a1.

The mode setting register 75 carries out setting of the number of bits of the weight coefficient (precision) for the precision switching circuits 81a1, 81a2, . . . , and 81am. The mode setting register 75 does not include a signal line to carry out setting for the random selector unit 72 (however, it may include this signal line). Here, the above-described five kinds of modes may be used as one example.

The first mode is the mode with scale 1 k bits/precision 128 bits and corresponds to the partition mode “8P (division into eight).” The mode with scale 1 k bits/precision 128 bits uses one LFB. Each partition in this mode may be implemented by only one of the LFBs 70a, . . . , and 70h.

The second mode is the mode with scale 2 k bits/precision 64 bits and corresponds to the partition mode “4P (division into four).” The mode with scale 2 k bits/precision 64 bits uses two LFBs. For example, each partition in this mode may be implemented by one combination in a combination of the LFBs 70a and 70b, a combination of the LFBs 70c and 70d, a combination of the LFBs 70e and 70f, and a combination of the LFBs 70g and 70h.

The third mode is the mode with scale 4 k bits/precision 32 bits and corresponds to the partition mode “2P (division into two).” The mode with scale 4 k bits/precision 32 bits uses four LFBs. For example, each partition in this mode may be implemented by one combination in a combination of the LFBs 70a, 70b, 70c, and 70d and a combination of the LFBs 70e, 70f, 70g, and 70h.

The fourth mode is the mode with scale 8 k bits/precision 16 bits and corresponds to the partition mode “FULL (scale: 8K, precision: 16 bits).” The mode with scale 8 k bits/precision 16 bits uses eight LFBs. The partition in this mode may be implemented by using a combination of the LFBs 70a, . . . , and 70h.

The fifth mode is the mode with scale 4 k bits/precision 64 bits and corresponds to the partition mode “FULL (scale: 4K, precision: 64 bits).” The mode with scale 4 k bits/precision 64 bits uses eight LFBs. The partition in this mode may be implemented by using a combination of the LFBs 70a, . . . , and 70h. However, as described with FIG. 16, the number of LFEs used in one LFB is half the number of LFEs included in one LFB.

Furthermore, the optimization apparatus 408 allows operations of the same problem or another problem to be executed in parallel through combining the above-described mode with scale 1 k bits/precision 128 bits, mode with scale 2 k bits/precision 64 bits, and mode with scale 4 k bits/precision 32 bits. This may change the execution mode only for a partial partition in plural partitions in a certain partition mode, for example.

For this purpose, with respect to plural LFBs (combination of LFBs), the scale coupling circuit 91 selects the number of combined LFBs (the number of combined groups) in such a manner that LFEs in a number equivalent to the number of spin bits are included according to the setting of the number of spin bits by the mode setting register 92. The scale coupling circuit 91 includes the following circuit configuration, for example.

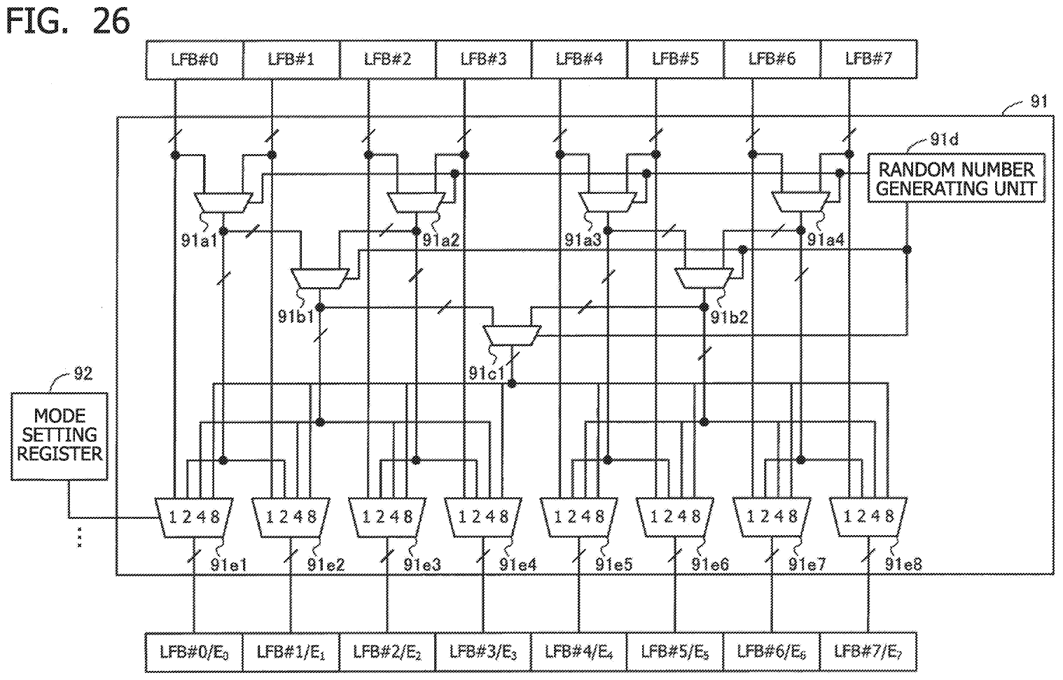

FIG. 26 is an explanatory diagram illustrating a circuit configuration example of the scale coupling circuit. The scale coupling circuit 91 includes selection circuits 91a1, 91a2, 91a3, 91a4, 91b1, 91b2, and 91c1 coupled in a tree manner across plural stages, a random number generating unit 91d, and mode selection circuits 91e1, 91e2, 91e3, 91e4, 91e5, 91e6, 91e7, and 91e8.

To each of the selection circuits 91a1, . . . , and 91a4 at the first stage, respective two sets of variables qᵢ, Fᵢ, ΔEᵢ, and index=i (state signal) output by each of the LFBs 70a, . . . , and 70h are input. For example, a set of (qₓ₀, Fₓ₀, ΔEₓ₀, index=x0) output by the LFB 70a (#0) and a set of (qₓ₁, Fₓ₁, ΔEₓ₁, index=x1) output by the LFB 70b (#1) are input to the selection circuit 91a1. Furthermore, a set of (qₓ₅, Fₓ₇, ΔEₓ₅, index=x2) output by the LFB 70c (#2) and a set of (qₓ₃, Fₓ₃, ΔEₓ₃, index=x3) output by the LFB 70d (#3) are input to the selection circuit 91a2. A set of (qₓ₄, Fₓ₄, ΔEₓ₄, index=x4) output by the LFB 70e (#4) and a set of (qₓ₅, Fₓ₅, ΔEₓ₅, index=x5) output by the LFB 70f (#5) are input to the selection circuit 91a3. A set of (qₓ₆, Fₓ₆, ΔEₓ₆, index=x6) output by the LFB 70g (#6) and a set of (qₓ₇, Fₓ₇, ΔEₓ₇, index=x7) output by the LFB 70h (#7) are input to the selection circuit 91a4.

Each of the selection circuits 91a1, . . . , and 91a4 selects one set of (qᵢ, Fᵢ, ΔEᵢ, index=i) in the two sets based on a one-bit random number output by the random number generating unit 91d. At this time, each of the selection circuits 91a1, . . . , and 91a4 preferentially selects the set in which Fᵢ is 1, and selects either one set based on the one-bit random number if Fᵢ is 1 in both sets (this similarly applies to the selection circuits 91b1, 91b2, and 91c1). Here, the random number generating unit 91d generates the one-bit random number for each selection circuit individually and supplies it to each selection circuit. Furthermore, each of the selection circuits 91a1, . . . , and 91a4 generates an identification value indicating which set has been selected based on index included in both sets and outputs a state signal including the selected variables qᵢ, Fᵢ, and ΔEᵢ and the identification value. The number of bits of the identification value output by each of the selection circuits 91a1, . . . , and 91a4 is larger than the input index by one bit.

To each of the selection circuits 91b1 and 91b2 at the second stage, respective two signals of the state signals output by the selection circuits 91a1, . . . , and 91a4 are input. For example, the state signals output by the selection circuits 91a1 and 91a2 are input to the selection circuit 91b1 and the state signals output by the selection circuits 91a3 and 91a4 are input to the selection circuit 91b2.

Each of the selection circuits 91b1 and 91b2 selects either one of the two state signals based on the two state signals and a one-bit random number output by the random number generating unit 91d. Furthermore, each of the selection circuits 91b1 and 91b2 updates the identification value included in the selected state signal by adding one bit in such a manner that which state signal has been selected is indicated, and outputs the selected state signal.

Two state signals output by the selection circuits 91b1 and 91b2 are input to the selection circuit 91c1 at the last stage. The selection circuit 91c1 selects either one of the two state signals based on the two state signals and a one-bit random number output by the random number generating unit 91d. Furthermore, the selection circuit 91c1 updates the identification value included in the selected state signal by adding one bit in such a manner that which state signal has been selected is indicated, and outputs the selected state signal.

As described above, the identification value is equivalent to index. The scale coupling circuit 91 may output index corresponding to the inversion bit by selecting index input from each random selector unit by each selection circuit similarly to the variables qᵢ, Fᵢ, and ΔEᵢ. In this case, each random selector unit receives supply of index in addition to the variable q and the flag F from each LFE. The control unit 504 carries out setting of index according to the combination of the LFBs for a given register for storing index in each LFE, for example.

Each of the mode selection circuits 91e1, . . . , and 91e8 includes input terminals according to the scale (i.e. 1 k bits, 2 k bits, 4 k bits, and 8 k bits). In FIG. 26, “1” depicted in each of the mode selection circuits 91e1, . . . , and 91e8 represents the input terminal corresponding to the scale of 1 k bits. Depicted “2” represents the input terminal corresponding to the scale of 2 k bits. Depicted “4” represents the input terminal corresponding to the scale of 4 k bits (precision of 32 bits). Depicted “8” represents the input terminal corresponding to the scale of 8 k bits (or scale 4 k bits/precision 64 bits).

The state signal output by the LFB 70a (#0) is input to the input terminal of the scale of 1 k bits in the mode selection circuit 91e1. The state signal output by the LFB 70b (#1) is input to the input terminal of the scale of 1 k bits in the mode selection circuit 91e2. The state signal output by the LFB 70c (#2) is input to the input terminal of the scale of 1 k bits in the mode selection circuit 91e3. The state signal output by the LFB 70d (#3) is input to the input terminal of the scale of 1 k bits in the mode selection circuit 91e4. The state signal output by the LFB 70e (#4) is input to the input terminal of the scale of 1 k bits in the mode selection circuit 91e5. The state signal output by the LFB 70f (#5) is input to the input terminal of the scale of 1 k bits in the mode selection circuit 91e6. The state signal output by the LFB 70g (#6) is input to the input terminal of the scale of 1 k bits in the mode selection circuit 91e7. The state signal output by the LFB 70h (#7) is input to the input terminal of the scale of 1 k bits in the mode selection circuit 91e8.

The state signal output by the selection circuit 91a1 is input to the input terminal of the scale of 2 k bits in each of the mode selection circuits 91e1 and 91e2. The state signal output by the selection circuit 91a2 is input to the input terminal of the scale of 2 k bits in each of the mode selection circuits 91e3 and 91e4. The state signal output by the selection circuit 91a3 is input to the input terminal of the scale of 2 k bits in each of the mode selection circuits 91e5 and 91e6. The state signal output by the selection circuit 91a4 is input to the input terminal of the scale of 2 k bits in each of the mode selection circuits 91e7 and 91e8.

The state signal output by the selection circuit 91b1 is input to the input terminal of the scale of 4 k bits in each of the mode selection circuits 91e1, 91e2, 91e3, and 91e4. The state signal output by the selection circuit 91b2 is input to the input terminal of the scale of 4 k bits in each of the mode selection circuits 91e5, 91e6, 91e7, and 91e8.

The state signal output by the selection circuit 91c1 is input to the input terminal of the scale of 8 k bits in each of the mode selection circuits 91e1, . . . , and 91e8.

Each of the mode selection circuits 91e1, . . . , and 91e8 accepts setting of the scale (the number of spin bits) by the mode setting register 92. However, in FIG. 26, diagrammatic representation of signal lines from the mode setting register 92 to each of the mode selection circuits 91e2, . . . , and 91e8 is replaced by depiction of “*.” Each of the mode selection circuits 91e1, . . . , and 91e8 selects the state signal input to the input terminal according to the set scale to output (xⱼ, Fⱼ, index=j) to the LFB 70a, . . . , or 70h and output ΔEⱼ to the adder 93a, . . . , or 93h.

For example, the mode selection circuit 91e1 outputs (q_{y0}, F_{y0}, index=y0) to the LFB 70a and outputs ΔE_{y0} to the adder 93a. The adder 93a updates E₀ based on ΔE_{y0}. The mode selection circuit 91e2 outputs (q_{y1}, F_{y1}, index=y1) to the LFB 70b and outputs ΔE_{y1} to the adder 93b. The adder 93b updates E₁ based on ΔE_{y1}. The mode selection circuit 91e3 outputs (q_{y2}, F_{y2}, index=y2) to the LFB 70c and outputs ΔE_{y2} to the adder 93c. The adder 93c updates E₂ based on ΔE_{y2}. The mode selection circuit 91e4 outputs (q_{y3}, F_{y3}, index=y3) to the LFB 70d and outputs ΔE_{y3} to the adder 93d. The adder 93d updates E₃ based on ΔE_{y3}. The mode selection circuit 91e5 outputs (q_{y4}, F_{y4}, index=y4) to the LFB 70e and outputs ΔE_{y4} to the adder 93e. The adder 93e updates E₄ based on ΔE_{y4}. The mode selection circuit 91e6 outputs (q_{y5}, F_{y5}, index=y5) to the LFB 70f and outputs ΔE_{y5} to the adder 93f. The adder 93f updates E₅ based on ΔE_{y5}. The mode selection circuit 91e7 outputs (q_{y6}, F_{y6}, index=y6) to the LFB 70g and outputs ΔE_{y6} to the adder 93g. The adder 93g updates E₆ based on ΔE_{y6}. The mode selection circuit 91e8 outputs (q_{y7}, F_{y7}, index=y7) to the LFB 70h and outputs ΔE_{y7} to the adder 93h. The adder 93h updates E₇ based on ΔE_{y7}.

For example, the optimization apparatus 408 includes, in each LFB, the random selector unit that selects any bit based on the signal that is output from each LFE that belongs to a certain LFB (group) and indicates whether or not inversion is possible, and outputs the signal that represents the selected bit to the scale coupling circuit 91. The scale coupling circuit 91 combines one or more LFBs according to the setting of the number of spin bits and selects the bit to be inverted based on the signal that represents the bit selected by the random selector unit corresponding to each of these one or more LFBs. The scale coupling circuit 91 outputs the signal that represents the bit to be inverted to the respective LFEs that belong to these one or more LFBs.

Here, the mode setting register 92 carries out the setting of the scale for the mode selection circuits 91e1, . . . , and 91e8 individually. However, in a mode of a certain scale, a common scale is set in the mode selection circuits corresponding to the LFBs used in combination.

For example, the mode setting register 92 may set the number of spin bits of a first spin bit string corresponding to a first combination of the LFBs and the number of spin bits of a second spin bit string corresponding to a second combination of the LFBs to the same number of bits or different numbers of bits. Furthermore, the mode setting register of each LFB including the mode setting register 75 may set the number of bits of the weight coefficient for the LFEs that belong to the first combination of the LFBs and the number of bits of the weight coefficient for the LFEs that belong to the second combination of the LFBs to the same number of bits or different numbers of bits.

This may implement various partition modes and execution modes different in the maximum scale or maximum precision of the problem that may be solved in the optimization apparatus 408.

For example, if the LFBs 70a and 70b are used in combination and a mode with a scale of 2 k bits is used, a selection signal to select the mode with a scale of 2 k bits is supplied from the mode setting register 92 to the mode selection circuits 91e1 and 91e2. At this time, for example, the optimization apparatus 408 may execute the same problem as operations by the LFBs 70a and 70b or a different problem in parallel by using the remaining six LFBs based on the setting of the mode setting register 92.

For example, regarding the remaining six LFBs, the scale coupling circuit 91 may combine respective two LFBs in the six LFBs to implement three modes with a scale of 2 k bits. This may implement four partitions in the partition mode “4P (division into four).”

Furthermore, regarding the remaining six LFBs, the scale coupling circuit 91 may implement six modes with a scale of 1 k bits in each of the six LFBs. This may make the state in which the execution mode of one partition in four partitions in the partition mode “4P (division into four)” is set to the execution mode “4P” and the execution mode of the remaining three partitions is set to the execution mode “8P.”

Moreover, the scale coupling circuit 91 may implement a mode with a scale of 2 k bits by a combination of two LFBs in the six LFBs and implement a mode with a scale of 4 k bits by a combination of the other four LFBs. This may make the state in which the execution mode of one partition in two partitions in the partition mode “2P (division into two)” is set to the execution mode “2P” and the execution mode of the remaining one partition is set to the execution mode “4P.”

The combinations of modes implemented in parallel are not limited to the above-described combinations. For example, various combinations are conceivable, such as combination of eight modes with a scale of 1 k bits, combination of four modes with a scale of 2 k bits, and combination of four modes with a scale of 1 k bits and two modes with a scale of 2 k bits.

As above, the scale coupling circuit 91 accepts setting of the number of spin bits with respect to each of plural spin bits strings by the mode setting register 92 and selects the number of combined LFBs (the number of groups) with respect to the number of spin bits of each of the plural spin bit strings to combine the LFBs. This may implement plural Ising models on one piece of the optimization apparatus 408.

Common energy is stored in a set of the E storing registers corresponding to the set of the LFBs used in combination. For example, when the LFBs 70a and 70b are used in combination, E₀ and E₁ stored in the E storing registers 94a and 94b have the same value. In this case, when the energy value for the set of these LFBs 70a and 70b is read out, it suffices for the control unit 504 to read out the energy value stored in either one of the E storing registers 94a and 94b (for example, E storing register 94a corresponding to the LFB 70a). The control unit 504 similarly reads out the energy value also for other combinations of the LFBs.

For example, the control unit 504 accepts input of initial values and operating conditions regarding the respective problems to be subjected to operations in parallel from the execution control unit 1803 of the optimization problem operation apparatus 101. The control unit 504 sets the scale/precision according to each problem input from the execution control unit 1803 of the optimization problem operation apparatus 101 in the mode setting register of the LFB and the mode setting register 92 for each group of the LFBs (i.e. partition) used for one problem.

For example, regarding a first problem, the control unit 504 sets scale 2 k bits/precision 64 bits in the mode setting registers of the LFBs 70a and 70b and carries out setting in the mode setting register 92 in such a manner that the mode selection circuits 91e1 and 91e2 carry out output corresponding to the scale of 2 k bits. Furthermore, regarding a second problem, the control unit 504 sets scale 2 k bits/precision 64 bits in the mode setting registers of the LFBs 70c and 70d and carries out setting in the mode setting register 92 in such a manner that the mode selection circuits 91e3 and 91e4 carry out output corresponding to the scale of 2 k bits.

In this case, in the optimization apparatus 408, operations of two problems (alternatively, both problems may be the same problem) in parallel are possible. For example, the control unit 504 controls each LFB in such a manner as to carry out the procedure of the flowchart illustrated in FIG. 15 for the combinations of the LFBs corresponding to the respective problems.

After the end of the operations, the control unit 504 reads out the spin bit string with respect to the first problem from the respective LFEs of the LFBs 70a and 70b and employs it as the solution of the first problem. Furthermore, after the end of the operations, the control unit 504 reads out the spin bit string with respect to the second problem from the respective LFEs of the LFBs 70c and 70d and employs it as the solution of the second problem. Three or more problems may also be subjected to operations in parallel similarly. This may efficiently execute operations for plural problems.

Furthermore, in the case of solving the same problem by plural sets of the LFBs in parallel, it is conceivable that the control unit 504 increases the speed of operations by a method called the replica exchange method, for example. In the replica exchange method, the speed of a search for a solution is increased by updating a spin bit string with different temperature parameters in the respective sets of the LFBs (respective replicas) and exchanging the temperature parameters between the sets of the LFBs (for example, between replicas) at a given probability after a given number of times of update.

Alternatively, as a search method of a solution, a method is also conceivable in which the procedure from the start (START) to the end (END) in FIG. 15 is repeatedly carried out and the spin bit string of the minimum energy is obtained as a solution from plural operation results. In this case, the control unit 504 may reduce the number of times of the above-described repetition and increase the speed of operations by using plural sets of the LFBs and solving the same problem in parallel.

As described above, according to the optimization problem operation apparatus 101 in accordance with the embodiment, a combinatorial optimization problem may be accepted and the partition mode and the execution mode of the optimization apparatus 408 may be decided according to the scale of requested precision of the accepted combinatorial optimization problem. According to the optimization problem operation apparatus 101, with the decided partition mode and execution mode, operations of the combinatorial optimization problem may be executed in parallel in the optimization apparatus 408 based on the number of times obtained by dividing the number of times of execution of the combinatorial optimization problem by the number of divisions corresponding to this execution mode.

This may execute operations of the combinatorial optimization problem regarding which the number of times of execution is specified in parallel with the partition mode and the execution mode according to the scale or requested precision of the problem. For this reason, hardware resources of the optimization apparatus 408 may be effectively used and the operation efficiency may be enhanced, so that increase in the speed of operation processing of plural problems (repetition of the same problem and different problems are both available) may be intended.

Furthermore, according to the optimization problem operation apparatus 101, seed values different from each other may be set for operations of a combinatorial optimization problem caused to be executed in parallel and the execution may be caused to be started. This may keep the solutions of the combinatorial optimization problem caused to be executed in parallel from becoming the same solution and obtain plural kinds of different solutions according to the number of times of repetition specified by the user.

Moreover, according to the optimization problem operation apparatus 101, if the number of times of execution of a combinatorial optimization problem is equal to or larger than a threshold, operations of the combinatorial optimization problem may be caused to be executed in parallel in the optimization apparatus 408. Due to this, when the number of times of execution of the combinatorial optimization problem is small, without using plural partitions, the remaining partitions may be made to wait for being used for an operation of a new problem.

The optimization problem operation method described in the present embodiment may be implemented through executing a program prepared in advance by a computer such as a personal computer or workstation. The present optimization problem operation program is recorded in a computer-readable recording medium such as a hard disc, flexible disc, CD, DVD, or USB memory and is executed through being read out from the recording medium by a computer. Furthermore, the present optimization problem operation program may be distributed through a network such as the Internet.

Furthermore, the respective functional units of the optimization problem operation apparatus 101 described in the present embodiment may be implemented also by ICs for specific use purposes, such as standard cell and structured application specific integrated circuit (ASIC), and programmable logic devices (PLD) such as an FPGA.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process, the process comprising:
accepting a combinatorial optimization problem to an operation unit that is capable of being divided into a plurality of partitions logically and solves the combinatorial optimization problem;
deciding a partition mode that prescribes a logical division state of the operation unit and an execution mode that prescribes a range of hardware resources used in an operation in the partition mode according to a scale or a requested precision of the combinatorial optimization problem; and
causing execution of operations of the combinatorial optimization problem in parallel in the operation unit with the partition mode and the execution mode decided, based on a number of times obtained by dividing a number of times of execution of the combinatorial optimization problem by a number of divisions corresponding to the execution mode.

2. The non-transitory computer-readable recording medium having stored the program according to claim 1, wherein
the causing execution sets seed values different from each other for the operations of the combinatorial optimization problem caused to be executed in parallel and causes the execution to be started.

3. The non-transitory computer-readable recording medium having stored the program according to claim 1, wherein
the causing execution causes the execution of the operations of the combinatorial optimization problem in parallel in the operation unit when the number of times of execution of the combinatorial optimization problem is equal to or larger than a threshold.

4. An optimization problem operation method in which a computer executes processing comprising:
accepting a combinatorial optimization problem to an operation unit that is capable of being divided into a plurality of partitions logically and solves the combinatorial optimization problem;
deciding a partition mode that prescribes a logical division state of the operation unit and an execution mode that prescribes a range of hardware resources used in an operation in the partition mode according to a scale or a requested precision of the combinatorial optimization problem; and
causing execution of operations of the combinatorial optimization problem in parallel in the operation unit with the partition mode and the execution mode decided, based on a number of times obtained by dividing a number of times of execution of the combinatorial optimization problem by a number of divisions corresponding to the execution mode.

5. An optimization problem operation apparatus comprising:
an operation unit configured to be capable of being divided into a plurality of partitions logically and solve a combinatorial optimization problem; and
a processor configured to
accept the combinatorial optimization problem to the operation unit,
decide a partition mode that prescribes a logical division state of the operation unit and an execution mode that prescribes a range of hardware resources used in an operation in the partition mode according to a scale or a requested precision of the combinatorial optimization problem, and
execute operations of the combinatorial optimization problem in parallel by the operation unit with the partition mode and the execution mode decided, based on a number of times obtained by dividing a number of times of execution of the combinatorial optimization problem by a number of divisions corresponding to the execution mode.
